(19) United States
(12) Patent Application Publication
(10) Pub. No.: US 2007/0005795 A1
(43) Pub. Date: Jan. 4, 2007

(54) OBJECT ORIENTED VIDEO SYSTEM

(75) Inventor: Ruben Gonzalez, Queensland (AU)

Correspondence Address: SUGHRUE MION, PLLC, 2100 PENNSYLVANIA AVENUE, N.W., SUITE 800, WASHINGTON, DC, 20037, US

(73) Assignee: ACTIVESKY, INC., Redwood City, CA (US)

(21) Appl. No.: 11/470,790

(22) Filed: Sep. 7, 2006

Related U.S. Application Data
(63) Continuation of application No. 09/937,096, filed on Dec. 19, 2001.

(30) Foreign Application Priority Data
Oct. 22, 1999 (AU) PQ 3603
Jul. 7, 2000 (AU) PQ 8661
Oct. 20, 2000 (WO) PCT/AU00/01296

(51) Int. Cl. G06F 15/16

(52) U.S. Cl. 709/232

(57) ABSTRACT

A method of generating an object oriented interactive multimedia file, including encoding data comprising at least one of video, text, audio, music and/or graphics elements as a video packet stream, text packet stream, audio packet stream, music packet stream and/or graphics packet stream respectively, combining the packet streams into a single self-contained object, said object containing its own control information, placing a plurality of the objects in a data stream, and grouping one or more of the data streams in a single contiguous self-contained scene, the scene including format definition as the initial packet in a sequence of packets. An encoder for executing the method is provided together with a player or decoder for parsing and decoding the file, which can be wirelessly streamed to a portable computer device, such as a mobile phone or a PDA. The object controls provide rendering and interactive controls for objects allowing users to control dynamic media composition, such as dictating the shape and content of interleaved video objects, and control the objects received.

### CROSS-REFERENCE

This is a continuation of application Ser. No. 09/937,096 filed Dec. 19, 2001 which is a National Stage Entry of PCT/AU00/01296 filed Oct. 20, 2000, which claims benefit Australian Application No. PQ 3603 filed Oct. 22, 1999 and Australian Application No. PQ 8661 filed Jul. 7, 2000. The entire disclosures of the prior applications, are considered part of the disclosure of the accompanying continuation application and is hereby incorporated by reference.

### FIELD OF THE INVENTION

The present invention relates to a video encoding and processing method, and in particular, but not exclusively, to a video encoding system which supports the coexistence of multiple arbitrarily-shaped video objects in a video scene and permits individual animations and interactive behaviours to be defined for each object, and permits dynamic media composition by encoding object oriented controls into video streams that can be decoded by remote client or standalone systems. The client systems may be executed on a standard computer or on mobile computer devices, such as personal digital assistants (PDAs), smart wireless phones, hand-held computers and wearable computing devices using low power, general purpose CPUs. These devices may include support for wireless transmission of the encoded video streams.

### BACKGROUND

Recent technology improvements have resulted in the introduction of personal mobile computing devices, which are just beginning to include full wireless communication technologies. The global uptake of wireless mobile telephones has been significant, but still has substantial growth potential. It has been recognised that there have not been any video technology solutions that have provided the video quality, frame rate or low power consumption for potential new and innovative mobile video processes. Due to the limited processing power of mobile devices, there are currently no suitable mobile video solutions for processes utilising personal computing devices such as mobile video conferencing, ultra-thin wireless network client computing, broadcast wireless mobile video, mobile video promotions or wireless video surveillance.

A serious problem with attempting to display video on portable handheld devices such as smart phones and PDAs is that in general these have limited display capabilities. Since video is generally encoded as using continuous colour representation which requires true colour (16 or 24 bit) display capabilities for rendering, severe performance degradation results when an 8 bit display is used. This is due to the quantisation and dithering processes that are performed on the client to convert the video images into an 8 bit format suitable for display on devices using a fixed colour map, which reduces quality and introduces a large processing overhead.

Computer based video conferencing currently uses standard computer workstations or PCs connected through a network including a physical cable connection and network computer communication protocol layers. An example of this is a videoconference between two PCs over the Internet, with physically connected cables end to end, using the TCP/IP network communication protocols. This kind of video conferencing has a physical connection to the Internet, and also uses large, computer-based video monitoring equipment. It provides for a videoconference between fixed locations, which additionally constrains the participants to a specific time for the conference to ensure that both parties will be at the appropriate locations simultaneously.

Broadcast of wireless textual information for personal handheld computers or smart-phones has only recently become feasible with advances in new and innovative wireless technologies and handheld computing devices. Handheld computing devices and mobile telephones are able to have wireless connections to wide area networks that can provide textual information to the user device. There is currently no real-time transmission of video to wireless handheld computing devices. This lack of video content connectivity tends to limit the commercial usefulness of existing systems, especially when one considers the inability of “broadcast” systems to target specific users for advertising purposes. One important market issue for broadcast media in any form is the question of advertising and how it is to be supported. Effective advertising should be specifically targeted to users and geographic locations, but broadcast technologies are inherently limited in this regard. As a consequence, “niche” advertisers of specialty products would be reluctant to support such systems.

Current video broadcast systems are unable to embed targeted advertising because of the considerable processing requirements needed to insert advertising material into video data streams in real time during transmission. The alternate method of pre-compositing video prior to transmission is too tedious as recognised by the present inventor to be performed on a regular basis. Additionally, once the advertising is embedded into the video stream, the user is unable to interact with the advertising which, reduces the effectiveness of the advertising. Significantly, it has been recognised that more effective advertising can be achieved though interactive techniques.

Most video encoders/decoders exhibit poor performance with cartoons or animated content; however, there is more cartoon and animated content being produced for the Internet than video. It has been recognised that there is a need for a codec which enables efficient encoding of graphics animations and cartoons as well as video.

Commercial and domestic security-based video surveillance systems have to date been achieved using closed circuit monitoring systems with video monitoring achieved in a central location, requiring the full-time attention of a dedicated surveillance guard. Video monitoring of multiple locations can only be achieved at the central control centre using dedicated monitoring system equipment. Security guards have no access to video from monitored locations whilst on patrol.

Network-based computing using thin client workstations involves minimal software processing on the client workstation, with the majority of software processing occurring on a server computer. Thin client computing reduces the cost of computer management due to the centralisation of information and operating software configuration. Client workstations are physically wired through standard local area networks such as 10 Base T Ethernet to the server computer. Client workstations run a minimal operating system, enabling communication to a backend server computer and information display on the client video monitoring equipment. Existing systems, however, are constrained. They are typically limited to specific applications or vendor software. For example, current thin clients are unable to simultaneously service a video being displayed and a spreadsheet application.

In order to directly promote product in the market, sales representatives can use video demonstrations to illustrate product usage and benefits. Currently, for the mobile sales representative, this involves the use of cumbersome dedicated video display equipment, which can be taken to customer locations for product demonstrations. There are no mobile handheld video display solutions available, which provide real-time video for product and market promotional purposes.

Video brochures have often been used for marketing and advertising. However, their effectiveness has always been limited because video is classically a passive medium. It has been recognised that the effectiveness of video brochures would be dramatically improved if they could be made interactive. If this interactivity could be provided intrinsically within a codec, this would open the door to video-based e-commerce applications. The conventional definition for interactive video includes a player that is able to decompress a normal compressed video into a viewing window and interpret some metadata which defines buttons and invisible “hot regions” to be overlaid over the video, typically representing hyperlinks where a user's mouse click will invoke some predefined action. In this typical approach, the video is stored as a separate entity from the metadata, and the nature of interaction is extremely limited, since there is no integration between the video content and the external controls that are applied.

The alternative approach for providing interactive video is that of MPEG4, which permits multiple objects, however this approach finds difficulty running on today's typical desktop computer such as a Pentium III 500 Mhz Computer having 128 Mb RAM. The reason being that the object shape information is encoded separately from the object colour/luminance information generating additional storage overhead, and that the nature of the scene description (BIFS) and file format having been taken in part from virtual reality markup language (VRML) is very complex. This means that to display each video frame for a video object three separate components have to be fully decoded; the luminance information, the shape/transparency information and the BIFS. These then have to be blended together before the object can be displayed. Given that the DCT based video codec itself is already very computationally intensive, the additional decoding requirements introduce significant processing overheads in addition to the storage overheads.

The provision of wireless access compatibilities to personal digital assistants (PDAs) permits electronic books to be freed from their storage limitations by enabling real-time wireless streaming of audio-visual content to PDAs. Many corporate training applications need audiovisual information to be available wirelessly in portable devices. The nature of audiovisual training materials dictates that they be interactive and provide for non-linear navigation of large amounts of stored content. This cannot be provided with the current state of the art.

### OBJECTS OF THE INVENTION

An object of the invention is to overcome the deficiencies described above. Another object of the invention is to provide software playback of streaming video, and to display video on a low processingpower, mobile device such as a general-purpose handheld devices using a general purpose processor, without the aid of specialised DSP or custom hardware.

A further object of the invention is to to provide a high performance low complexity software video codec for wirelessly connected mobile devices. The wireless connection may be provided in the form of a radio network operating in CDMA, TDMA, FDMA transmission modes over packet swithced or circuit switched networks as used in GSM, CDMA, GPRS, PHS, UMTS, IEEE 802.11 etc networks.

A further object of the invention is to send colour prequantisation data for real-time colour quantisation on clients with 8 bit colour displays (mapping any non-stationary three-dimensional data onto a single dimension) when using codecs that use continuous colour representations.

A further object of the invention is to support multiple arbitrary shaped video objects in a single scene with no extra data overhead or processing overhead.

A further object of the invention is to integrate audio, video, text, music and animated graphics seamlessly into a video scene.

A further object of the invention is to attach control information directly to objects in a video bitstream to define interactive behavior, rendering, composition, digital rights management information, and interpretation of compressed data for objects in a scene.

A further object of the invention is to interact with individual objects in the video and control rendering, and the composition of the content being displayed.

Yet another object of the invention is to provide interactive video possessing the capability of modifying the rendering parameters of individual video objects, executing specific actions assigned to video objects when conditions become true, and the ability to modify the overall system status and perform non-linear video navigation. This is achieved through the control information that is attached to individual objects.

Another object of the invention is to provide interactive non-linear video and composite media where the system is capable of responding in one instance to direct user interaction with hyperlinked objects by jumping to the specified atget scene. In another instance the path taken through given portions of the video is indirectly determined by user interaction with other not directly related objects. For example the system may track what scenes have been viewed previously and automatically determine the next scene to be displayed based on this history.

Interactive tracking data can be provided to the server during content serving. For downloaded content, the interactive tracking data can be stored on the device for later synchronization back to the server. Hyperlink requests or additional information requests selected during replay of content off-line will be stored and sent to the server for fulfillment on next synchronization (asynchronous uploading of forms and interaction data).

A further object of the invention is to provide the same interactive control over object oriented video whether the video data is being streamed from a remote server or being played offline from local storage. This allows the application of interactive video in the following distribution alternatives; streaming (“pull”), scheduled (“push”), and download. It provides for automatically and asynchronous uploading of forms and interaction data from a client device when using download or scheduled distribution model,

An object of the invention to animate the rendering parameters of audio/visual objects within a scene. This includes, position, scale, orientation, depth, transparency, colour, and volume. The invention aims to achieve this through defining fixed animation paths for rendering parameters, sending commands from a remote server to modify the rendering parameters, and changing the rendering parameters as a direct or indirect consequence of user interaction, such as activating an animation path when a user clicks on an object.

Another object of the invention is to define behaviours to individual audio-visual objects that are executed when users interact with objects, wherein the behaviours include animations, hyper-linking, setting of system states/variables, and control of dynamic media composition.

Another object of the invention is to conditionally execute immediate animations or behavioural actions on objects. These conditions may include the state of system variables, timer events, user events and relationships between objects (e.g., overlapping), the ability to delay these actions until conditions become true, and the ability to define complex conditional expressions. It is further possible to retarget any control from one object to another so that interaction with one object affects another rather than itself.

Another object of the invention includes the ability to create video menus and simple forms for registering user selections. Said forms being able to be automatically uploaded to a remote server synchronously if online or asynchronously if the system off-line.

An object of the invention is to provide interactive video, which includes the ability to define loops; such as looping the play of an individual object's content or looping of object control information or looping entire scenes.

Another object of the invention is to provide multi-channel control where subscribers can change the viewed content stream to another channel such as to/from a unicast (packet switched connection) session from/to a multicast (packet or circuit switched) channel. For example interactive object behaviour may be used to implement a channel changing feature where interacting with an object executes changing channels by changing from a packet switched to circuit switched connections in devices supporting both connection modes and changing between unicast and broadcast channels in a circuit switched connection and back again.

Another object of the invention is to provide content personalisation through dynamic media composition (“DMC”) which is the process of permitting the actual content of a displayed video scene to be changed dynamically, in real-time while the scene is being viewed, by inserting, removing or replacing any of the arbitrary shaped visual/audio video objects that the scene includes, or by changing the scene in the video clip.

An example would be an entertainment video containing video object components, which relate to the subscribers user profile. For example in a movie scene, a room could contain golf sporting equipment rather than tennis. This would be particularly useful in advertising media where there is a consistent message but with various alternative video object components.

Another object of the invention is to enable the delivery and insertion of a targeted in-picture interactive advertising video object with or without interactive behaviour into a viewed scene as an embodiment of the dynamic media process. The advertising object may be targeted to the user based on time of day, geographic location, user profile etc. Furthermore, the invention aims to allow for the handling of various kinds of immediate or delayed interactive response to user interaction (eg a user click) with said object including removal of advertisement, performing a DMC operation such as immediately replacing the advertising object with another object or replacing the viewed scene with a new one, registering the user for offline follow-up actions, and jumping to a new hyperlink destination or connection at the end of the current video scene/session, or and changing the transparency of the advertising object or making it go away or disappear. Tracking of user interaction with advertisment objects when these are provided in a real-time streaming scenario further permits customisation of targetting purposes or evaluation of advertising effectiveness.

Another object of the invention is to subsidise call charges associated with wireless network or smartphone use through advertising by automatically displaying a sponsor's video advertising object for a sponsored call during or at the end of a call. Alternatively, displaying an interactive ivdeo object prior to, during or after the call offering sponsorship if the user performs some interaction with the object.

An object of the invention is to provide a wireless interactive e-commerce system for mobile devices using audio and visual data in online and off-line scenarios. The e-commerce include marketing/promotional purposes using either hyper-linked in-picture advertising or interactive video brochures with nonliner navigation, or direct online shopping where individual sale items can be created as objects so that users may interact with them such as dragging them into shopping baskets etc.

An object of the invention includes a method and system to freely provide to the public, (or at subsidised cost), memory devices such as compact flash or memory stick or a memory devices having some other form factor that contains interactive video brochures with advertising or promotional material or product information. The memory devices are preferably read only devices, although other types of memory can be used. The memory devices may be configured to provide a feedback mechanism to the producer, using either online communication, or by writing some data back on to the memory card which is then deposited at some collection point. Without using physical memory cards, this same objective may be accomplised using local wireless distribution by pushing information to devices following negotiation with the device regarding if the device is prepared to receive the data and the quantity receivable.

An object of the invention is to send to users when in download, interactive video brochures, videozines and video (activity) books so that they can then interact with the brochures including filling out forms, etc. If present in the video brochure and actioned or interacted by a user, user data/forms these will then be asynchronously uploaded to the originating server when the client becomes online again. If desired, the uploading can be performed automatically and/or asynchronously. These brochures may contain video for training/educational, marketing or promotional, product information purposes and the collected user interaction information may be a test, survey, request for more information, purchase order etc. The interactive video brochures, videozines and video (activity) books may be created with in-picture advertising objects.

A further object of the invention is to create unique video based user interfaces for mobile devices using our object based interactive video scheme.

A further object of the invention is to provide video mail for wirelessly connected mobile users where electronic greeting cards and messages may be created and customised and forwarded among subscribers.

A further object of the invention is to provide local broadcast as in sports arenas or other local environments such as airports, shopping malls with back channel interactive user requests for additional information or e-commerce transactions.

Another object of the invention is to provide a method for voice command and control of online applications using the interactive video systems.

Another object of the invention is to provide a wireless ultrathin clients to provide access to remote computing servers via wireless connections. The remote computing server may be a privately owned computer or provided by an application service provider.

Still another object of the invention is to provide videoconferencing including multiparty video conferencing on low-end wireless devices with or without in-picture advertising.

Another object of the invention is to provide a method of video surveillance, whereby a wireless video surveillance system inputs signals from video cameras, video storage devices, cable TV and broadcast TV, streaming Internet video for remote viewing on a wirelessly connected PDA or mobile phone. Another object of the invention is to provide a traffic monitoring service using a street traffic camera.

### SUMMARY OF THE INVENTION

System/Codec Aspects

The invention provides the ability to stream and/or run video on low-power mobile devices in software, if desired. The invention further provides the use of a quadtree-based codec for colour mapped video data. The invention further provides using a quadtree-based codec with transparent leaf representation, leaf colour prediction using a FIFO, bottom level node type elimination, along with support for arbitrary shape definition.

The invention further includes the use of a quadtree based codec with nth order interpolation for non-bottom leaves and zeroth order interpolation on the bottom level leaves and support for arbitrary shape definition. Thus, features of various embodiments of the invention may include one or more of the following features:

sending colour prequantisation information to permit real-time client side colour quantisation;

using a dynamic octree datastructure to represent the mapping of a 3D data spacing into an adaptive codebook for vector quantisation;

the ability to seamlessly integrating audio, video, text, music and animated graphics into a wireless streaming video scene;

supporting multiple arbitrary shaped video objects in a single scene. This feature is implemented with no extra data overhead or processing overhead, for example by encoding additional shape information separate from luminance or texture information;

basic file format constructs, such as file entity hierarchy, object data streams, separate specification of rendering, definition and content parameters, directories, scenes, and object based controls;

the ability to interact with individual objects in wireless streaming video;

the ability to attach object control data to objects in the video bit streams to control interaction behaviour, rendering parameters, composition etc;

the ability to embed digital rights management information into video or graphic animation data stream for wireless streaming based distribution and for download and play based distribution;

the ability to creating video object user interfaces (“VUI's”) instead of conventional graphic user interfaces (GUI's); and/or

the ability to use an XML based markup language (“IAVML”) or similar scripts to define object controls such as rendering parameters and programmatic control of DMC functions in multimedia presentations.

Interaction Aspects

The invention further provides a method and system for controlling user interaction and animation (self action) by supporting
a method and system for sending object controls from a streaming server to modify data content or rendering of content.
embedding object controls in a data file to modify data content or rendering of content.
the client may optionally execute actions defined by the object controls based on direct or indirect user interaction.

The invention further provides the ability to attach executable behaviours to objects, including: animation of rendering parameters, for audio/visual objects in video scenes, hyperlinks, starting timers, making voice calls, dymaic media composition actions, changing system states (e.g., pause/play), changing user variables (e.g., setting a boolean flag).

The invention also provides the ability to activate object behaviours when users specifically interact with objects (e.g., click on an object or drag anobject) when user events occur (paused button pressed, or key pressed), or when system events occur (e.g., end of scene reached).

The invention further provides a method and system for assigning conditions to actions and behaviours these conditions include timer events (e.g., timer has expired), user events (e.g., key pressed), system events (e.g., scene 2 playing), interaction events (e.g., user clicked on object), relationships between objects (e.g., overlapping), user variables (e.g., boolean flag set), and system status (e.g., playing or paused, streaming or standalone play).

Moreover, the invention provides the ability to form complex conditional expressions using AND-OR plane logic, waiting for conditions to become true before execution of actions, the ability to clear waiting actions, the ability to retarget consequences of interactions with objects and other controls from one object to another, permit objects to be replaced by other objects while playing based on user interaction, and/or permit the creation or instantiation of new objects by interacting with an existing object.

The invention provides the ability to define looping play of object data (i.e., frame sequence for individual objects), object controls (i.e., rendering parameters), and entire scenes (restart frame sequences for all objects and controls).

Further, the invention provides the ability to create forms for user feedback or menus for user control and interaction in streaming mobile video and the ability to drag video objects on top of other objects to effect system state changes.

Dynamic Media Composition

The invention provides the ability to permit the composition of entire videos by modifying scenes and the composition of entire scenes by modifying objects. This can be performed in the case of online streaming, playing video off-line (stand-alone), and hybrid. Individual in-picture objects may be replaced by another object, added to the current scene, and deleted from the current scene.

DMC can be performed in the three modes including fixed, adaptive, and user mediated. A local object library for DMC support can be used to store objects for use in DMC, store objects for direct playing, that can be managed from a streaming server (insert, update, purge), and that can be queried by the server. Additionally the a local object library for DMC support has versioning control for library objects, automatic expiration of non persistent library objects, and automatic object updating from the server. Furthermore, the invention includes multilevel access control for library objects, supports a unique ID for each library object, has a history or status of each library object, and can enable the sharing of specific media objects between two users.

Further Applications

The invention provides ultrathin clients that provide access to remote computing servers via wireless connections, permit users to create, customise and send electronic greeting cards to mobile smart phones, the use of processing spoken voice commands to control the video display, the use of interactive streaming wireless video from a server for training/educational purposes using non-linear navigation, streaming cartoons/graphic animation to wireless devices, wireless streaming interactive video e-commerce applications, targeted in-picture advertising using video objects and streaming video.

In addition, the invention allows the streaming of live traffic video to users. This can be performed in a number of alternative ways including where the user dials a special phone number and then selects the traffic camera location to view within the region handled by the operator/exchange, or where a user dials a special phone number and the user's geographic location (derived from GPS or cell triangulation) is used to automatically provide a selection of traffic camera locations to view. Another alternative exists where the user can register for a special service where the service provider will call the user and automatically stream video showing the motorists route that may have a potential traffic jam. Upon registering the user may elect to nominate a route for this purpose, and may assist with determining the route. In any case the system could track the user's speed and location to determine direction of travel and route being followed, it would then search its list of monitored traffic cameras along potential routes to determine if any sites are congested. If so, the system would call the motorist and present the traffic view. Stationary users or those travelling at walking speeds would not be called. Alternatively given a traffic camera indicating congestion the system may search through the list of registered users that are travelling on that route and alert them.

The invention further provides to the public, either for free or at a subsidised cost, memory devices such as compact flash memory, memory stick, or in any other form factor such as a disc that contain interactive video brochures with advertising or promotional material or product information. The memory devices are preferably read only memories for the user, although other types of memories such as read/write memories can be used, if desired. The memory devices may be configured to provide a feedback mechanism to the producer, using either online communication, or by writing some data back on to the memory memory device which is then deposited at some collection point.

Without using physical memory cards or other memory devices, this same process can be accomplished using local wireless distribution by pushing information to devices following negotiation with the device regarding if the device is prepared to receive the data, and if so, what quantity is receivable. Steps involved may include: a) a mobile device comes into range of a local wireless network (this may be an IEEE 802.11 or bluetooth, etc. type of network), it detects a carrier signal and a server connection request. If acccepted, the client alerts the user by means of an audible alarm or some other method to indicate that it is initiating the transfer; b) if the user has configured a mobile device to accept these connection requests, then the connection is established with the server else the request is rejected; c) the client sends to the server configuration information including device capabilities such as display screen size, memory capacity and CPU speed, device manufacturer/model and operating system; d) the server receives this information and selects the correct data stream to send to the client. If none is suitable then the connection is terminated; e) after the information is transferred the server closes the connection and the client alerts the user to the end of transmission; and f) if the transmission is unduly terminated due to a lost connection before the transmission is completed, the client cleans up any memory used and reinitialises itself for new connection requests.

### STATEMENTS OF THE INVENTION

In accordance with the present invention there is provided a method of generating an object oriented interactive multimedia file, including:

encoding data comprising at least one of video, text, audio, music and/or graphics elements as a video packet stream, text packet stream, audio packet stream, music packet stream and/or graphics packet stream respectively;

combining said packet streams into a single self-contained object, said object containing its own control information;

placing a plurality of said objects in a data stream; and

grouping one or more of said data streams in a single contiguous self-contained scene, said scene including format definition as the initial packet in a sequence of packets.

The present invention also provides a method of mapping in real time from a non-stationary three-dimensional data set onto a single dimension, comprising the steps of:

pre-computing said data; encoding said mapping;

transmitting the encoded mapping to a client; and

said client applying said mapping to the said data.

The present invention also provides a system for dynamically changing the actual content of a displayed video in an object-oriented interactive video system comprising:

a dynamic media composition process including an interactive multimedia file format including objects containing video, text, audio, music, and/or graphical data wherein at least one of said objects comprises a data stream, at least one of said data streams comprises a scene, at least one of said scenes comprises a file;

a directory data structure for providing file information;

selecting mechanism for allowing the correct combination of objects to be composited together;

a data stream manager for using directory information and knowing the location of said objects based on said directory information; and

control mechanism for inserting, deleting, or replacing in real time while being viewed by a user, said objects in said scene and said scenes in said video.

The present invention also provides an object oriented interactive multimedia file, comprising:

a combination of one or more of contiguous self-contained scenes;

each said scene comprising scene format definition as the first packet, and a group of one or more data streams following said first packet;

each said data stream apart from first data stream containing objects which may be optionally decoded and displayed according to a dynamic media composition process as specified by object control information in said first data stream; and

each said data stream including one or more single self-contained objects and demarcated by an end stream marker; said objects each containing it's own control information and formed by combining packet streams; said packet streams formed by encoding raw interactive multimedia data including at least one or a combination of video, text, audio, music, or graphics elements as a video packet stream, text packet stream, audio packet stream, music packet stream and graphics packet stream respectively.

The present invention also provides a method of providing a voice command operation of a low power device capable of operating in a streaming video system, comprising the following steps:

capturing a user's speech on said device;

compressing said speech;

inserting encoded samples of said compressed speech into user control packets;

sending said compressed speech to a server capable of processing voice commands;

said server performs automatic speech recognition;

said server maps the transcribed speech to a command set;

said system checks whether said command is generated by said user or said server;

if said transcribed command is from said server, said server executes said command;

if said transcribed command is from said user said system forwards said command to said user device; and

said user executes said command.

The present invention also provides an image processing method, comprising the step of:

generating a colour map based on colours of an image;

determining a representation of the image using the colour map; and

determining a relative motion of at least a section of the image which is represented using the colour map.

The present invention also provides a method of determining an encoded representation of

an image comprising: analyzing a number of bits utilized to represent a colour;

representing the colour utilizing a first flag value and a first predetermined number of bits, when the number of bits utilized to represent the colour exceeds a first value; and

representing the colour utilizing a second flag value and a second predetermined number of bits, when the number of bits utilized to represent the colour does not exceed a first value.

The present invention also provides an image processing system, comprising means for generating a colour map based on colours of an image;

means for determining a representation of the image using the colour map; and

means for determining a relative motion of at least a section of the image which is represented using the colour map.

The present invention also provides an image encoding system for determining an encoded representation of an image comprising:

means for analyzing a number of bits utilized to represent a colour;

means for representing the colour utilizing a first flag value and a first predetermined number of bits, when the number of bits utilized to represent the colour exceeds a first value; and

means for representing the colour utilizing a second flag value and a second predetermined number of bits, when the number of bits utilized to represent the colour does not exceed a first value.

The present invention also provides a method of processing objects, comprising the steps of:

parsing information in a script language;

reading a plurality of data sources containing a plurality of objects in the form of at least one of video, graphics, animation, and audio;

attaching control information to the plurality of objects based on the information in the script language; and

interleaving the plurality of objects into at least one of a data stream and a file.

The present invention also provides a system for processing objects, comprising:

means for parsing information in a script language;

means for reading a plurality of data sources containing a plurality of objects in the form of at least one of video, graphics, animation, and audio;

means for attaching control information to the plurality of objects based on the information in the script language; and

means for interleaving the plurality of objects into at least one of a data stream and a file.

The present invention also provides a method of remotely controlling a computer, comprising the step of:

performing a computing operation at a server based on data,

generating image information at the server based on the computing operation;

transmitting, via a wireless connection, the image information from the server to a client computing device without transmitting said data;

receiving the image information by the client computing device; and

displaying the image information by the client computing device.

The present invention also provides a system for remotely controlling a computer, comprising:

means for performing a computing operation at a server based on data;

means for generating image information at the server based on the computing operation;

means for transmitting, via a wireless connection, the image information from the server to a client computing device without transmitting said data;

means for receiving the image information by the client computing device; and means for displaying the image information by the client computing device.

The present invention also provides a method of transmitting an electronic greeting card, comprising the steps of:

inputting information indicating features of a greeting card;

generating image information corresponding to the greeting card;

encoding the image information as an object having control information;

transmitting the object having the control information over a wireless connection;

receiving the object having the control information by a wireless hand-held computing device;

decoding the object having the control information into a greeting card image by the wireless hand-held computing device; and

displaying the greeting card image which has been decoded on the hand-held computing device.

The present invention also provides a system transmitting an electronic greeting card, comprising:

means for inputting information indicating features of a greeting card;

means for generating image information corresponding to the greeting card;

means for encoding the image information as an object having control information;

means for transmitting the object having the control information over a wireless connection;

means for receiving the object having the control information by a wireless hand-held computing device;

means for decoding the object having the control information into a greeting card image by the wireless hand-held computing device; and

means for displaying the greeting card image which has been decoded on the hand-held computing device.

The present invention also provides a method of controlling a computing device, comprising the steps of:

inputting an audio signal by a computing device;

encoding the audio signal;

transmitting the audio signal to a remote computing device;

interpreting the audio signal at the remote computing device and generating information corresponding to the audio signal;

transmitting the information corresponding to the audio signal to the computing device;

controlling the computing device using the information corresponding to the audio signal.

The present invention also provides a system for controlling a computing device, comprising:

inputting an audio signal by a computing device;

encoding the audio signal;

transmitting the audio signal to a remote computing device;

interpreting the audio signal at the remote computing device and generating information corresponding to the audio signal;

transmitting the information corresponding to the audio signal to the computing device; and

controlling the computing device using the information corresponding to the audio signal.

The present invention also provides a system for performing a transmission, comprising:

means for displaying an advertisement on a wireless hand-held device;

means for transmitting information from the wireless hand-held device; and

means for receiving a discounted price associated with the information which has been transmitted because of the display of the advertisement.

The present invention also provides a method of providing video, comprising the steps of:

determining whether an event has occurred; and

obtaining a video of an area transmitting to a user by a wireless transmission the video of the area in response to the event.

The present invention also provides a system for providing video, comprising:

means for determining whether an event has occurred;

means for obtaining a video of an area; and

means for transmitting to a user by a wireless transmission the video of the area in response to the event.

The present invention also provides an object oriented multimedia video system capable of supporting multiple arbitrary shaped video objects without the need for extra data overhead or processing overhead to provide video object shape information.

The present invention also provides a method of delivering multimedia content to wireless devices by server initiated communications wherein content is scheduled for delivery at a desired time or cost effective manner and said user is alerted to completion of delivery via device's display or other indicator.

The present invention also provides an interactive system wherein stored information can be viewed offline and stores user input and interaction to be automatically forwarded over a wireless network to a specified remote server when said device next connects online.

The present invention also provides a video encoding method, including:

encoding video data with object control data as a video object; and

generating a data stream including a plurality of said video object with respective video data and object control data.

The present invention also provides a video encoding method, including:

quantising colour data in a video stream based on a reduced representation of colours;

generating encoded video frame data representing said quantised colours and transparent regions; and

generating encoded audio data and object control data for transmission with said encoded video data.

The present invention also provides a video encoding method, including:
(i) selecting a reduced set of colours for each video frame of video data;
(ii) reconciling colours from frame to frame;
(iii) executing motion compensation;
(iv) determining update areas of a frame based on a perceptual colour difference measure;
(v) encoding video data for said frames into video objects based on steps (i) to (iv); and
(vi) including in each video object animation, rendering and dynamic composition controls.

The present invention also provides a wireless streaming video and animation system, including:
(i) a portable monitor device and first wireless communication means;
(ii) a server for storing compressed digital video and computer animations and enabling a user to browse and select digital video to view from a library of available videos; and
(iii) at least one interface module incorporating a second wireless communication means for transmission of transmittable data from the server to the portable monitor device, the portable monitor device including means for receiving said transmittable data, converting the transmittable data to video images displaying the video images, and permitting the user to communicate with the server to interactively browse and select a video to view.

The present invention also provides a method of providing wireless streaming of video and animation including at least one of the steps of:
(a) downloading and storing compressed video and animation data from a remote server over a wide area network for later transmission from a local server;
(b) permitting a user to browse and select digital video data to view from a library of video data stored on the local server;
(c) transmitting the data to a portable monitor device; and
(d) processing the data to display the image on the portable monitor device.

The present invention also provides a method of providing an interactive video brochure including at least one of the steps of:
(a) creating a video brochure by specifying (i) the various scenes in the brochure and the various video objects that may occur within each scene, (ii) specifying the preset and user selectable scene navigational controls and the individual composition rules for each scene, (iii) specifying rendering parameters on media objects, (iv) specifying controls on media objects to create forms to collect user feedback, (v) integrating the compressed media streams and object control information into a composite data stream.

The present invention also provides a method of creating and sending video greeting cards to mobile devices including at least one of the steps of:
(a) permitting a customer to create the video greeting card by (i) selecting a template video scene or animation form a library, (ii) customising the template by adding user supplied text or audio objects or selecting video objects from a library to be inserted as actors in the scene;
(b) obtaining from the customer (i) identification details, (ii) preferred delivery method, (iii) payment details, (iv) the intended recipient's mobile device number; and
(c) queuing the greeting card depending on the nominated delivery method until either bandwidth becomes available or off peak transport can be obtained, polling the recipient's device to see if it is capable of processing the greeting card and if so forwarding to the nominated mobile device.

The present invention also provides a video decoding method for decoding the encoded data.

The present invention also provides a dynamic colour space encoding method to permit further colour quantisation information to be sent to the client to enable real-time client based colour reduction.

The present invention also provides a method of including targeted user and/or local video advertising.

The present invention also includes executing an ultrathin client, which may be wireless, and which is able to provide access to remote servers.

The present invention also provides a method for multivideo conferencing.

The present invention also provides a method for dynamic media composition.

The present invention also provides a method for permitting users to customise and forward electronic greeting cards and post cards to mobile smart phones.

The present invention also provides a method for error correction for wireless streaming of multimedia data.

The present invention also provides systems for executing any one of the above methods, respectively.

The present invention also provides server software for permitting users to a method for error correction for wireless streaming of video data.

The present invention also provides a computer software for executing steps of any one of the above methods, respectively.

The present invention also provides a video on demand system. The present invention also provides a video security system. The present invention also provides an interactive mobile video system.

The present invention also provides a method of processing spoken voice commands to control the video display.

The present invention also provides software including code for controlling object oriented video and/or audio. Advantageously, the code may include IAVML instructions, why may be based on XML.

### BRIEF DESCRIPTION OF DRAWINGS

Preferred embodiments of the present invention are hereinafter described, by way of example only, with reference to the accompanying drawings, wherein:

FIG. 1 is a simplified block diagram of an object oriented multimedia system of one embodiment of the present invention;

FIG. 2 is a schematic diagram illustrating the three major packet types interleaved into an object oriented data stream of the embodiment illustrated in FIG. 1;

FIG. 3 is a block diagram illustrating the three phases of data processing in an object oriented multimedia player embodiment of the present invention;

FIG. 4 is a schematic diagram showing the hierarchy of object types in an object oriented data file according to the present invention;

FIG. 5 is a diagram showing a typical packet sequence in a data file or stream according to the present invention;

FIG. 6 is a diagram illustrating the information flow between client and server components of an object oriented multimedia player according to the present invention;

FIG. 7 is a block diagram showing the major components of an object oriented multimedia player client according to the present invention;

FIG. 8 is a block diagram showing the functional components of an object oriented multimedia player client according to the present invention;

FIG. 9 is a flow chart describing the major steps in the multi-object client rending process according to the present invention;

FIG. 10 is a block diagram of a preferred embodiment of the client rendering engine according to the present invention;

FIG. 11 is a block diagram of a preferred embodiment of the client interaction engine according to the present invention;

FIG. 12 is a component diagram describing an embodiment of an interactive multi-object video scene with DMC functionality.

FIG. 13 is a flow chart describing the major steps in the process the client performs in playing an interactive object oriented video according to the present invention;

FIG. 14 is a block diagram of the local server component of an interactive multimedia player according to the present invention;

FIG. 15 is a block diagram of a remote streaming server according to the present invention;

FIG. 16 Is a flow chart describing the main steps executed by a client performing dynamic media composition according to the present invention;

FIG. 17 Is a flow chart describing the main steps executed by a server client performing dynamic media composition according to the present invention;

FIG. 18 is a block diagram of an object-oriented video encoder according to the present invention;

FIG. 19 is a flow chart of the main steps executed by a video encoder according to the present invention;

FIG. 20 is a block diagram of an input colour processing component of a video encoder according to the present invention;

FIG. 21 is a block diagram of the components of a region update selection process used in a video encoder according to the present invention;

FIG. 22 is a diagram of three fast motion compensation methods used in video encoding;

FIG. 23 is a diagram of the tree splitting method used in a video encoder according to the present invention;

FIG. 24 is a flow chart of the main stages performed to encode the data resulting from the video compression process according to the present invention;

FIG. 25 is a flow chart of the steps for encoding the colour map update information according to the present invention;

FIG. 26 is a flow chart of the steps to encode the quad tree structure data for normal predicted frames according to the present invention;

FIG. 27 is a flow chart of the steps to encode the leaf colour in the quad tree data structure according to the present invention;

FIG. 28 is a flow chart of the main steps executed by a video encoder to compress video key frames according to the present invention;

FIG. 29 is a flow chart of the main steps executed by a video encoder to compress video using the alternate encoding method according to the present invention;

FIG. 30 is a flow chart of the main involved in the prequantisation process to perform real-time colour (vector) quantisation in real-time at the client according to the present invention;

FIG. 31 is a flow chart of the main steps in the voice command process according to the present invention;

FIG. 32 is a block diagram of an ultra-thin computing client Local Area wireless Network (LAN) system according to the present invention;

FIG. 33 is a block diagram of an ultra-thin computing client Wide Area wireless Network (WAN) system according to the present invention;

FIG. 34 is a block diagram of an ultra-thin computing client Remote LAN server system according to the present invention;

FIG. 35 is a block diagram of an multiparty wireless videoconferencing system according to the present invention;

FIG. 36 is a block diagram of one embodiment of an interactive ‘video on demand’ system, with targeted in-picture user advertising, according to the present invention;

FIG. 37 is a flow chart of the main steps involved in the process of delivering and handling one embodiment of an interactive in-picture targeted user advertisement according to the present invention;

FIG. 38 is a flow chart of the main steps involved in the process of playing and handling one embodiment of an interactive video brochure according to the present invention;

FIG. 39 is a flow chart of a sequence of possible user interactions in one embodiment of an interactive video brochure according to the present invention;

FIG. 40 is a flow chart of the main steps involved in push or pull based distribution of video data according to the present invention;

FIG. 41 is a block diagram of an interactive ‘video on demand’ system according to the present invention, with remote server based digital rights management functions including user authentication, access control, billing and usage metering;

FIG. 42 is a flow chart of the main steps of the process that player software performs in playing on demand streaming wireless video according to the present invention;

FIG. 43 is a block diagram of a video security/surveillance systems according to the present invention

FIG. 44 is a block diagram of an electronic greeting card system and service according to the present invention.

FIG. 45 is a flow chart of the main steps involved in creating and sending a personalised electronic video greeting card or video E-mail to a mobile telephone according to the present invention;

FIG. 46 is a block diagram showing the centralised parametric scene description used in the MPEG4 standard;

FIG. 47 is a block diagram showing the main steps in providing colour quantisation data to a decoder for real time colour quantisation according to the present invention;

FIG. 48 is a block diagram showing the main components of an object library according to the present invention;

FIG. 49 is a flowchart of the main steps of a video decoder according to the present invention;

FIG. 50 is a flowchart of the main steps involved in decoding a quad tree encoded video frame according to the present invention.

FIG. 51 is a flowchart of the main steps involved in decoding a leaf colour of a quad tree according to the present invention.

### DETAILED DESCRIPTION OF THE INVENTION

Glossary of Terms

Bit Stream A sequence of bits transmitted from a server to a client, but may be stored in memory.
Data Stream One or more interleaved Packet Streams.
Dynamic Media Composition Changing the composition of a multi-object multimedia presentation in real time.
File An object oriented multimedia file.
In Picture Object An overlayed video object within a scene.
Media Object A combination of one or more interleaved media types including audio, video, vector graphics, text and music.
Object A combination of one or more interleaved media types including audio, video, vector graphics, text and music.
Packet Stream A sequence of data packets belonging to one object transmitted from a server to a client but may be stored in memory.
Scene The encapsulation of one or more Streams, comprising a multi-object multimedia presentation.
Stream A combination of one or more interleaved Packet Streams, stored in an object oriented multimedia file.
Video Object A combination of one or more interleaved media types including audio, video, vector graphics, text and music.
   Acronyms

The following acronyms are used herein:
FIFO First In First Out Buffer.
IAVML Interactive Audio Visual Mark-up Language
PDA Personal Digital Assistant
DMC Dynamic Media Composition
IME Interaction Management Engine
DRM Digital Rights Management
ASR Automatic Speech Recognition
PCMCIA Personal Computer Memory Card International Association
   General System Architecture

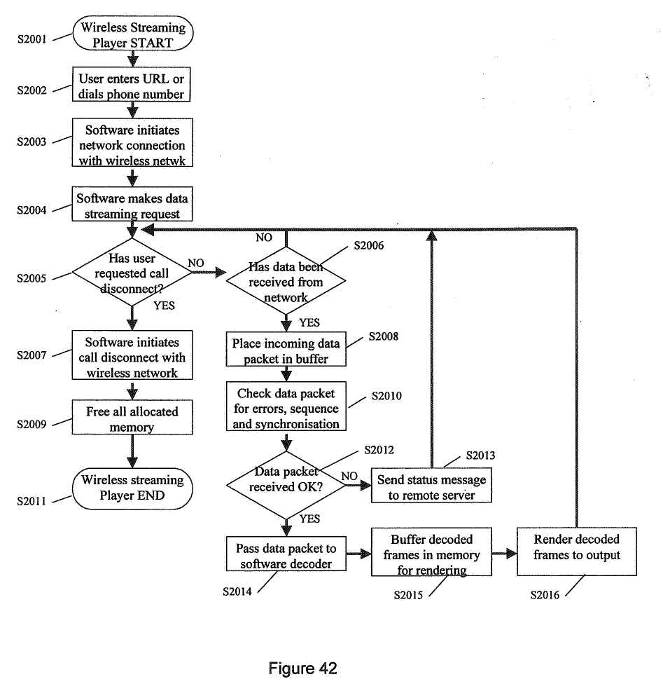

The processes and algorithms described herein form an enabling technology platform for advanced interactive rich media applications such as E-commerce. The great advantage of the methods described is that they can be executed on very low processing power devices such as mobile phones and PDAs in software only, if desired. This will become more apparent from the flow chart and accompanying descriptions as shown in FIG. 42 The specified video codec is fundamental to this technology as it enables the ability to provide advanced object oriented interactive processes in low power, mobile video systems. An important advantage of the system exists in its low overhead. These advanced object oriented interactive processes enable a new level of functionality, user experience and applications than have heretofore been possible on wireless devices.

Typical video players such as MPEG1/2, H.263 players present a passive experience to users. They read a single compressed video data stream and play it by performing a single, fixed decoding transformation on the received data. In contrast, an object oriented video player, as described herein, provides advanced interactive video capabilities and allows dynamic composition of multiple video objects from multiple sources to customise the content that users experience. The system permits not only multiple, arbitrary-shaped video objects to coexist, but also determines what objects may coexist at any moment in real-time, based on either user interaction or predefined settings. For example, a scene in a video may be scripted to have one of two different actors perform different things in a scene depending on some user preference or user interaction.

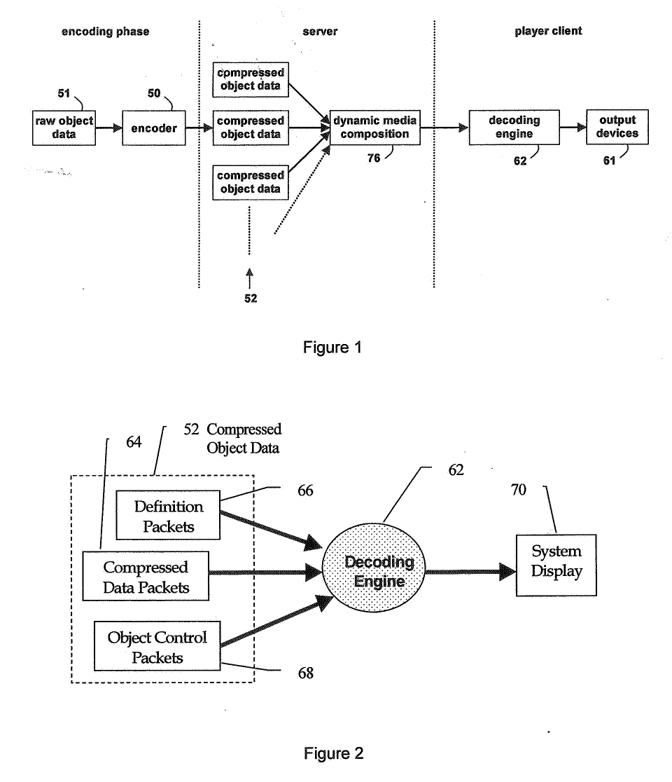

To provide such flexibility, an object oriented video system has been developed including an encoding phase, a player client and server, as shown in FIG. 1. The encoding phase includes an encoder 50, which compresses raw multimedia object data 51 into a compressed object data file 52. The server component includes a programmable, dynamic media composition component 76, which multiplexes compressed object data from a number of encoding phases together with definition and control data according to a given script, and sends the resulting data stream to the player client. The player client includes a decoding engine 62, which decompresses the object data stream and renders the various objects before sending them to the appropriate hardware output devices 61.

Referring to FIG. 2, the decoding engine 62 performs operations on three interleaved streams of data: compressed data packets 64, definition packets 66, and object control packets 68. The compressed data packets 64 contain the compressed object (e.g., video) data to be decoded by an applicable encoder/decoder (‘codec’). The methods for encoding and decoding video data are discussed in a later section. The definition packets 66 convey media format and other information that is used to interpret the compressed data packets 64. The object control packets 68 define object behaviour, rendering, animation and interaction parameters.

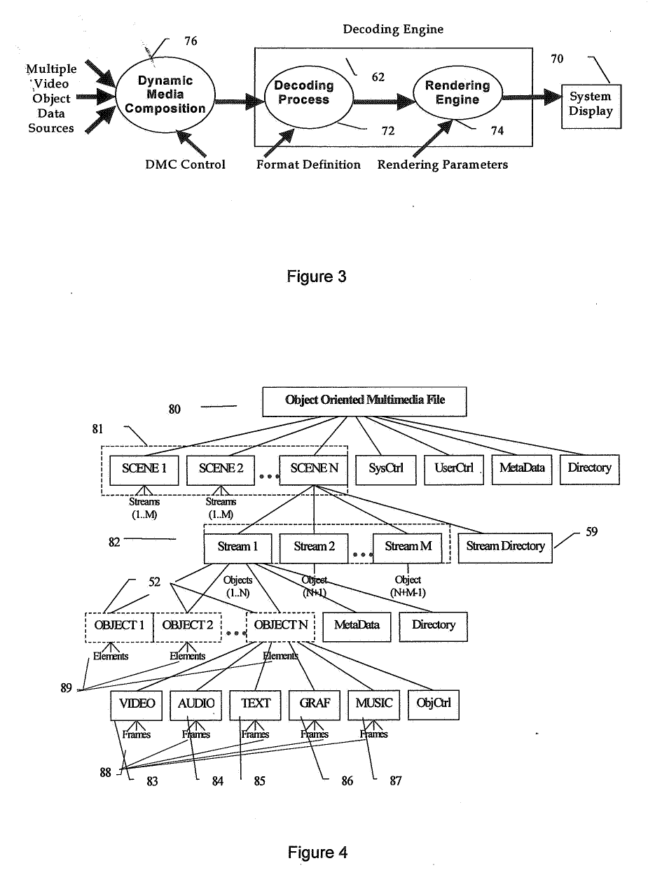

FIG. 3 is a block diagram illustrating the three phases of data processing in an object oriented multimedia player. As shown, three separate transforms are applied to the object oriented data to generate a final audio-visual presentation via a system display 70 and an audio subsystem. A ‘dynamic media composition’ (DMC) process 76 modifies the actual content of the data stream and sends this to the decoding engine 62. In the decoding engine 62, a normal decoding process 72 extracts the compressed audio and video data and sends it to a rendering engine 74 where other transformations are applied, including geometric transformations of rendering parameters for individual objects, (e.g., translation). Each transformation is individually controlled through parameters inserted into the data stream.

The specific nature of each of the final two transformations depends on the output of the dynamic media composition process 76, as this determines the content of the data stream passed to the decoding engine 62. For example, the dynamic media composition process 76 may insert a specific video object into the bit stream. In this case, in addition to the video data to be decoded, the data bit stream will contain configuration parameters for the decoding process 72 and the rendering engine 74.

The object oriented bit stream data format permits seamless integration between different kinds of media objects, supports user interaction with these objects, and enables programmable control of the content in a displayed scene, whether streaming the data from a remote server or accessing locally stored content.

FIG. 4 is a schematic diagram showing the hierarchy of object types in an object oriented multimedia data file. The data format defines a hierarchy of entities as follows: an object oriented data file 80 may contain one or more scenes 81. Each scene may contain one or more streams 82 which contain one or more separate simultaneous media objects 52. The media objects 52 may be of a single media element 89 such as video 83, audio 84, text 85, vector graphics (GRAF) 86, music 87 or composites of such elements 89. Multiple instances of each of the above said media types may simultaneously occur together with other media types in a single scene. Each object 52 can contain one or more frames 88 encapsulated within data packets. When more than one media object 52 is present in a scene 81, the packets for each are interleaved. A single media object 52 is a totally self-contained entity that has virtually no dependencies. It is defined by a sequence of packets including one or more definition packets 66, followed by data packets 64 and any control packets 68 all bearing the same object identifier number. All packets in the data file have the same header information (the baseheader) which specifies the object that the packet corresponds to, the type of data in the packet, the number of the packet in a sequence and the amount of data (size) the packet contains. Further details of the file format are described in a later section.

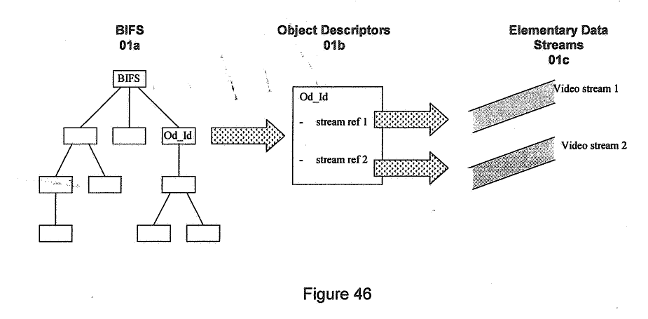

The distinction with the MPEG4 system will be readily observed. Refering to FIG. 46, MPEG4 relies on a centralised parametric scene description in the form of the Binary Format for Scenes (BIFS) 01a, which is a hierarchical structure of nodes that can contain the attributes of objects and other information. BIFS 01a is borrowed directly from the very complex Virtual Reality Markup Language (VRML) Grammar. In this approach, the centralised BIFS structure 01a is actually the scene itself: it is the fundamental component in an object oriented video, not the objects themselves. Video object data may be specifed for use in a scene, but does not serve in defining the scene itself. So, for example, a new video object cannot be introduced into a scene unless the BIFS structure 01a is first modified to include a node that references the video data. The BIFS also does not directly reference any object data streams; instead, a special intermediary independent device called an object descriptor 01b maps between any OBJ_IDs in the nodes of a BIFS 01a and the elementary data streams 01c which contain video data. Hence in the MPEG approach each of these three separate entities 01a, 01b, 01c, are interdependent, so that if an object stream is copied to another file, it loses any interactive behaviour and any other control information associated with it. Since MPEG4 is not object-centric, its data packets are referred to as atoms which have a common header consisting of only type and packet size information, but no object identifier.

The format described herein is much simpler, since there is no central structure that defines what the scene is. Instead, the scene is self-contained and completely defined by the objects that inhabit the scene. Each object is also self-contained, having attached any control information that specifies the attributes and interactive behaviour of the object. New objects can be copied into a scene just by inserting their data into the bitstream, doing this introduces all of the objects' control information into the scene as well as their compressed data. There are virually no interdependencies between media objects or between scenes. This approach reduces the complexity and the storage and processing overheads associated with the complex BIFs approach.

In the case of download and play of video data, to allow interactive, object oriented manipulation of multimedia data, such as the ability to choose which actors appear in a scene, the input data does not include a single scene with a single “actor” object, but rather one or more alternative object data streams within each scene that may be selected or “composited-in” to the scene displayed at run-time, based on user input. Since the composition of the scene is not known prior to runtime, it is not possible to interleave the correct object data streams into the scene.

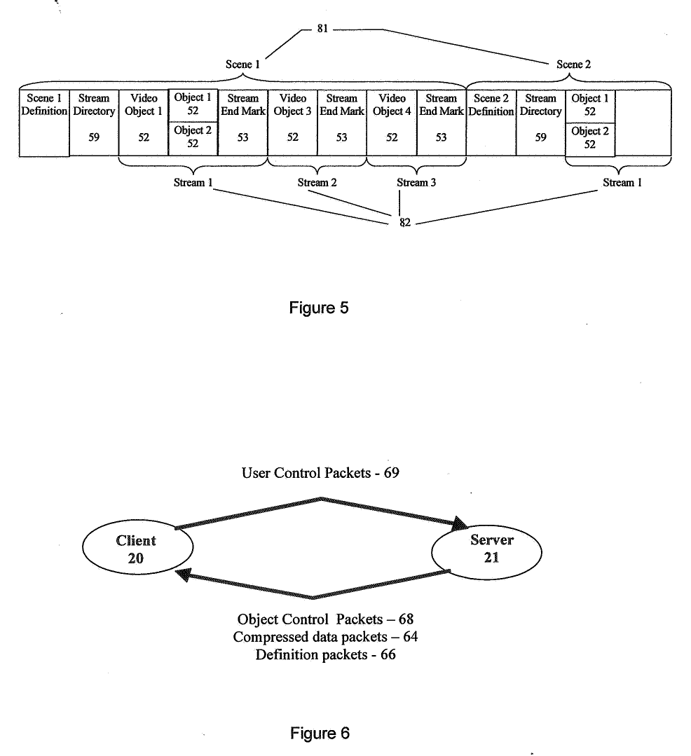

FIG. 5 is a diagram showing a typical packet sequence in a data file. A stored scene 81 includes a number of separate selectable streams 82, one for each “actor” object 52 that is a candidate for the dynamic media composition process 76, referred to in FIG. 3. Only the first stream 82 in a scene 81 contains more than one (interleaved) media object 52. The first stream 82 within a scene 81 defines the scene structure, the constituent objects and their behaviour. Additional streams 82 in a scene 81 contain optional object data streams 52. A directory 59 of streams is provided at the beginning of each scene 81 to enable random access to each separate stream 82.

While the bit stream is capable of supporting advanced interactive video capabilities and dynamic media composition, it supports three implementation levels, providing various levels of functionality. These are:

1. Passive media: Single-object, non-interactive player

2. Interactive media: Single-object, limited interaction player

3. Object-oriented active media: Multi-object, fully interactive player

The simplest implementation provides a passive viewing experience with a single instance of media and no interactivity. This is the classic media player where the user is limited to playing, pausing and stopping the playback of normal video or audio.

The next implementation level adds interaction support to passive media by permitting the definition of hot regions for click-through behaviour. This is provided by creating vector graphic objects with limited object control functionality. Hence the system is not literally a single object system, although it would appear so to the user. Apart from the main media object being viewed transparent, clickable vector graphic objects are the other types of objects permitted. This allows simple interactive experiences to be created such as non-linear navigation, etc.

The final implementation level defines the unrestricted use of multiple objects and full object control functionality, including animations, conditional events, etc., and uses the implementation of all of the components in this architecture. In practice, the differences between this level and the previous may only be cosmetic.

FIG. 6 is a diagram illustrating the information flow (or bit stream) between client and server components of an object-oriented multimedia system. The bit stream supports client side and server side interaction. Client side interaction is supported via a set of defined actions that may be invoked through objects that cause modification of the user experience, shown herein as object control packets 68. Server side interaction support is where user interaction, shown here as user control packets 69, is relayed from a client 20 to a remote server 21 via a back channel, and provides mediation of the service/content provision to online users, predominantly in the form of dynamic media composition. Hence an interactive media player to handle the bit stream has a client-server architecture. The client 20 is responsible for decoding compressed data packets 64, definition packets 66 and object control packets 68 sent to it from the server 21. Additionally the client 20 is responsible for object synchronisation, applying the rendering transformations, compositing the final display output, managing user input and forwarding user control back to the server 21. The server 21 is responsible for managing, reading, and parsing partial bit streams from the correct source(s), constructing a composite bit stream based on user input with appropriate control instructions from the client 20, and forwarding the bit stream to the client 20 for decoding and rendering. This server side Dynamic Media Composition, illustrated as component 76 of FIG. 3, permits the content of the media to be composited in real-time, based on user interaction or predefined settings in a stored program script.

The media player supports both server side and client side interaction/functionality when playing back data stored locally, and also when the data is being streamed from a remote server 21. Since it is the responsibility of the server component 21 to perform the DMC and manage sources, in the local playback case the server is co-located with the client 20, while being remotely located in the streaming case. Hybrid operation is also supported, where the client 20 accesses data from local and remotely located source/servers 21.

Interactive Client

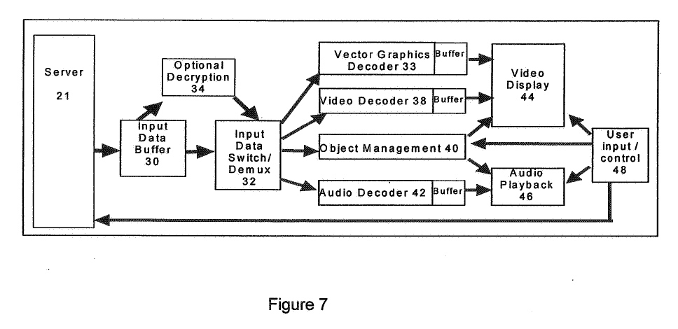

FIG. 7 is a block diagram showing the major components of an object oriented multimedia player client 20. The object oriented multimedia player client 20 is able to receive and decode the data transmitted by the server 21 and generated by the DMC process 76 of FIG. 3. The object oriented multimedia player client 20 also includes a number of components to execute the decoding process. The steps of the decoding process are simplistic when compared to the encoding process, and can be executed entirely by software compiled on a low power mobile computing device such as a Palm Pilot 111c or a smart phone. An input data buffer 30 is used to hold the incoming data from the server 21 until a full packet has been received or read. The data is then forwarded to an input data switch/demux 32, either directly or via a decryption unit 34. The input data switch/demux 32 determines which of sub-processes 33, 38, 40, 42 is required to decode the data, and then forwards the data to the correct component according to the packet type that executes that sub-process. Separate components 33, 38 and 42 perform vector graphics, video, and audio decoding respectively. The video and audio decoding modules 38 and 42 in the decoder independently decompress any data sent to them and perform a preliminary rendering into a temporary buffer. An object management component 40 extracts object behaviour and rendering information for use in controlling the video scene. A video display component 44 renders visual objects on the basis of data received from the vector graphics decoder 33, video decoder 38 and the object management component 40. An audio play back component 46 generates audio on the basis of data received from the audio decoding and object management component 40. A user input/control component 48 generates instructions and controls the video and audio generated by the display and playback components 44 and 46. The user control component 48 also transmits control messages back to the server 21.

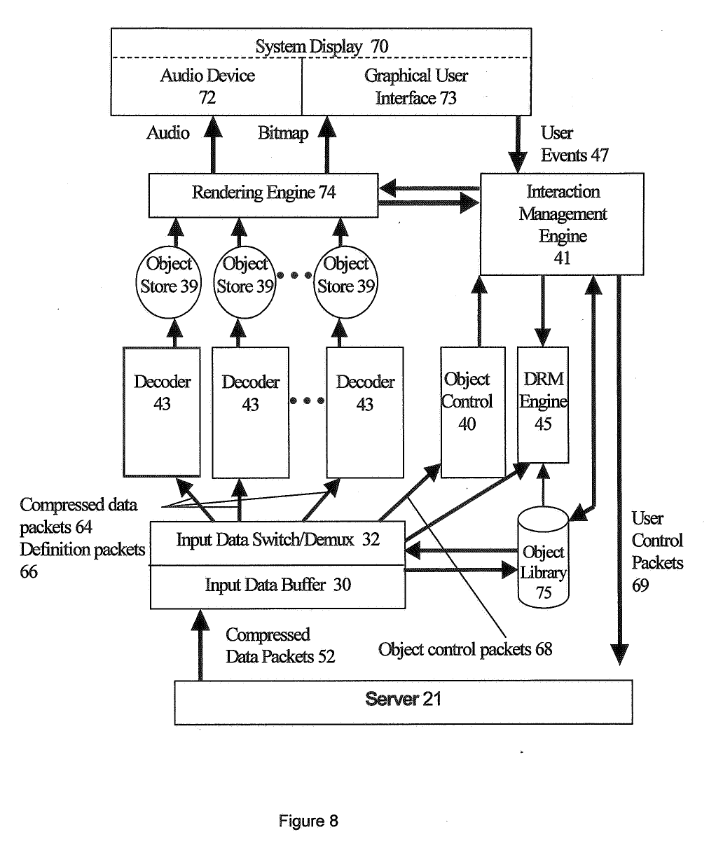

FIG. 8 is a block diagram showing the functional components of an object oriented multimedia player client 20, including the following:
1. Decoders 43 with optional object stores 39 for the main data paths (a combination of a plurality of components 33, 38 and 42 of FIG. 7)
2. Rendering engine 74 (components 44 and 46 of FIG. 7 combined)
3. Interaction management engine 41 (components 40 and 48 of FIG. 7 combined)
4. Object control 40 path (part of component 40 of FIG. 7)
5. Input data buffer 30 and input data switch/demux 32.
6. Optional digital rights management (DRM) engine 45
7. Persistent local object library 75

There are two principle flows of data through the client system 20. Compressed object data 52 is delivered to the client input buffer 30 from the server 21 or the persistent local object library 75. The input data switch/demux 32 splits up the buffered compressed object data 52 into compressed data packets 64, definition packets 66 and object control packets 68. Compressed data packets 64 and definition packets 66 are individually routed to the appropriate decoder 43 based on the packet type as identified in the packet header. Object control packets 68 are sent to the object control component 40 to be decoded. Alternatively, the compressed data packets 64, definition packets 66 and object control packets 68 may be routed from the input data switch/demux 32 to the object library 75 for persistent local storage, if an object control packet is received specifying library update information. One decoder instance 43 and object store 39 exists for each media object and for each media type. Hence there are not only different decoders 43 for each media type, but if there are three video objects in a scene, then there will be three instances of video decoders 43. Each decoder 43 accepts the appropriate compressed data packets 64 and definition packets 66 sent to it and buffers the decoded data in the object data stores 39. Each object store 39 is responsible for managing the synchronisation of each media object in conjunction with the rendering engine 74; if the decoding is lagging the (video) frame refresh rate, then the decoder 43 is instructed to drop frames as appropriate. The data in the object stores 39 is read by the rendering engine 74 to compose the final displayed scene. Read and write access to the object data stores 39 is asynchronous such that the decoder 43 may only update the object data store 39 at a slow rate, while the rendering engine 74 may be reading that data at a faster rate, or vice versa, depending on the overall media synchronisation requirements. The rendering engine 74 reads the data from each of the object stores 39 and composes both the final display scene and the acoustic scene, based on rendering information from the interaction management engine 41. The result of this process is a series of bitmaps that are handed over to the system graphical user interface 73 to be displayed on the display device 70 and a series of audio samples to be passed to the system audio device 72.

The secondary data flow through the client system 20 comes from the user via the graphical user interface 73, in the form of User Events 47, to the interaction management engine 41, where the user events are split up, with some of them being passed to the rendering engine 74 in the form of rendering parameters, and the rest being passed back through a back channel to the server 21 as user control packets 69; the server 21 uses these to control the dynamic media composition engine 76. To decide where or if user events are to passed to other components of the system, the interaction management engine 41 may request the rendering engine 74 to perform hit testing. The operation of the interaction management engine 41 is controlled by the object control component 40, which receives instructions (object control packets 68) sent from the server 21 that define how the interaction management engine 41 interprets user events 47 from the graphical user interface 73, and what animations and interactive behaviours are associated with individual media objects. The interaction management engine 41 is responsible for controlling the rendering engine 74 to carry out the rendering transformations. Additionally, the interaction management engine 41 is responsible for controlling the object library 75 to route library objects into the input data switch/demux 32.

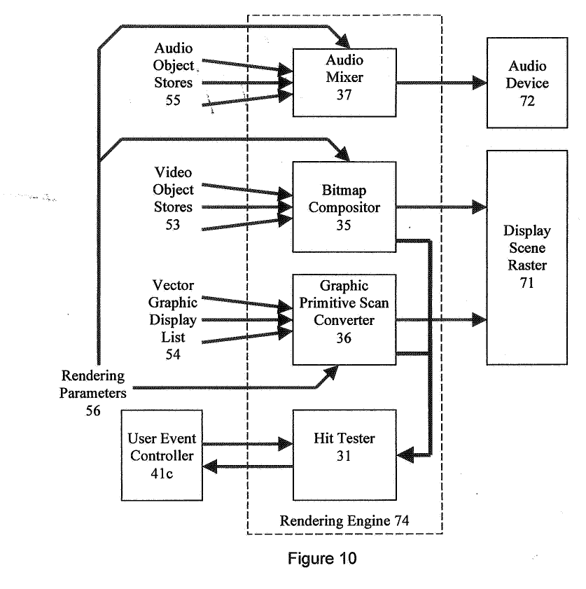

The rendering engine 74 has four main components as shown in FIG. 10. A bitmap compositor 35 reads bitmaps from the visual object store buffers 53 and composites them into the final display scene raster 71. A vector graphic primitive scan converter 36 renders the vector graphic display list 54 from the vector graphic decoder onto the display scene raster 71. An audio mixer 37 reads the audio object stores 55 and mixes the audio data together before passing the result to the audio device 72. The sequence in which the various object store buffers 53 to 55 are read and how their content is transformed onto the display scene raster 71 is determined by rendering parameters 56 from the interaction management engine 41. Possible transformations include Z-order, 3D orientation, position, scale, transparency, colour, and volume. To speed up the rendering process, it may not be necessary to render the entire display scene, but only a portion of it. The fourth main component of the rendering engine is the Hit Tester 31, which performs object hit testing for user pen events as directed by the user event controller 41c of the interaction management engine 41.

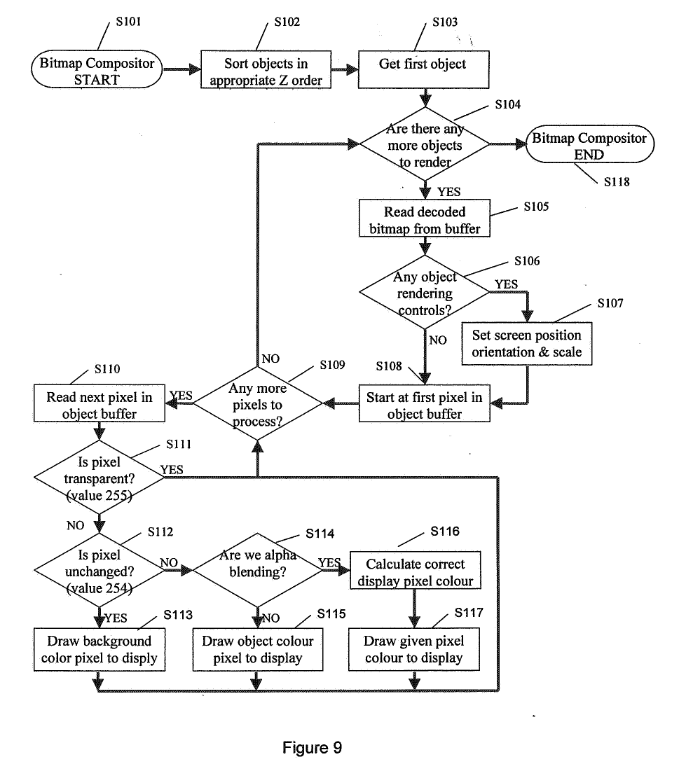

The display scene should be rendered whenever visual data is received from the server 21 according to synchronization information, when a user selects a button by clicking or drags an object that is draggable, and when animations are updated. To render the scene, it may be composited into an offscreen buffer (the display scene raster 71), and then drawn to the output device 70. The object rendering/bitmap compositing process is shown in FIG. 9, beginning at step s101. A list is maintained that contains a pointer to each media object store containing visual objects. The list is sorted according to Z order at step s102. Subsequently, at step s103, the bitmap compositer gets the media object with the lowest Z order. If at step s104 there are no further objects to composite, the video object rendering process ends at step s118. Otherwise, and always in the case of the first object, the decoded bitmap is read from the object buffer at step s105. If, at step s106, there are object rendering controls, then the screen position, orientation and scale are set at step s107. Specifically, the object rendering controls define the appropriate ⅔D geometric transform to determine which coordinates the object pixels are mapped to. The first pixel is read from the object buffer at steps s108, and, if there are more pixels to process at s109, reads the next pixel from the object buffer at step s110. Each pixel in the object buffer is processed individually. If, at step s111, the pixel is transparent (pixel value is 0xFE), then the rendering process ignores the pixel and returns to step s109 to begin processing the next pixel in the object buffer. Otherwise, if the pixel is unchanged (pixel value is 0xFF) at step s112, then a background colour pixel is drawn to the display scene raster at step s113. However, if the pixel is neithier transparent nor unchanged, and alpha blending is not enabled at step s114, the object colour pixel is drawn to the display scene raster at step s115. If alpha blending is enabled at step s114, then an alpha blending composition process is performed to set the defined level of transparency for the object. However, unlike traditional alpha blending processes that need to separately encode the mixing factor for every pixel in a bitmap, this approach does not make use of an alpha channel. Instead, it utilizes a single alpha value specifying the degree of opacity of the entire bitmap in conjunction with embedded indication of transparent regions in the actual bitmap representation. Thus, when the new alpha blending object pixel colour is calculated at step s116, it is drawn to the display scene raster at step s117. This concludes the processing for each individual pixel, thus control returns to step s109, to begin processing the next pixel in the object buffer. If no pixels remain to be processed at step s109, the process returns to step s104 to begin processing the next object. The bitmap compositor 35 reads each video object store in sequence according to the Z-order associated with each media object, and copies it to the display scene raster 71. If no Z order has been explicitly assigned to objects, the z order value for an object can be taken to be the same as the object_ID. If two objects have the same Z order, they are drawn in order of ascending object IDs.

As described, the bitmap compositor 35 makes use of the three region types that a video frame can have: colour pixels to be rendered, areas to be made transparent, and areas to remain unchanged. The colour pixels are appropriately alpha blended into the display scene raster 71, and the unchanged pixels are ignored so the display scene raster 71 is unaffected. The transparent pixels force the corresponding background display scene pixel to be refreshed. This can be performed when the pixel of the object in question is overlaying some other object by simply doing nothing, but if the pixel is being drawn directly over the scene background, then that pixel needs to be set to the scene background colour.

If the object store contains a display list in place of a bitmap, then the geometric transform is applied to each of the coordinates in the display list, and the alpha blending is performed during the scan conversion of the graphics primitives specified within the display list.

Refering to FIG. 10, the bitmap compositor 35 supports display scene rasters with different colour resolutions, and manages bitmaps with different bit depths. If the display scene raster 71 has a depth of 15, 16 or 24 bits, and a bitmap is a colour mapped 8 bit image, then the bitmap compositor 35 reads each colour index value from the bitmap, looks up the colour in the colour map associated with that particular object store, and writes the red, green and blue components of the colour in the correct format to the display scene raster 71. If the bitmap is a continuous tone image, the bitmap compositor 35 simply copies the colour value of each pixel into the correct location on the display scene raster 71. If the display scene raster 71 has a depth of 8 bits and a colour look up table, the approach taken depends on the number of objects displayed. If only one video object is being displayed, then its colour map is copied directly into the colour map of the display scene raster 71. If multiple video objects exist, then the display scene raster 71 will be set up with a generic colour map, and the pixel value set in the display scene raster 71 will be the closest match to the colour indicated by the index value in the bitmap.

The hit tester component 31 of the rendering engine 74 is responsible for evaluating when a user has selected a visual object on the screen by comparing the pen event location coordinates with each object displayed. This ‘hit testing’ is requested by the user event controller 41c of the interaction management engine 41, as shown in FIG. 10, and utilizes object positioning and transformation information provided by the bitmap compositor 35 and vector graphic primitive scan convertor 36 components. The hit tester 31 applies an inverse geometric transformation of the pen event location for each object, and then evaluates the transparency of the bitmap at the resulting inverse-transformed coordinate. If the evaluation is true, a hit is registered, and the result is returned to the user event controller 41c of the interaction management engine 41.

The rendering engines' audio mixer component 37 reads each audio frame stored in the relevant audio object store in round-robin fashion, and mixes the audio data together according to the rendering parameters 56 provided by the interaction engine to obtain the composite frame. For example, a rendering parameter for audio mixing may include volume control. The audio mixer component 37 then passes the mixed audio data to the audio output device 72.

The object control component 40 of FIG. 8 is basically a codec that reads the coded object control packets from the switch/demux input stream and issues the indicated control instructions to the interaction management engine 41. Control instructions may be issued to change individual objects or system wide attributes. These controls are wide-ranging, and include rendering parameters, definition of animation paths, creating conditional events, controlling the sequence of media play including inserting objects from the object library 75, assigning hyperlinks, setting timers, setting and resetting system state registers, etc, and defining user-activated object behaviours.

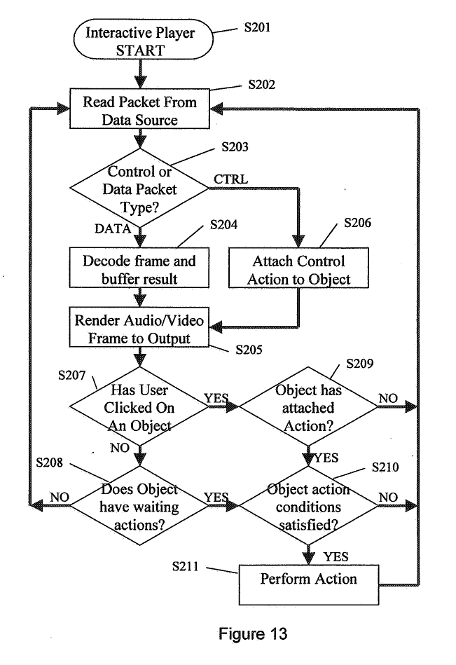

The interaction engine 41 has to manage a number of different processes; the flowchart of FIG. 13 shows the major steps an interactive client performs in playing an interactive object oriented video. The process begins at step s201. Data packets and control packets are read at step s202 from the input data source, either the Object Stores 39 of FIG. 8, or the Object Control component 40 of FIG. 8. If, at step s203, the packet is a data packet, the frame is decoded and buffered at step s204. If, however, the packet is an object control packet, the interaction engine 41 attaches the appropriate action to the object at step s206. The object is then rendered at step s205. If, at step s207, there has been no user interaction with an object (i.e. user has not clicked on the object), and, at step s208, no objects have waiting actions, then the process returns to step s202, and a new packet is read from the input data source at step s202. However, if at step s208, the object has waiting actions, or if there was no user interaction, but the object has an attached action at step s209, the object action conditions are tested at step s210, and if the conditions are satisfied, then the action is performed at step s211. Otherwise, the next packet is read from the input data source at step s202.

The interaction engine 41 has no predefined behaviour: all of the actions and conditions that the interaction management engine 41 may perform or respond to are defined by ObjectControl packets 68, as shown in FIG. 8. The interaction engine 41 may immediately perform predefined actions unconditionally (such as jumping back to the start of a scene when the last video frame in the scene is reached), or delay execution until some system conditions are met (such as a timer event occurring), or it may respond to user input (such as clicking or dragging an object) with a defined behaviour, either unconditionally, or subject to system conditions. Possible actions include rendering attribute changes, animations, looping and non-sequential play sequences, jumping to hyperlinks, dynamic media composition where a displayed object stream is replaced by another object, possibly from the persistent local object library 75, and other system behaviours that are invoked when given conditions or user events become true.

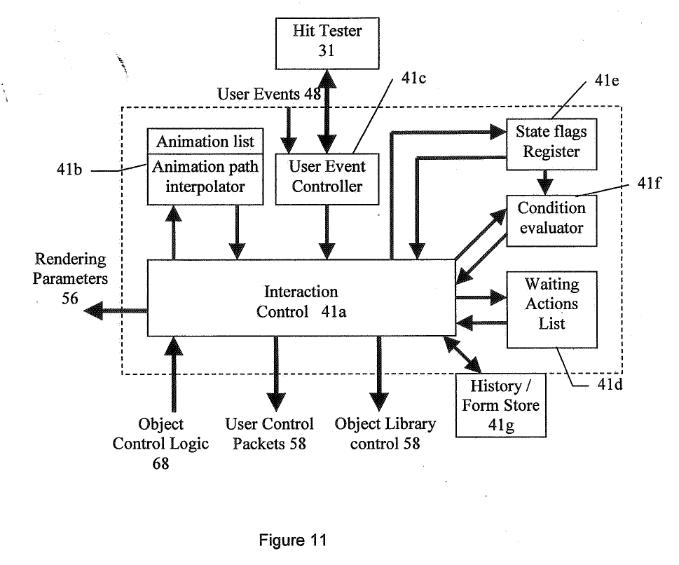

The interaction management engine 41 includes three main components: an interaction control component 41a, a waiting actions manager 41d, and an animation manager 41b, as shown in FIG. 11. The animation manager 41b includes the Interaction Control component 41a and the Animation Path Interpolator/Animation List 41b, and stores all animations that are currently in progress. For each active animation, the manager interpolates the rendering parameters 56 sent to the rendering engine 74 at intervals specified by the object control logic 63. When an animation has completed, it is removed from the list of active animations, the Animation list 41b, unless it is defined to be a looping animation. The waiting actions manager 41d includes the Interaction Control component 41d and the Waiting Actions List 41d, and stores all object control actions to be applied subject to a condition becoming true. The interaction control component 41a regularly polls the waiting actions manager 41d and evaluates the conditions associated with each waiting action. If the conditions for an action are met, the interaction control component 41a will execute the action and purge it from the waiting actions list 41d, unless the action has been defined as an object behaviour, in which case it remains on the waiting actions list 41d for further future executions. For condition evaluation, the interaction management engine 41 employs a condition evaluator 41f, and a state flags register 41e. The state flags register 41e is updated by the interaction control component 41a, and maintains a set of user-definable system flags. The condition evaluator 41f performs condition evaluation as instructed by the interaction control component 41a, comparing the current system state to the system flags in the state flags register 41e on a per object basis, and if the appropriate system flags are set, the condition evaluator 41f notifies the interaction control component 41a that the condition is true, and that the action should be executed. If the client is offline (i.e., not connected to a remote server), the interaction control component 41a maintains a record of all interaction activities performed (user events, etc). These are temporarily stored in the history/form store 41d and are sent to the server using user control packets 69 when the client comes online. Object control packets 68 and hence the object control logic 63 may set a number of user-definable system flags. These are used to permit the system to have a memory of its current state, and are stored in the state flags register 41e. For example, one of these flags may be set when a certain scene or frame in the video is played, or when a user interacts with an object. User interaction is monitored by the user event controller 41c, receiving as input user events 47 from the grapical user interface 73. Additionally, the user event controller 41c may request the rendering engine 74 to perform ‘hit testing’, using the rendering engines' hit tester 31. Typically, hit testing is requested for user pen events, such as user pen click/tap. The user event controller 41c forwards user events to the interaction control component 41a. This may then be used to determine what scene to play next in nonlinear videos, or what objects to render in a scene. In an e-commerce application, the user may drag one or more iconic video objects onto a shopping basket object. This will then register the intended purchases. When the shopping basket is clicked, the video will jump to the checkout scene, where a list of all of the objects that were dragged onto the shopping basket appears, permitting the user to confirm or delete the items. A separate video object can be used as a button, indicating that the user wishes to register the purchase order or cancel it.

Object control packets 68 and hence the object control logic 63 may contain conditions that is satisfied for any specified actions to be executed; these are evaluated by the condition evaluator 41f. Conditions may include the system state, local or streaming playback, system events, specific user interactions with objects, etc. A condition may have the wait flag set, indicating that if the condition isn't currently satisfied, then wait until it is. The wait flag is often used to wait for user events such as penUp. When a waiting action is satisfied, it is removed from the waiting actions list 41d associated with an object. If the behaviour flag of an Object control packet 68 is set, then the action will remain with an object in the waiting actions list 41d, even after it has executed.

An Object control packet 68 and hence the object control logic 63 may specify that the action is to affect another object. In this case, the conditions should be satisfied on the object specified in the base header, but the action is executed on the other object. The object control logic may specify object library controls 58, which are forwarded to the object library 75. For example, the object control logic 63 may specify that a jumpto (hyperlink) action is to be performed together with an animation, with the conditions being that a user click event on the object is required, evaluated by the user event controller 41c in conjunction with the hit tester 31, and that the system should wait for this to become true before executing the instruction. In this case, an action or control will wait in the waiting actions list 41d until it is executed and then it will be removed. A control like this may, for example, be associated with a pair of running shoes being worn by an actor in a video, so that when users click on them, the shoes may move around the screen and zoom in size for a few seconds before the users are redirected to a video providing sales information for the shoes and an opportunity to purchase or bid for the shoes in an online auction.

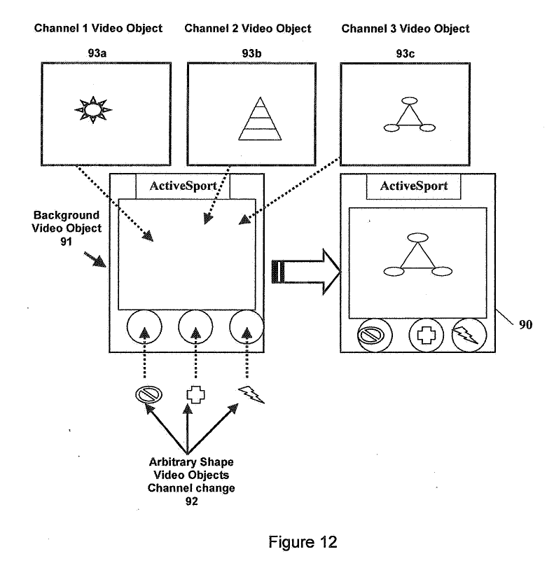

FIG. 12 illustrates the composition of a multi-object interactive video scene. The final scene 90 includes a background video object 91, three arbitary shape “channel change” video objects 92, and three “channel” video objects 93a, 93b and 93c. An object may be defined as a “channel changer” 92 by assigning a control with “behaviour”, “jumpto” and “other” properties, with a condition of user click event. This control is stored in the waiting actions list 41d until the end of the scene occurs and will cause the DMC to change the composition of the scene 90 whenever it is clicked. The “channel changing” object in this illustration would display a miniature version of the content being shown on the other channel.

An object control packet 68, and hence the object control logic 63 may have the animation flag set, indicating that multiple commands will follow rather than a single command (such as move to). If the animation flag isn't set, then the actions are executed as soon as the conditions are satisfied. As often as any rendering changes occur, the display scene should be updated. Unlike most rendering actions that are driven by either user events 47 or object control logic 63, animations should force rendering updates themselves. After the animation is updated, and if the entire animation is complete, it is removed from the animation list 41b. The animation path interpolator 41b determines where, between which two control points, the animation is currently positioned. This information, along with a ratio of how far the animation has progressed between the two control points (the ‘tweening’ value), is used to interpolate the relevant rendering parameters 56. The tween value is expressed as a ratio in terms of a numerator and denominator:
X=x[start]+(x[end]−x[start])*numerator/denominator

If the animation is set to loop, then the start time of the animation is set to the current time when the animation has finished, so that it isn't removed after the update.

The client supports the following types of high-level user interaction: clicking, dragging, overlapping, and moving. An object may have a button image associated with it that is displayed when the pen is held down over an object. If the pen is moved a specified number of pixels when it is down over an object, then the object is dragged (as long as dragging isn't protected by the object or scene). Dragging actually moves the object under the pen. When the pen is released, the object is moved to the new position unless moving is protected by the object or scene. If moving is protected, then the dragged object moves back to its original position when the pen is released. Dragging may be enabled so that users can drop objects on top of other objects (e.g., dragging an item onto a shopping basket). If the pen is released whilst the pen is also over other objects, then these objects are notified of an overlap event with the dragged object.

Objects may be protected from clicks, moving, dragging, or changes in transparency or depth through object control packets 68. A PROTECT command within an object control packet 68 may have individual object scope or system scope. If it has system scope, then all objects are affected by the PROTECT command. System scope protection overrides object scope protection.

The JUMPTO command has four variants. One permits jumping to a new given scene in a separate file specified by a hyperlink, another permits replacing a currently playing media object stream in the current scene with another media object from a separate file or scene specified by a hyperlink, and the other two variants permit jumping to a new scene within the same file or replacing a playing media object with another within the same scene specified by directory indices. Each variant may be called with or without an object mapping. Additionally, a JUMPTO command may replace a currently playing media object stream with a media object from the locally stored persistent object library 75.

While most of the interaction control functions can be handled by the client 20 using the rendering engine 74 in conjunction with the interaction manager 41, some control instances may need to be handled at a lower level and are passed back to the server 21. This includes commands for non-linear navigation, such as jumping to hyperlinks and dynamic scene composition, with the exception of commands instructing insertion of objects from the object library 75.

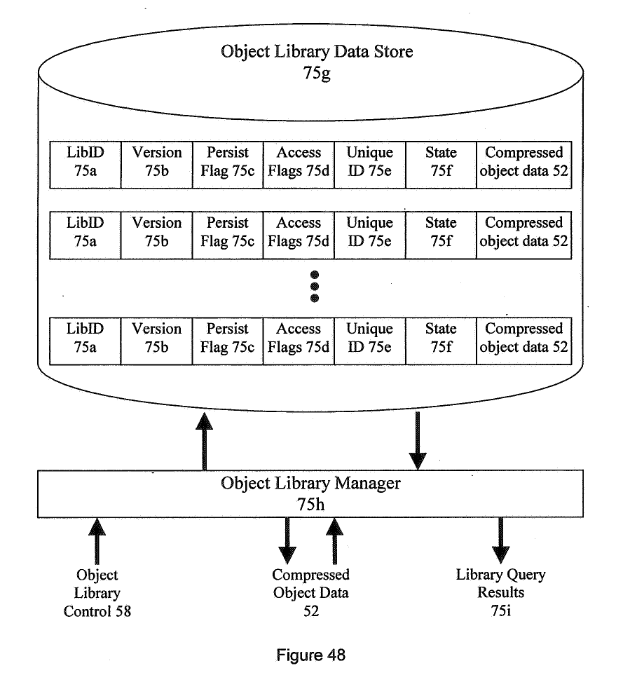

The object library 75 of FIG. 8 is a persistent, local media object library. Objects can be inserted into or removed from this library through special object control packets 68 known as object library control packets, and Scene Definition packets 66 which have the ObjLibrary mode bit field set. The object library control packet defines the action to be performed with the object, including inserting, updating, purging and querying the object library. The input data switch/demux 32 may route compressed data packets 52 directly to the object library 75 if the appropriate object library action (for example insert or update) is defined. As shown in the block diagram of FIG. 48, each object is stored in the object library data store 75g as a separate stream; the library does not support multiple interleaved objects since addressing is based on the library ID that is the stream number. Hence the library may contain up to 200 separate user objects, and the object library may be referenced using a special scene number (for example 250). The library also supports up to 55 system objects, such as default buttons, checkboxes, forms, etc. The library supports garbage collection, such that an object may be set to expire after a certain time period, at which time the object is purged from the library. For each object/stream, the information contained in an object library control packet is stored by the client 20, containing additional information for the stream/object including the library id 75a, version information 75b, object persist information 75c, access restrictions 75d, unique object identifier 75e and other state information 75f. The object stream additionally includes compressed object data 52. The object library 75 may be queried by the interaction management engine 41 of FIG. 8, as directed by the object control component 40. This is performed by reading and comparing the object identifier values sequentially for all objects in the library 75 to find a match against the supplied search key. The library query results 75i are returned to the interaction management engine 41, to be processed or sent to the server 21. The object library manager 75h is responsible for managing all interaction with the object library.

Server Software

The purpose of the server system 21 is to (i) create the correct data stream for the client to decode and render (ii) to transmit said data reliably to the client over a wireless channel including TDMA, FDMA or CDMA systems, and (iii) to process user interaction. The content of the data stream is a function of the dynamic media composition process 76 and non-sequential access requirements imposed by non-linear media navigation. Both the client 20 and server 21 are involved in the DMC process 76. The source data for the composite data stream may come from either a single source or from multiple sources. In the single source case, the source should contain all of the optional data components that may be required to composite the final data stream. Hence this source is likely to contain a library of different scenes, and multiple data streams for the various media objects that are to be used for composition. Since these media objects may be composited simultaneously into a single scene, advanced non-sequential access capabilities are provided on the part of the server 21 to select the appropriate data components from each media object stream in order to interleave them into the final composite data stream to send to the client 20. In the multiple source case, each of the different media objects to be used in the composition can have individual sources. Having the component objects for a scene in separate sources relieves the server 21 of the complex access requirements, since each source need only be sequentially accessed, although there are more sources to manage.

Both source cases are supported. For download and play functionality, it is preferable to deliver one file containing the packaged content, rather than multiple data files. For streaming play, it is preferable to keep the sources separate, since this permits much greater flexibility in the composition process and permits it to be tailored to specific user needs such as targeted user advertising. The separate source case also presents a reduced load on server equipment since all file accesses are sequential.

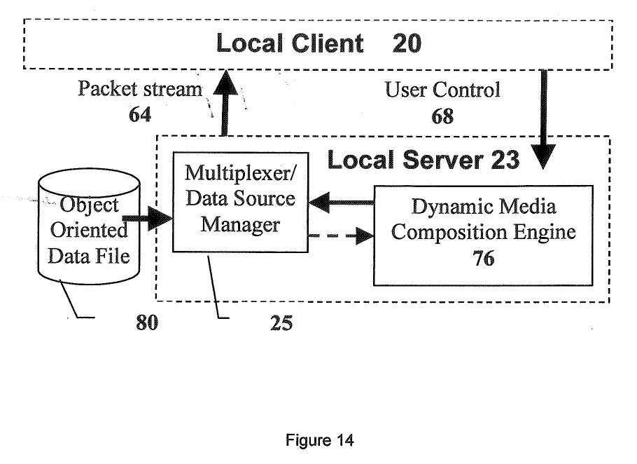

FIG. 14 is a block diagram of the local server component of an interactive multimedia player playing locally stored files. As shown in FIG. 14, standalone players need a local client system 20 and a local single source server system 23.

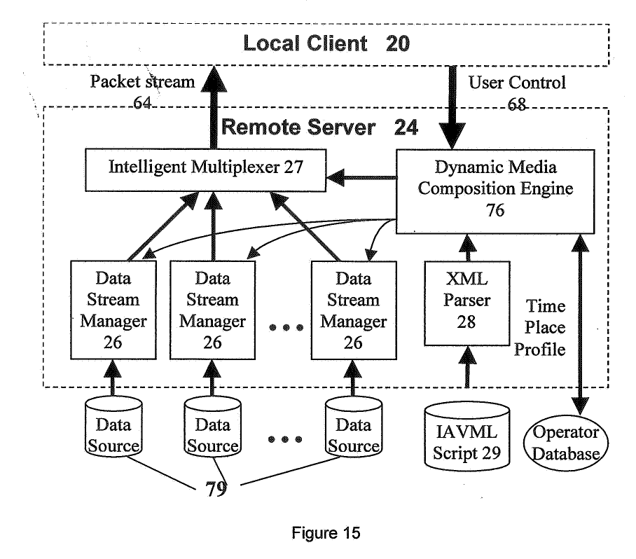

As shown in FIG. 15, streaming players need a local client system 20 and a remote multi-source server 24. However, a player is also able to play local files and streaming content simultaneously, so the client system 20 is also able to simultaneously accept data from both a local server and a remote server. The local server 23 or the remote server 24 may constitute the server 21.

Referring to the simplest case with passive media playback in FIG. 14, the local server 23 opens an object oriented data file 80 and sequentially reads its contents, passing the data 64 to the client 20. Upon a user command performed at user control 68, the file reading operation may be stopped, paused, continued from its current position, or restarted from the beginning of the object oriented data file 80. The server 23 performs two functions: accessing the object oriented data file 80, and controlling this access. These can be generalised into the multiplexer/data source manager 25 and the dynamic media composition engine 76.

In the more advanced case with local playback of video and dynamic media composition (FIG. 14), it is not possible for the client to merely sequentially read one predetermined stream with multiplexed objects, because the contents of the multiplexed stream are not known when the object oriented data file 80 is created. Therefore, the local object oriented data file 80 includes multiple streams for each scene which are stored contiguously. The local server 23 randomly accesses each stream within a scene and selects the objects which need to be sent to the client 20 for rendering. In addition, a persistent object library 75 is maintained by the client 20 and can be managed from the remote server when online. This is used to store commonly downloaded objects such as checkbox images for forms.

The data source manager/multiplexer 25 of FIG. 14 randomly accesses the object oriented data file 80, reads data and control packets from the various streams in the file used to compose the display scene, and multiplexes these together to create the composite packet stream 64 that the client 20 uses to render the composite scene. A stream is purely conceptual as there is no packet indicating the start of a stream. There is, however, an end of stream packet to demarcate stream boundaries as shown at 53 in FIG. 5. Typically, the first stream in a scene contains descriptions of the objects within the scene. Object control packets within the scene may change the source data for a particular object to a different stream. The server 23 then needs to read more than one stream simultaneously from within an object oriented data file 80 when performing local playback. Rather than creating separate threads, an array or linked list of streams can be created. The mutliplexer/data source manager 25 reads one packet from each stream in a round-robin fashion. At a minimum, each stream needs to store the current position in the file and a list of referencing objects.

In this case, the dynamic media composition engine 76 of FIG. 14, upon the receipt of user control information 68 from the client 20, selects the correct combination of objects to be composited together, and ensures that the mutliplexer/data source manager 25 knows where to find these objects, based on directory information provided to the dynamic media composition engine 76 by the multiplexer/data source manager 25. This may also require an object mapping function to map the storage object identifier with the run time object identifier, because they can differ depending upon the composition. A typical situation where this may occur is when multiple scenes in a file 80 may wish to share a particular video or audio object. Since a file may contain multiple scenes, this can be achieved by storing shared content in a special “library” scene. Objects within a scene have object IDs ranging from 0-200, and every time a new scene definition packet is encountered, the scene is reset with no objects. Each packet contains a base header that specifies the type of the packet as well as the object ID of the referenced object. An object ID of 254 represents the scene, whilst an object ID of 255 represents the file. When multiple scenes share an object data stream, it is not known what object IDs will have already been allocated for different scenes; hence, it is not possible to preselect the object IDs in the shared object stream, as these may already be allocated in a scene. One way to get around this problem is to have unique IDs within a file, but this increases storage space and makes it more difficult to manage sparse object IDs. The problem is solved by allowing each scene to use its own object IDs and when a packet from one scene indicates a jump to another scene, it specifies an object mapping between IDs from each scene. When packets are read from the new scene, the mapping is used to convert the object IDs.

Object mapping information is expected to be in the same packet as a JUMPTO command. If this information is not available, then the command is simply ignored. Object mappings may be represented using two arrays: one for the source object IDs which will be encountered in the stream, and the other for destination object IDs which the source object IDs will be converted to. If an object mapping is present in the current stream, then the destination object IDs of the new mapping are converted using the object mapping arrays of the current stream. If an object mapping is not specified in the packet, then the new stream inherits the object mapping of the current stream (which may be null). All object IDs within a stream should be converted. For example, parameters such as: base header IDs, other IDs, button IDs, copyFrame IDs, and overlapping IDs should all be converted into the destination object IDs.

In the remote server scenario, shown in FIG. 15, the server is remote from the client, so that data 64 will be streamed to the client. The media player client 20 is designed to decode packets received from the server 24 and to send back user operations 68 to the server. In this case, it is the remote server's 24 responsibility to respond to user operations (such as clicking an object), and to modify the packet stream 64 being sent to the client. In this case, each scene contains a single multiplexed stream (composed of one or more objects).

In this scenario, the server 24 composes scenes in real-time by multiplexing multiple object data streams based on client requests to construct a single multiplexed packet stream 64 (for any given scene) that is streamed to the client for playback. This architecture allows the media content being played back to change, based on user interaction. For example, two video objects may be playing simultaneously. When the user clicks or taps on one, it changes to a different video object, whilst the other video object remains unchanged. Each video may come from a different source, so the server opens both sources and interleaves the bit streams, adding appropriate control information and forwarding the new composite stream to the client. It is the server's responsibility to modify the stream appropriately before streaming it to the client.

FIG. 15 is a block diagram of a remote streaming server 24. As shown, the remote server 24 has two main functional components similar to the local server: the data stream manager 26 and the dynamic media composition engine 76. However, the server intelligent multiplexer 27 can take input from multiple data stream manager 26 instances, each having a single data source and from the dynamic media composition engine 76, instead of from a single manager with multiple inputs. Along with the object data packets that are multiplexed together from the source(s), the intelligent multiplexer 27 inserts additional control packets into the packet stream to control the rendering of the component objects in the composite scene. The remote data stream managers 26 are also simpler, as they only perform sequential access. In addition to this, the remote server includes an XML parser 28 to enable programmable control of the dynamic media composition through an IAVML script 29. The remote server also accepts a number of inputs from the server operator database 19 to further control and customize the dynamic media composition process 76. Possible inputs include the time of day, day of the week, day of the year, geographic location of the client, and a user's demographic data, such as gender, age, any stored user profiles, etc. These inputs can be utilized in an IAVML script as variables in conditional expressions. The remote server 24 is also responsible for passing user interaction information such as object selections and form data back to the server operator's database 19 for later follow up processing such as data mining, etc.

As shown in FIG. 15, the DMC engine 76 accepts three inputs and provides three outputs. The inputs include an XML based script, user input and database information. The XML script is used to direct the operation of the DMC engine 76 by specifying how to compose the scene being streamed to the client 20. The composition is mediated by possible input from the user's interaction with objects in the current scene that have DMC control operations attached to them, or from input from a separate database. This database may contain information relating to time of day/date, the client's geographic location or the user's profile. The script can direct the dynamic composition process based on any combination of these inputs. This is performed by the DMC process by instructing the data stream managers to open a connection to and read the appropriate object data requried for the DMC operation, it also instructs the intelligent multiplexer to modify its interleaving of object packets received from the data stream managers and the DMC engine 76 to effect the removal, insertion or replacement of objects in a scene. The DMC engine 76 also optionally generates and attaches control information to objects according to the object control specifications for each in the script and provides this to the intelligent multiplexor for streaming to the client 20 as part of the object. Hence all of the processing is performed by the DMC engine 76 and no work is performed by the client 20 other than rendering the self-contained objects according to the parameters provided by any object control information. The DMC process 76 is capable of altering both objects in a scene and scenes in videos.

In contrast to this process is the process required to perform similar functionality in MPEG4. This does not use a scripting language but relies on the BIFS. Hence any modification of scenes requires the separate modification/insertion of the (i) BIFS, (ii) object descriptors, (iii) object shape information, and (iii) video object data packets. The BIFS has to be updated at the client device using a special BIFS-Command protocol. Since MPEG4 has separate but interdependent data components to define a scene, a change in composition cannot be achieved by simply multiplexing the object data packets (with or without control information) into a packet stream, but requires remote manipulation of the BIFS, multiplexing of the data packets and shape information, and the creation and transmision of new object descriptor packets. In addition, if advanced interactive functionality is required for MPEG4 objects, separately written Java programs are sent to the BIFS for execution by the client, which entails a significant processing overhead.

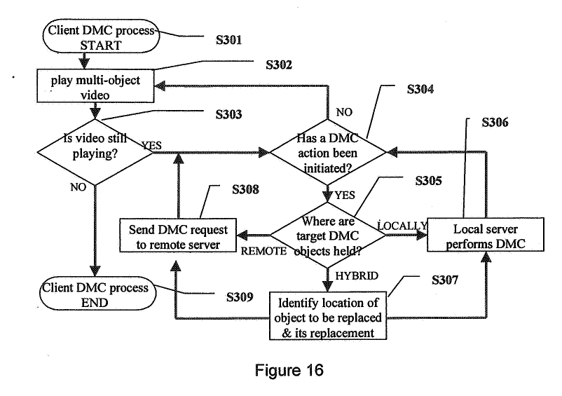

The operation of the local client performing Dynamic Media Composition (DMC) is described by the flow chart shown in FIG. 16. In step s301, the Client DMC Process begins and immediately starts providing object compositing information to the data steam manager, facilitating multi-object video playback as shown in step s302. The DMC checks the user command list and the availability of further multimedia objects to ensure the video is still playing (step s303); if there is no more data or the user has stopped video playback, the Client DMC process ends (step s309). If, at step s303, video playback is to continue, the DMC process will browse the user command list and object control data for any initiated DMC actions. As shown in step s304, if no actions are initiated, the process returns to step s302 and video playback continues. However, if a DMC action has been initiated at step s304, the DMC process checks the location of the target multimedia objects, as shown at step s305. If the target objects are stored locally, the local server DMC process sends instructions to the local data source manager to read the modified object stream from the local source, as shown in step s306; the process then returns to step s304 to check for further initiated DMC actions. If the target objects are stored remotely, the local DMC process sends appropriate DMC instuctions to the remote server, as shown in step s308. Alternativly, the DMC action may require target objects to be sourced both locally and remotely, as shown in step s307, thus appropriate DMC actions are executed by the local DMC process (step s306), and DMC instructions are sent to the remote server for processing (step s308). It is clear from this discussion that the local server supports hybrid, multi-object video playback, where source data is derived both locally and remotely.

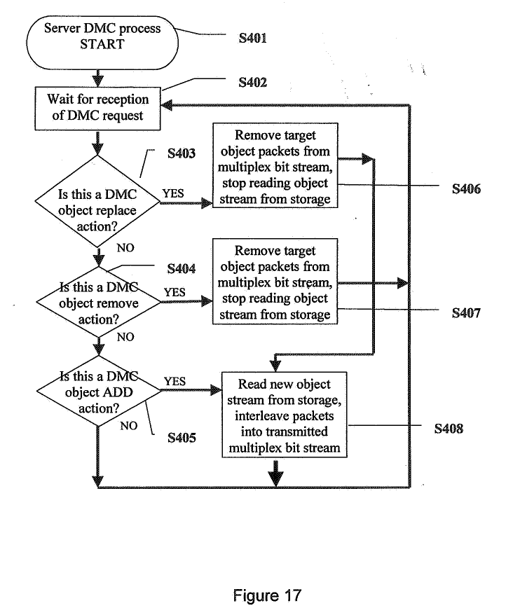

The operation of the Dynamic Media Composition Engine 76 is described by the flow chart shown in FIG. 17. The DMC process begins in step s401, and enters a wait state, step s402, until a DMC request is received. On receipt of a request the DMC engine 76 queries the request type at steps s403, s404 and s405. If at step s403 the request is determined to be an object Replace action, then two target objects exist: an active target object and a new target object to be added to the stream. First, the data stream manager is instructed, at step s406, to delete the active target object packets from the multiplexed bitstream, and to stop reading the active target object stream from storage. Subsequently, the datastream manager is instructed, at step s408, to read the new target object stream from storage, and to interleave these packets into the transmitted multiplex bit stream. The DMC engine 76 then returns to its wait state at step s402. If at step s403 the request was not an object Replace action, then at step s404 if the action type is an object remove action, then one target object exists, which is an active target object. The object Remove action is processed at step s407, where the data stream manager is instructed to delete the active target object packets from the multiplex bitstream, and to stop reading the active target object stream from storage. The DMC engine 76 then returns to its wait state at step s402. If at step s404 the requested action was not an object Remove action, then at step s405 if the action is an object Add action, then one target object exists, which is a new target object. The object Add action is processed at step s408, where the datastream manager is instructed to read the new target object stream from storage, and to interleave these packets into the transmitted multiplex bit stream. The DMC engine 76 then returns to its wait state at step s402. Finally, if the requested DMC action is not an object Replace action (at step s403), or an object Remove action (at step s404), or an object Add action (at step s405), then the DMC engine 76 ignores the request and returns to its wait state at step s402.

Video Decoder

It is inefficient to store, transmit and manipulate raw video data, and so computer video systems normally encode video data into a compressed format. The section following this one describes how video data is encoded into an efficient, compressed form. This section describes the video decoder, which is responsible for generating video data from the compressed data stream. The video codec supports arbitrary-shaped video objects. It represents each video frame using three information components: a colour map, a tree based encoded bitmap, and a list of motion vectors. The colour map is a table of all of the colours used in the frame, specified in 24 bit precision with 8 bits allocated for each of the red, green and blue components. These colours are referenced by their index into the colour map. The bitmap is used to define a number of things including: the colour of pixels in the frame to be rendered on the display, the areas of the frame that are to be made transparent, and the areas of the frame that are to be unchanged. Each pixel in each encoded frame may be allocated to one of these functions. Which of these roles a pixel has is defined by its value. For example, if an 8 bit colour representation is used, then colour value 0xFF may be assigned to indicate that the corresponding on screen pixel is not to be changed from its current value, and the colour value of 0xFE may be assigned to indicate that the corresponding on screen pixel for that object is to be transparent. The final colour of an on-screen pixel, where the encoded frame pixel colour value indicates it is transparent, depends on the background scene colour and any underlying video objects. The specific encoding used for each of these components that makes up an encoded video frame is described below.

The colour table is encoded by first sending an integer value to the bit stream to indicate the number of table entries to follow. Each table entry to be sent is then encoded by first sending its index. Following this, a one bit flag is sent for each colour component (Rf, Gf and Bf) indicating, if it is ON, that the colour component is being sent as a full byte, and if the flag is OFF that the high order nibble (4 bits) of the respective colour component will be sent and the low order nibble is set to zero. Hence the table entry is encoded in the following pattern where the number or C language expression in the parenthesis indicates the number of bits being sent: R(Rf?8:4), G(Gf? 8: 4), B(Bf?8: 4).

The motion vectors are encoded as an array. First, the number of motion vectors in the array is sent as a 16 bit value, followed by the size of the macro blocks, and then the array of motion vectors. Each the entry in the array contains the location of the macro block and the motion vector for the block. The motion vector is encoded as two signed nibbles, one each for the horizontal and vertical components of the vector.

The actual video frame data is encoded using a preordered tree traversal method. There are two types of leaves in the tree: transparent leaves, and region colour leaves. The transparent leaves indicate that the onscreen displayed region indicated by the leaf will not be altered, while the colour leaves will force the onscreen region to the colour specified by the leaf. In terms of the three functions that can be assigned to any encoded pixel as previously described, the transparent leaves would correspond to the colour value of 0xFF while pixels with a value of 0xFE indicating that the on screen region is to be forced to be transparent are treated as normal region colour leaves. The encoder starts at the top of the tree and for each node stores a single bit to indicate if the node is a leaf or a parent. If it is a leaf, the value of this bit is set to ON, and another single bit is sent to indicate if the region is transparent (OFF), otherwise it is set to ON followed by a another one bit flag to indicate if the colour of the leaf is sent as an index into a FIFO buffer or as the actual index into the colour map. If this flag is set to OFF, then a two bit codeword is sent as the index of one of the FIFO buffer entries. If the flag is ON, this indicates that the leaf colour is not found in the FIFO, and the actual colour value is sent and also inserted into the FIFO, pushing out one of the existing entries. If the tree node was a parent node, then a single OFF bit is stored, and each of the four child nodes are then individually stored using the same method. When the encoder reaches the lowest level in the tree, then all nodes are leaf nodes and the leaf/parent indication bit is not used, instead storing first the transparency bit followed by the colour codeword. The pattern of bits sent can be represented as shown below. The following symbols are used: node type (N), transparent (T), FIFO Predicted colour (P), colour value (C), FIFO index (F)

```
N(1) ---off → N(1)[...], N(1)[...], N(1)[...] , N(1)[...]
    \---- on → T(1) --- off
            \------on → P(1) --- off → F(2)
                    \--- on → C(x)
```

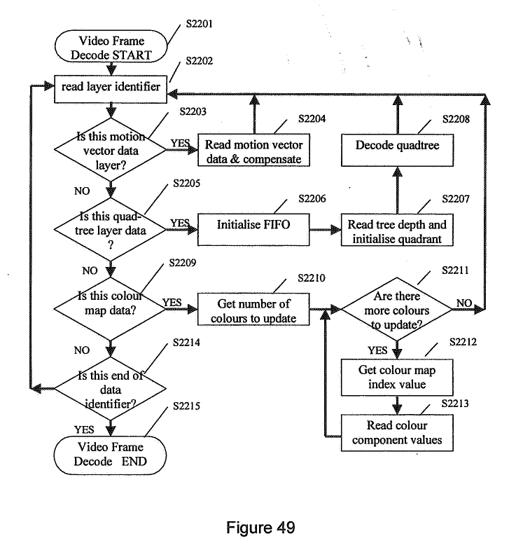

FIG. 49 is a flowchart showing the principal steps of one embodiment of the video frame decoding process. The video frame decoding process begins at step s2201 with a compressed bit stream, A layer identifier, which is used to physically separate the various information components within the compressed bit stream, is read from the bit stream at step s2202. If the layer identifier indicates the start of the motion vector data layer, step s2203 proceeds to step s2204 to read and decode the motion vectors from the bit stream and perform the motion compensation. The motion vectors are used to copy the indicated macro blocks from the previously buffered frame to the new locations indicated by the vectors. When the motion compensation process is complete, the next layer identifier is read from the bit stream at step s2202. If the layer identifier indicates the start of the quad tree data layer, step s2205 proceeds to step s2206, and initialises the FIFO buffer used by the read leaf colour process. Next, the depth of the quad tree is read from the compressed bit stream at step s2207, and is used to initialize the quad tree quadrant size. The compressed bitmap quad tree data is now decoded at step s2209. As the quad tree data is decoded, the region values in the frame are modified according to the leaf values. They may be overwritten with new colours, set to transparent, or left unchanged. When the quad tree data is decoded, the decode process reads the next layer identifier from the compressed bit stream at step s2202. If the layer indicates the start of the colour map data layer, step s2209 proceeds to step s2210 which reads the number of colours to be updated from the compressed bit stream. If there are one or more colours to update at step s2211, the first colour map index value is read from the compressed bit stream at step s2212, and the colour component values are read from the compressed bit stream at step s2213. Each colour update is in turn read through steps s2211, s2212, and s2213 until all of the colour updates have been performed, at which time step s2211 proceeds to step s2202 to read a new layer identifier from the compressed bit stream. If the layer identifier is an end of data indentifier, step s2214 proceeds to step s2215 and ends the video frame decoding process. If the layer identifier is unknown through steps s2203, s2205, s2209, and s2214, the layer identifier is ignored, and the process returns to step s2202 to read the next layer identifier.

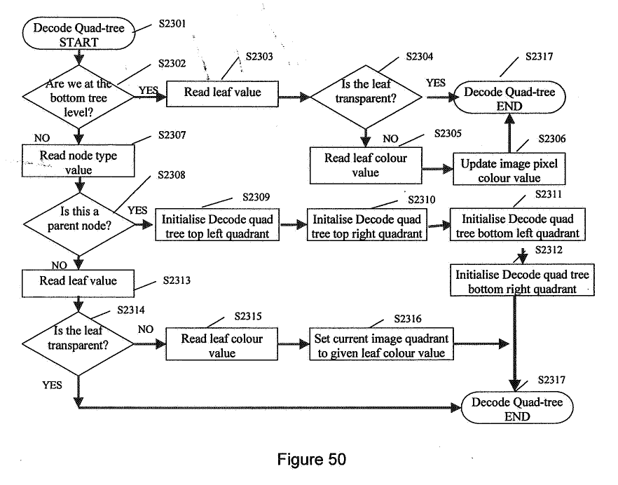

FIG. 50 is a flowchart showing the principal steps of one embodiment of a quad tree decoder with bottom-level node type elimination. This flowchart implements a recursive method, calling itself recursively for each tree quadrant processed. The quad tree decoding process begins at step s2301, having some mechanism of recognising the depth and position of the quadrant to be decoded. If at step s2302 the quadrant is a non-bottom quadrant, the node type is read from the compressed bit stream at step s2307. If the node type is a parent node at step s2308, then four recursive calls are in turn made to the quad tree decoding process for the top left quadrant at step s2309, the top right quadrant and step s2310, the bottom left quadrant at step s2311, the bottom right quadrant at step s2312; subsequently this iteration of the decoding process ends at step s2317. The particular order in which the recursive calls are made for each quadrant is arbitrary, however the order is the same as the quad tree decomposition process performed by the encoder. If the node type is a leaf node, the process continues from step s2308 to s2313, and the leaf type value is read from the compressed bit stream. If the leaf type value indicates a transparent leaf at step s2314, the decoding process ends at step s2317. If the leaf is not transparent, the leaf colour is read from the compressed bit stream at step s2315. The leaf read colour value function employs a FIFO buffer, described herein. Subsequently at step s2316 the image quadrant is set to the appropriate leaf colour value; this may be the background object colour or the leaf colour as indicated. After the image update is complete, the quad tree decode function ends this iteration at step s2317. The recursive calls to the quad tree decode function continue until a bottom level quadrant is reached. At this level there is no need to include in the compressed bit stream a parent/leaf node indicator, as each node at this level is a leaf; hence step s2302 proceeds to step s2303 and reads immediately the leaf type value. If the leaf is not transparent at step s2304, then the leaf colour value is read from the compressed bit stream at step s2305, and the image quadrant colours are updated appropriately at step s2306. This iteration of the decoding process ends at step s2317. The recursive process executions of the quad tree decoding process continue until all leaf nodes in the compressed bit stream have been decoded.

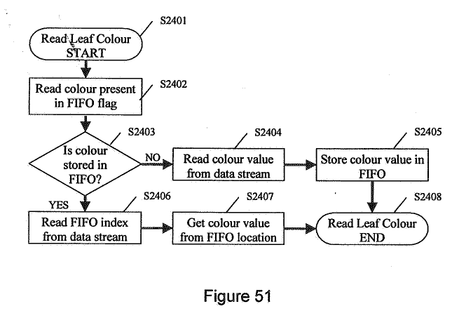

FIG. 51 shows the steps executed in reading a quad tree leaf colour, beginning at step s2401. A single flag is read from the compressed bit stream at step s2402. This flag indicates if the leaf colour is to be read from the FIFO buffer or directly from the bit stream. If, at step s2403, the leaf colour is not to be read from the FIFO, the leaf colour value is read from the compressed bit stream at step s2404, and is stored in the FIFO buffer at step s2405. Storing the newly read colour in the FIFO pushes out the least recently added colour in the FIFO. The read leaf colour function ends at step s2408, after updating the FIFO. If however the leaf colour is already stored in the FIFO, the FIFO index codeword is read from the compressed bit stream at step s2406. The leaf colour is then determined, at step s2407, by indexing into the FIFO, based on the recently read codeword. The read leaf colour process ends at step s2408.

Video Encoder

To this point, the discussion has focussed on the manipulation of pre-existing video objects and files which contain video data. The previous section described how compressed video data is decoded to produce raw video data. In this section, the process of generating this data is discussed. The system is designed to support a number of different codecs. Two such codecs are described here; others that may also be used include the MPEG family and H.261 and H.263 and their successors.

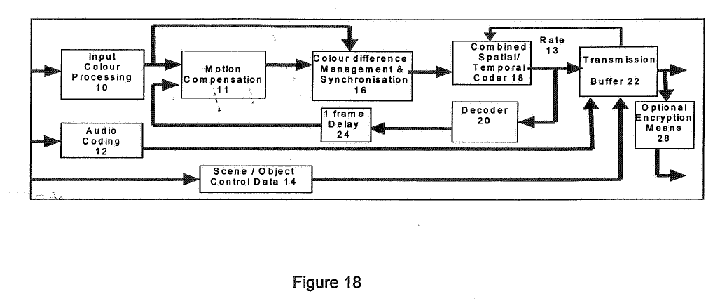

The encoder comprises ten main components, as shown in FIG. 18. The components can be implemented in software, but to enhance the speed of the encoder, all the components can be implemented in an application-specific integrated circuit (ASIC) developed specifically to execute the steps of the encoding process. An audio coding component 12 compresses input audio data. The audio coding component 12 may use adaptive delta pulse code modulation (ADPCM) according to either ITU specification G.723 or the IMA ADPCM codec. A scene/object control data component 14 encodes scene animation and presentation parameters associated with the input audio and video which determine the relationships and behaviour of each input video object. An input colour processing component 10 receives and processes individual input video frames and eliminates redundant and unwanted colours. This also removes unwanted noise from video images. Optionally, motion compensation is performed on the output of the input colour processor 10 using the previously encoded frame as a basis. A colour difference management and synchronisation component 16 receives the output of the input colour processor 10, and determines the encoding using the optionally motion-compensated, previously encoded frame as a basis. The output is then provided to both a combined spatial/temporal coder 18 to compress the video data, and to a decoder 20 which executes the inverse function to provide the frame to the motion compensation component 11 after a one frame delay 24. A transmission buffer 22 receives the output of the spatial/temporal coder 18, the audio coder 12 and the control data component 14. The transmission buffer 22 manages transmission from a video server housing the encoder, by interleaving encoded data and controlling data rates via feedback of rate information to the combined spatial/temporal coder 18. If required, the encoded data can be encrypted by an encryption component 28 for transmission.

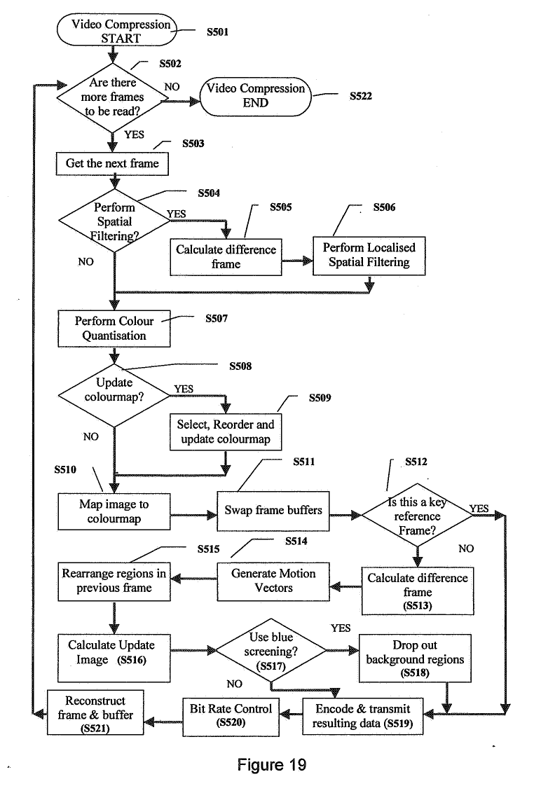

The flow chart of FIG. 19 describes the main steps executed by the encoder. The video compression process begins at step s501, entering a frame compression loop (s502 to s521), and ending at step s522 when, at step s502, there are no video data frames remaining in the input video data stream. The raw video frame is fetched from the input data stream in step s503. At this point, it may be desired to perform spatial filtering. Spatial filtering is performed to lower the bit rate or total bits of the video being generated, but spatial filtering also lowers the fidelity. If it is determined by step s504 that spatial filtering is to be performed, a colour difference frame is calculated at step s505 between the current input video frame and the previously processed or reconstructed video frame. It is preferable to perform the spatial filtering where there is movement, and the step of calculating the frame difference indicates where there is movement; if there is no difference, then there is no movement, and a difference in regions of a frame indicates movement for those regions. Subsequently, localised spatial filtering is performed on the input video frame at step s506. This filtering is localised such that only image regions that have changed between frames are filtered. If desired, the spatial filtering may also be performed on I frames. This can be carried out using any desired technique including inverse gradient filtering, median filtering, and/or a combination of these two types of filtering, for example. If it is desired to perform spatial filtering on a key frame and also to calculate the frame difference in step S505, the reference frame used to calculate the difference frame may be an empty frame.

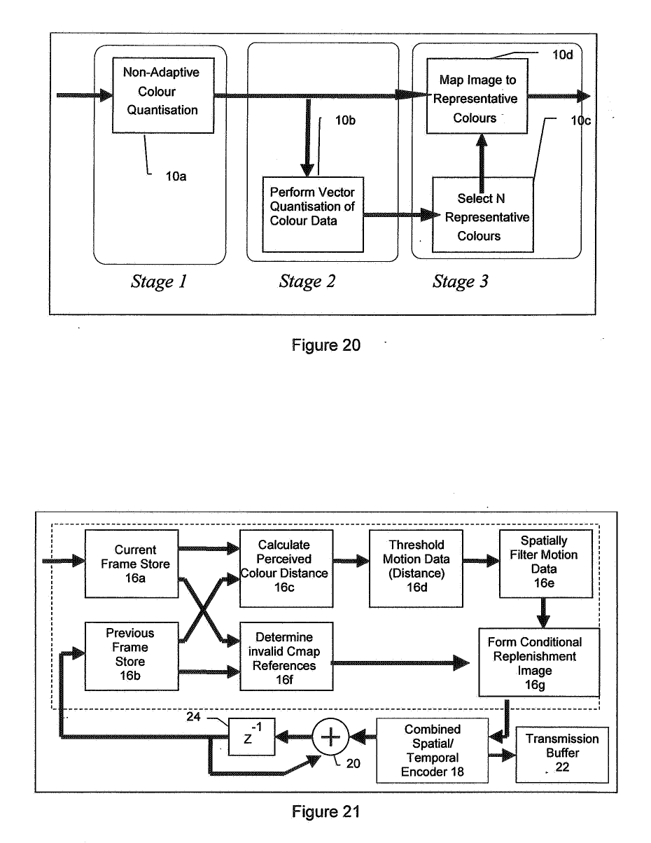

Colour quantisation is performed at step s507 to remove statistically insignificant colours from the image. The general process of colour quantisation is known with respect to still images. Example types of colour quantisation which may be utilised by the invention include, but are not limited to, all techniques described in and referenced by U.S. Pat. Nos. 5,432,893 and 4,654,720 which are incorporated by reference. Also incorporated by reference are all documents cited by and referenced in these patents. Further information about the colour quantisation step s507 is explained with reference to elements 10a, 10b, and 10c of FIG. 20. If a colour map update is to be performed for this frame, flow proceeds from step s508 to step s509. In order to achieve the highest quality image, the colourmap may be updated every frame. However, this may result in too much information being transmitted, or may require too much processing. Therefore, instead of updating the colourmap every frame, the colour map may be updated every n frames, where n is an integer equal to or greater than 2, preferably less than 100, and more preferably less than 20. Alternatively, the colour map may be updated every n frames on average, where n is not required to be an integer, but may be any value including fractions greater than 1 and less than a predetermined number, such as 100 and more preferably less than 20. These numbers are merely exemplary and, if desired, the colour map may be updated as often or as infrequently as desired.

When there is a desire to update the colour map, step s509 is performed in which a new colour map is selected and correlated with the previous frame's colour map. When the colour map changes or is updated, it is desirable to keep the colour map for the current frame similar to the colour map of the previous frame so that there is not a visible discontinuity between frames which use different colour maps.

If at step s508 no colour map is pending (e.g. there is no need to update the colour map), the previous frame's colour map is selected or utilised for this frame. At step s510, the quantised input image colours are remapped to new colours based on the selected colour map. Step s510 corresponds to block 10d of FIG. 20. Next, frame buffer swapping is performed in step s511. Frame buffer swapping at step s511 facilitates faster and more memory efficient encoding. As an exemplary implementation of frame buffer swapping, two frame buffers may be used. When a frame has been processed, the buffer for this frame is designated as holding a past frame, and a new frame received in the other buffer is designated as being the current frame. This swapping of frame buffers allows an efficient allocation of memory.

A key reference frame, also referred to as a reference frame or a key frame, may serve as a reference. If step s512 determines that this frame (the current frame) is to be encoded as, or is designated as, a key frame, the video compression process proceeds directly to step s519 to encode and transmit the frame. A video frame may be encoded as a key frame for a number of reasons, including: (i) it is the first frame in a sequence of video frames following a video definition packet, (ii) the encoder detects a visual scene change in the video content, or (iii) the user has selected key frames to be inserted into the video packet stream. If the frame is not a key frame, the video compression process calculates, at step s513, a difference frame between the current colour map indexed frame and the previous reconstructed colour map indexed frame. The difference frame, the previous reconstructed colour map indexed frame, and the current colour map indexed frame are used at step s514 to generate motion vectors, which are in turn used to rearrange the previous frame at step s515.

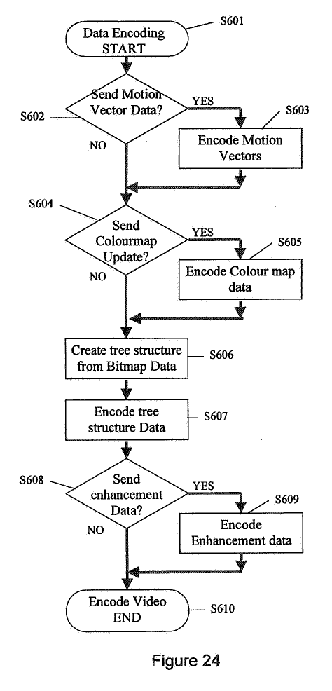

The rearranged previous frame and the current frame are now compared at step s516 to produce a conditional replenishment image. If blue screen transparency is enabled at step s517, step s518 will drop out regions of the difference frame that fall within the blue screen threshold. The difference frame is now encoded and transmitted at step s519. Step s519 is explained in further detail below with reference to FIG. 24. Bit rate control parameters are established at step s520, based on the size of the encoded bit stream. Finally the encoded frame is reconstructed at step s521 for use in encoding the next video frame, beginning at step s502.

The input colour processing component 10 of FIG. 18 performs reduction of statistically insignificant colours. The colour space chosen to perform this colour reduction is unimportant as the same outcome can be achieved using any one of a number of different colour spaces.

The reduction of statistically insignificant colours may be implemented using various vector quantisation techniques as discussed above, and may also be implemented using any other desired technique including popularity, median cut, k-nearest neighbour and variance methods as described in S. J. Wan, P. Prusinkiewicz, S. KIM. Wong, “Variance-Based Color Image Quantization for Frame Buffer Display.”, Color Research and Application, Vol. 15, No. 1, February 1990, which is incorporated by reference. As shown in FIG. 20, these methods may utilise an initial uniform or non-adaptive quantisation step 10a to improve the performance of the vector quantisation algorithm 10b by reducing the size of the vector space. The choice of method is made to maintain the highest amount of time correlation between the quantised video frames, if desired. The input to this process is the candidate video frame, and the process proceeds by analysing the statistical distribution of colours in the frame. In 10c, the colours which are used to represent the image are selected. With the technology available now for some hand-held processing devices or personal digital assistants, there may be a limit of simultaneously displaying 256 colours, for example. Thus, 10c may be utilised to select 256 different colours to be used to represent the image. The output of the vector quantisation process is a table of representative colours for the entire frame 10c that can be limited in size. In the case of the popularity methods, the most frequent N colours are selected. Finally, each of the colours in the original frame is remapped 10d to one of the colours in the representative set.

The colour management components 10b, 10c and 10d of the Input Colour Processing component 10 manages the colour changes in the video. The input colour processing component 10 produces a table containing a set of displayed colours. This set of colours changes dynamically over time, given that the process is adaptive on a per frame basis. This permits the colour composition of the video frames to change without reducing the image quality. Selecting an appropriate scheme to manage the adaptation of the colour map is important. Three distinct possibilities exist for the colour map: it may be static, segmented and partially static, or fully dynamic. With a fixed or static colour map, the local image quality will be reduced, but high correlation is preserved from frame to frame, leading to high compression gains. In order to maintain high quality images for video where scene changes may be frequent, the colour map should be able to adapt instantaneously. Selecting a new optimal colour map for each frame has a high bandwidth requirement, since not only is the colour map updated every frame, but also a large number of pixels in the image would need to be remapped each time. This remapping also introduces the problem of colour map flashing. A compromise is to only permit limited colour variations between successive frames. This can be achieved by partitioning the colour map into static and dynamic sections, or by limiting the number of colours that are allowed to vary per frame. In the first case, the entries in the dynamic section of the table can be modified, which ensures that certain predefined colours will always be available. In the other scheme, there are no reserved colours and any may be modified. While this approach helps to preserve some data correlation, the colour map may not be able to adapt quickly enough in some cases to eliminate image quality degradation. Existing approaches compromise image quality to preserve frame-to-frame image correlation.

For any of these dynamic colour map schemes, synchronisation is important to preserve temporal correlations. This synchronisation process has three components:
1. Ensuring that colours carried over from each frame into the next are mapped to the same indices over time. This involves resorting each new colour map in relation to the current one.
2. A replacement scheme is used for updating the changed colour map. To reduce the amount of colour flashing, the most appropriate scheme is to replace the obsolete colour with the most similar new replacement colour.
3. Finally, all existing references in the image to any colour that is no longer supported are replaced by references to currently supported colours.

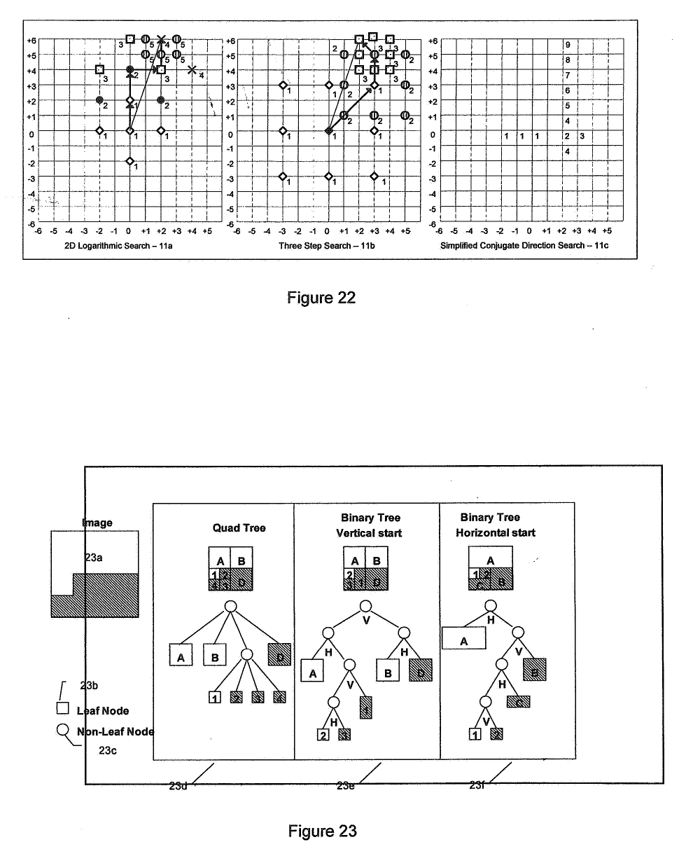

Following the input colour processing 10 of FIG. 18, the next component of the video encoder takes the indexed colour frames and optionally performs motion compensation 11. If motion compensation is not performed, then the previous frame from the frame buffer 24 is not modified by the motion compensation component 11 and is passed directly to the colour difference management and synchronisation component 16. The preferred motion compensation method starts by segmenting the video frame into small blocks and determining all blocks in a video frame where the number of pixels needing to be replenished or updated and are not transparent exceeds some threshold. The motion compensation process is then performed on the resultant pixel blocks. First, a search is made in the neighbourhood of the region to determine if the region has been displaced from the previous frame. The traditional method for performing this is to calculate the mean square error (MSE) or sum square error (SSE) metric between the reference region and a candidate displacement region. As shown in FIG. 22, this process can be performed using an exhaustive search or one of a number of other existing search techniques, such as the 2D logarithmic 11a, three step 11b or simplified conjugate direction search 11c. The aim of this search is to find the displacement vector for the region, often called the motion vector. Traditional metrics do not work with indexed/colour mapped image representations because they rely on the continuity and spatio-temporal correlation that continuous image representations provide. With indexed representations, there is very little spatial correlation and no gradual or continuous change of pixel colour from frame to frame; rather, changes are discontinuous as the colour index jumps to new colour map entries to reflect pixel colour changes. Hence a single index/pixel changing colour will introduce large changes to the MSE or SSE, reducing the reliability of these metrics. Hence a better metric for locating region displacement is where the number of pixels that are different in the previous frame compared to the current frame region is the least if the region is not transparent. Once the motion vector is found, the region is motion-compensated by predicting the value of the pixels in the region from their original location in the previous frame according to the motion vector. The motion vector may be zero if the vector giving the least difference corresponds to no displacement. The motion vector for each displaced block, together with the relative address of the block, is encoded into the output bitstream. Following this, the colour difference management component 16 calculates the perceptual difference between the motion-compensated previous frame and the current frame.

The colour difference management component 16 is responsible for calculating the perceived colour difference at each pixel between the current and preceding frame. This perceived colour difference is based on a similar calculation to that described for the perceptual colour reduction. Pixels are updated if their colour has changed more than a given amount. The colour difference management component 16 is also responsible for purging all invalid colour map references in the image, and replacing these with valid references, generating a conditional replenishment image. Invalid colour map references may occur when newer colours displace old colours in the colour map. This information is then passed to the spatial/temporal coding component 18 in the video encoding process. This information indicates which regions in the frame are fully transparent, and which need to be replenished, and which colours in the colour map need to be updated. All regions in a frame not being updated are identified by setting the value of the pixel to a predetermined value that has been selected to represent non update. The inclusion of this value permits the creation of arbitrarily shaped video objects. To ensure that prediction errors do not accumulate and degrade the image quality, a loop filter is used. This forces the frame replenishment data to be determined from the present frame and the accumulated previous transmitted data (the current state of the decoded image), rather than from the present and previous frames. FIG. 21 provides a more detailed view of the colour difference management component 16. The current frame store 16a contains the resultant image from the input colour processing component 10. The previous frame store 16b contains the frame buffered by the I frame delay component 24, which may or may not have been motion-compensated by the motion compensation component 11. The colour difference management component 16 is portioned into two main components: the calculation of perceived colour differences between pixels 16c, and cleaning up invalid colour map references 16f. The perceived colour differences are evaluated with respect to a threshold 16d to determine which pixels need to be updated, and the resultant pixels are optionally filtered 16e to reduce the data rate. The final update image is formed 16g from the output of the spatial filter 16e and the invalid colour map references 16f and is sent to the spatial encoder 18.

This results in a conditional replenishment frame which is now encoded. The spatial encoder 18 uses a tree splitting method to recursively partition each frame into smaller polygons according to a splitting criteria. A quad tree split 23d method used, as is shown in FIG. 23. In one instance, that of zeroth order interpolation, this attempts to represent the image 23a by a uniform block, the value of which is equal to the global mean value of the image. In another instance, first or second order interpolation may be used. If, at some locations of the image, the difference between this representative value and the real value exceeds some tolerance threshold, then the block is recursively subdivided uniformly, into two or four subregions, and a new mean is calculated for each subregion. For lossless image encoding, there is no tolerance threshold. The tree structures 23d, 23e, 23f are composed of nodes and pointers, where each node represents a region and contains pointers to any child nodes representing subregions which may exist. There are two types of nodes: leaf 23b and non-leaf 23c nodes. Leaf nodes 23b are those that are not further decomposed and as such have no children, instead containing a representative value for the implied region. Non-leaf nodes 23c do not contain a representative value, since these consist of further subregions and as such contain pointers to the respective child nodes. These can also be referred to as parent nodes.

Dynamic Bitmap (Colour) Encoding

The actual encoded representation of a single video frame includes bitmap, colour map, motion vector and video enhancement data. As shown in FIG. 24, the video frame encoding process begins at step s601. If (s602) motion vectors were generated via the motion compensation process, then the motion vectors are encoded at step s603. If (s604) the colour map has changed since the previous video frame, the new colour map entries are encoded at step s605. The tree structure is created from the bitmap frame at step s606 and is encoded at step s607. If (s608) video enhancement data is to be encoded, the enhancement data is encoded at step s609. Finally, the video frame encoding process ends at step s610.

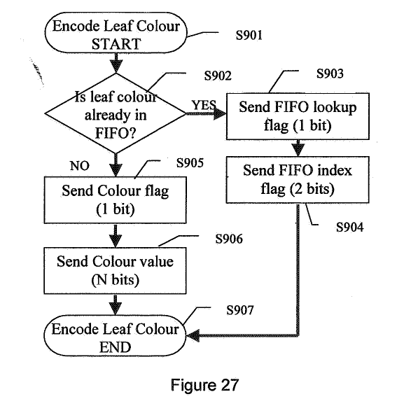

The actual quadtree video frame data is encoded using a preordered tree traversal method. There may be two types of leaves in the tree: transparent leaves and region colour leaves. The transparent leaves indicate that the region indicated by the leaf is unchanged from its previous value (these are not present in video key frames), and the colour leaves contain the region colour. FIG. 26 represents a pre-ordered tree traversal encoding method for normal predicted video frames with zeroth order interpolation and bottom level node type elimination. The encoder of FIG. 26 begins at step s801, initially adding a quad tree layer identifier to the encoded bit stream at step s802. Beginning at the top of the tree, step s803, the encoder gets the initial node. If, at step s804, the node is a parent node, the encoder adds a parent node flag (a single ZERO bit) to the bit stream at step s805. Subsequently, the next node is fetched from the tree at step s806, and the encoding process returns to step s804 to encode subsequent nodes in the tree. If at step s804 the node is not a parent node, i.e., it is a leaf node, the encoder checks the node level in the tree at step s807. If at step s807 the node is not at the bottom of the tree, the encoder adds a leaf node flag (a single ONE bit) to the bit stream at step s808. If the leaf node region is transparent at step s809, a transparent leaf flag (a single ZERO bit) is added to the bit stream at step s810; otherwise, an opaque leaf flag (single ONE bit) is added to the bit stream at step s811. The opaque leaf colour is then encoded at step s812, as shown in FIG. 27. If, however, at step s807 the leaf node is at the bottom level of the tree, then bottom level node type elimination occurs because all nodes are leaf nodes and the leaf/parent indication bit is not used, such that at step s813 four flags are added to the bit stream to indicate if each of the four leaves at this level are transparent (ZERO) or opaque (ONE). Subsequently, if the top left leaf is opaque at step s814, then at step s815 the top left leaf colour is encoded as shown in FIG. 27. Each of steps s814 and s815 are repeated for each leaf node at this second bottom level, as shown in steps s816 and s817 for the top right node, steps s818 and s819 for the bottom left node, and steps s820 and s821 for bottom right node. After the leaf nodes are encoded (from steps s810, s812, s820 or s821) the encoder checks whether further nodes remain in the tree at step s822. If no nodes remain in the tree, then the encoding process ends at step s823. Otherwise, the encoding process continues at step s806, where the next node is selected from the tree and the entire process restarts for the new node from step s804.

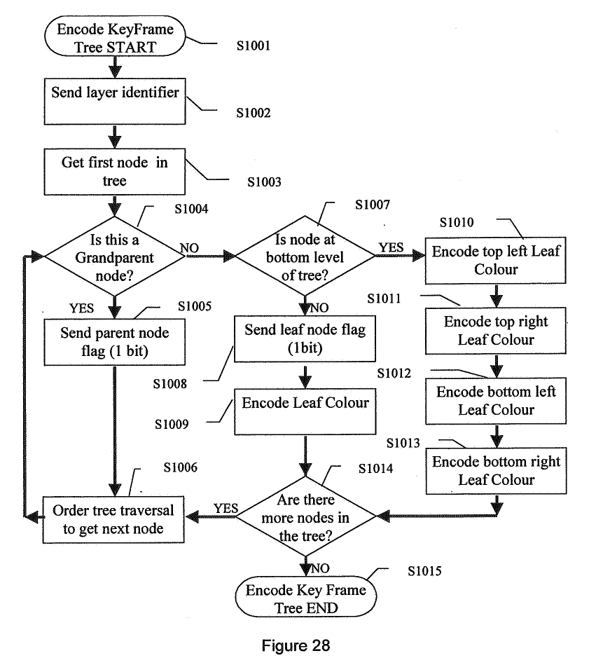

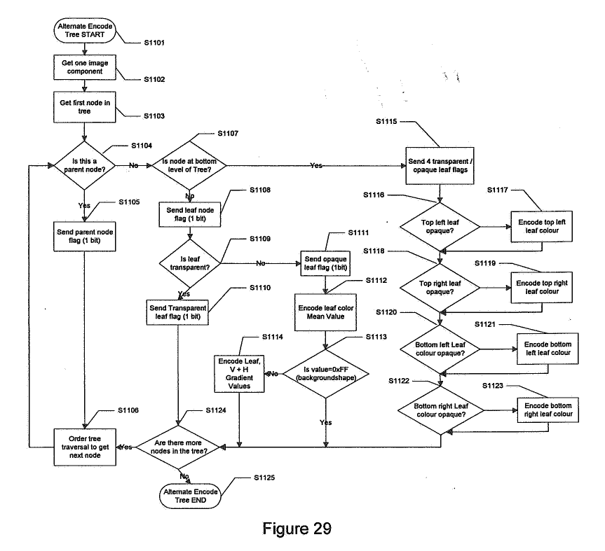

In the special case of video key frames (these are not predicted), these do not have transparent leaves and a slightly different encoding method is used, as shown in FIG. 28. The key frame encoding process begins at step s1001, initially adding a quad tree layer identifier to the encoded bit stream at step s1002. Beginning at the top of the tree, step s1003, the encoder gets the initial node. If, at step s1004, the node is a parent node, the encoder adds a parent node flag (a single ZERO bit) to the bit stream at step s1005; subsequently, the next node is fetched from the tree at step s1006, and the encoding process returns to step s1004 to encode subsequent nodes in the tree. If however at step s1004 the node is not a parent node, i.e. it is a leaf node, the encoder checks the node level in the tree at step s1007. If at step s1007 the node is greater than one level from the bottom of the tree the encoder adds a leaf node flag (a single ONE bit) to the bit stream at step s1008. The opaque leaf colour is then encoded at step s1009, as shown in FIG. 27. If, however at step s1007 the leaf node is one level from the bottom of the tree, then bottom level node type elimination occurs because all nodes are leaf nodes and the leaf/parent indication bit is not used. Thus at step s1010 the top left leaf colour is encoded as shown in FIG. 27. Subsequently, at steps s1011, s1012 and s1013, the opaque leaf colours are encoded similarly for the top right leaf, bottom left leaf and the bottom right leaf respectively. After the leaf nodes are encoded (from steps s1009 or s1013) the encoder checks whether further nodes remain in the tree at step s1014. If no nodes remain in the tree, then the encoding process ends at step s1015. Otherwise, the encoding process continues, at step s1006, where the next node is selected from the tree and the entire process restarts for the new node from step s1004.

The opaque leaf colours are encoded using a FIFO buffer as shown in FIG. 27. The leaf colour encoding process begins at step s901. The colour to be encoded is compared with the four colours already in the FIFO, if at step s902 it is determined that the colour is in the FIFO buffer, then a single FIFO lookup flag (single ONE bit) is added to the bit stream at step s903, followed by, at step s904, a two bit codeword representing the colour of the leaf as an index into the FIFO buffer. This codeword indexes one of four entries in the FIFO buffer. For example, index values of 00, 01 and 10 specify that the leaf colour is the same as the previous leaf, the previous different leaf colour before that, and the previous one before that respectively. If however at step s902 the colour to be encoded is not available in the FIFO, a send colour flag (a single ZERO bit) is added to the bit stream at step s906, followed by N bits, at step s906, representing the actual colour value. Additionally, the colour is added to the FIFO, pushing out one of the existing entries. The colour leaf encoding process ends then at step s907.

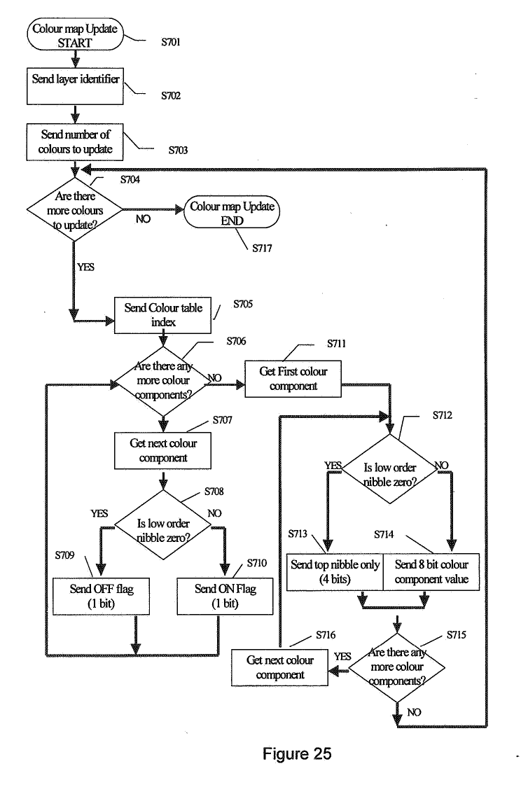

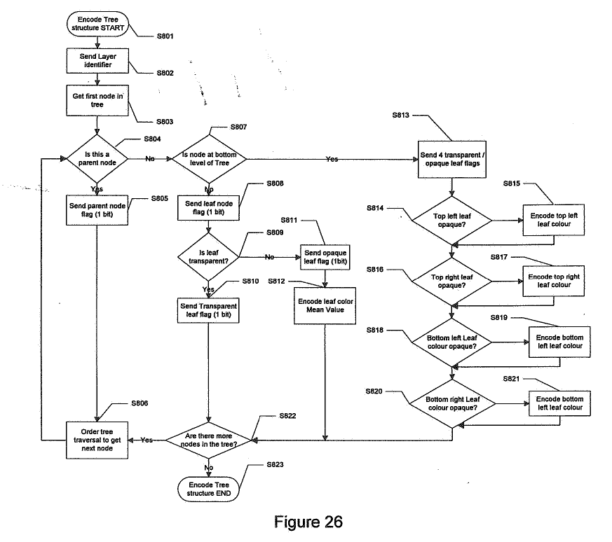

The colourmap is similarly compressed. The standard representation is to send each index followed by 24 bits, 8 to specify the red component value, 8 for the green component and 8 for the blue. In the compressed format, a single bit flag indicates if each colour component is specified as a full 8-bit value, or just as the top nibble with the bottom 4 bits set to zero. Following this flag, the component value is sent as 8 or 4 bits depending on the flag. The flowchart of FIG. 25 depicts one embodiment of a colour map encoding method using 8-bit colour map indices. In this implementation, the single bit flags specifying the resolution of the colour component for all the components of one colour are encoded prior to the colour components themselves. The colour map update process begins at step s701. Initially, a colour map layer identifier is added to the bit stream at step s702, followed by, at step s703, a codeword indicating the number of colour updates following. At step s704 the process checks a colour update list for additional updates; if no further colour updates require encoding, the process ends at step s717. If, however, colours remain to be encoded, then at step s705 the colour table index to be updated is added to the bit stream. For each colour there are typically a number of components (red, green and blue, for example), thus step s706 forms a loop condition around steps s707, s708, s709 and s710, processing each component separately. Each component is read from the data buffer at step s707. Subsequently, if, at step s708, the component low order nibble is zero, an off flag (a single ZERO bit) is added to the bit stream at step s709, or if the low order nibble is non-zero, an on flag (a single ONE bit) is added to the bit stream at step s710. The process is repeated by returning to step s706, until no colour components remain. Subsequently, the first component is again read from the data buffer at step s711. Similarly, step s712 forms a loop condition around steps s713, s714, s715 and s716, processing each component separately. Subsequently, if, at step s712, the component's low order nibble is zero, the component's high order nibble is added to the bit stream at step s713. Alternatively, if the low order nibble is non-zero, the component's 8-bit colour component is added to the bit stream at step s714. If further colour components remain to be added at step s715, the next colour component is read from the input data stream at step s716, and the process returns to step s712 to process this component. Otherwise, if no components remain at step s715, the colour map encoding process returns to step s704 to process any remaining colour map updates.

Alternate Encoding Method

In the alternate encoding method, the process is very similar to the first as shown in FIG. 29 except that the input colour processing component 10 of FIG. 18 does not perform colour reduction, but instead ensures that the input colour space is in YCbCr format, converting from RGB if required. There is no colour quantisation or colour map management required, thus steps s507 through s510 of FIG. 19 are replaced by a single colour space conversion step, ensuring the frame is represented in YCbCr colour space. The motion compensation component 11 of FIG. 18 performs “traditional” motion compensation on the Y component and stores the motion vectors. The conditional replenishment images are then generated from the inter-frame coding process for each of the Y, Cb and Cr components using the motion vectors from the Y component. The three resultant difference images are then compressed independently after down-sampling the Cb and Cr bitmaps by a factor of two in each direction. The bitmap encoding uses a similar recursive tree decomposition, but this time for each leaf that is not at the bottom of the tree, three values are stored: the mean bitmap value for the area represented by the leaf, and the gradients for the horizontal and vertical directions. The flowchart of FIG. 29 depicts the alternate bitmap encoding process, beginning at step s1101. At step s1102 the image component (Y, Cb or Cr) is selected for encoding, then at step s1103 the initial tree node is selected. If this node, at step s1104, is a parent node, a parent node flag (1 bit) the alternate bitmap encoding process returns to step s1104. If at step s1104 the new node is not at parent node, at step s1107 the nodes depth in the tree is determined. If, at step s1107, the node is not at the bottom level of the tree, the node is encoded using the non-bottom leaf node encode method, such that at step s1108 a leaf node flag (1 bit) is added to the bitstream. Subsequently if at step s1109 the leaf is transparent, a transparent leaf flag (1 bit) is added to the bitstream. If however the leaf is not transparent, an opaque leaf flag (1 bit) is added to the bitstream, subsequently at step s1112 the leaf colour mean value is encoded. The mean is encoded using a FIFO as in the first method by sending a flag and either the FIFO index in 2 bits or the mean itself in 8 bits. If at step s1113, the region is not an invisible background region (for use in arbitrary shaped video objects) then the leaf horizontal and vertical gradients are encoded at step s1114. Invisible background regions are encoded using a special value for the mean, for example 0xFF. The gradients are sent as a 4 bit quantised value. If, however, at step s1107 it is determined that the leaf node is on the bottom most level of the tree, then the corresponding leaves are encoded as in the previous method by sending the bitmap value and no parent/lead indication flag. Transparent and colour leaves are encoded as before using single bit flags. In the case of arbitrarily-shaped video, the invisible background regions are encoded by using a special value for the mean, for example 0xFF, and in this case the gradient values are not sent Specifically then at step s1115 four flags are added to the bit stream to indicate if each of the four leaves at this level are transparent or opaque. Subsequently, if the top left leaf is opaque at step s1116, then at step s1117 the top left leaf colour is encoded as described above for opaque leaf colour encoding. Each of steps s1116 and s1117 are repeated for each leaf node at this bottom level, as shown in steps s1118 and s1119 for the top right node, steps s1120 and s1121 for the bottom left node, and steps s1122 and s1123 for the bottom right node. At the completion of leaf node encoding, the encoding process checks the tree for additional nodes at step s1124, ending at step s1125 if no nodes remain. Alternatively, the next node is fetched at step s1106, and the process restarts at step s1104. The reconstruction in this case involves interpolating the values within each region identified by the leaves using first, second or third order interpolation and then combining the values for each of the Y, Cb and Cr components to regenerate the 24 bit RGB values for each pixel. For devices with 8 bit, colour mapped displays, quantisation of the colour is executed before display.

Encoding of Colour Prequantisation Data

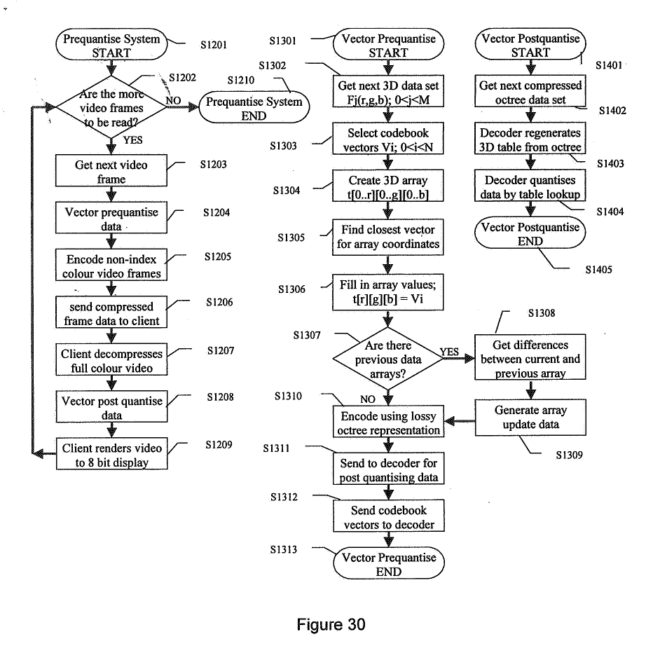

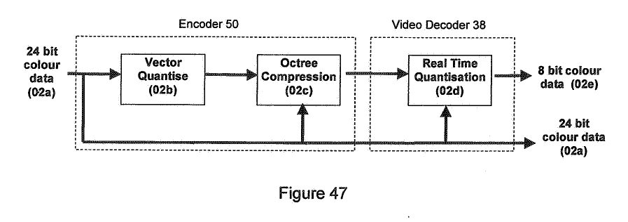

For improved image quality, a first or second order interpolated coding can be used, as in the alternate encoding method previously described. In this case, not only was the mean colour for the region represented by each leaf stored, but also colour gradient information at each leaf. Reconstruction is then performed using quadratic or cubic interpolation to regenerate a continuous tone image. This may create a problem when displaying continuous colour images on devices with indexed colour displays. In these situations, the need to quantise the output down to 8 bits and index it in real time is prohibitive. As shown in FIG. 47, in this case the encoder 50 can perform vector quantisation 02b of 24-bit colour data 02a, generating colour pre-quantisation data. Colour quantisation information can be encoded using octree compression 02c, as described below. This compressed colour pre-quantisation data is sent with the encoded continuous tone image to enable the video decoder/player 38 to perform real-time colour quantisation 02d by applying the pre-calculated colour quantisation data, thus producing optionally 8-bit indexed colour video representation 02e in real-time. This technique can also be used when reconstruction filtering is used that generates a 24-bit result that is to be displayed on 8-bit devices. This problem can be resolved by sending a small amount of information to the video decoder 38 that describes the mapping from the 24 bit colour result to the 8 bit colour table. This process is depicted in the flowchart beginning with step s1201 in FIG. 30, and includes the main steps involved in the pre-quantisation process to perform real-time colour quantisation at the client. All frames in the video are processed sequentially as indicated by the conditional block at step s1202. If no frames remain, then the pre-quantisation process ends at step s12110. Otherwise at step s1203 the next video frame is fetched from the input video stream, and then at step s1204 vector pre-quantisation data is encoded. Subsequently, the non-index based colour video frames are encoded/compressed at step s1205. The compressed/encoded frame data is sent to the client at step s1206, which the client subsequently decodes into a full-colour video frame at step s1207. The vector pre-quantisation data is now used for vector post-quantisation at step s1208, and finally the client renders the video frame at step s1209. The process returns to step s1202 to process subsequent video frames in the stream. The vector pre-quantisation data includes a three-dimensional array of size 32×64×32, where the cells in the array contain the index values for each r,g,b coordinate. Clearly, storing and sending a total of 32×64×32=65,536 index values is a large overhead that makes the technique impractical. The solution is to encode this information in a compact representation. One method, as shown in the flow chart of FIG. 30 beginning at step s1301, is to encode this three dimensional array of indexes using an octree representation. The encoder 50 of FIG. 47 may use this method. At step s1302, the 3D data set/video frame is read from the input source, such that Fⱼ(r,g,b) represents all unique colours in the RGB colour space for all j pixels in the video frame. Subsequently at step s1303 N codebook vectors Vᵢ are selected to best represent the 3D data set Fⱼ(r,g,b). A three-dimensional array t[0..Rₘₐₓ,0..Bₘₐₓ0..Bₘₐₓ] is created in step s1304. For all cells in array t, the closest codebook vector Vi is determined in step s1305, and in step s1306 the closest codebook vector for each cell is stored in array t. If, at step s1307, previous video frames have been encoded such that a previous data array t exists, then step 1308 determines the differences between the current and previous t arrays; subsequently, at step s1309, an update array is generated. Then, either the update array of step s1309 or the full array t is encoded at step s1310 using a lossy octree method. This method takes the 3D array (cube) and recursively splits it in a similar manner to the quadtree based representation. Since the vector codebook (Vᵢ)/colour map is free to change dynamically, this mapping information is also updated to reflect the changes in the colour map from frame to frame. A similar conditional replenishment method is proposed to perform this using the index value 255 to represent an unchanged coordinate mapping and other values to represent update values for the 3D mapping array. Like the spatial encoder, the process uses a preordered octree tree traversal method to encode the colour space mapping into the colour table. Transparent leaves indicate that the region of the colour space indicated by the leaf is unchanged and index leaves contain the colour table index for the colour specified by the coordinates of the cell. The octree encoder starts at the top of the tree and for each node stores a single ONE bit if the node is a leaf, or a ZERO bit if it is a parent. If it is a leaf and the colour space area is unchanged then another single ZERO bit is stored otherwise the corresponding colour map index is explicitly encoded as a n bit codeword. If the node was a parent node and a ZERO bit was stored, then each of the eight child nodes are recursively stored as described. When the encoder reaches the lowest level in the tree, then all nodes are leaf nodes and the leaf/parent indication bit is not used, instead storing first the unchanged bit followed by the colour index codeword. Finally, at step s1311, the encoded octree is sent to the decoder for post quantising data and at step s1312 the codebook vectors Vᵢ/colour map are sent to the decoder, thus ending the vector pre-quantisation process at step s1313. The decoder performs the reverse process, vector post-quantisation, as shown in the flowchart of FIG. 30 beginning at step s1401. The compressed octree data is read at step s1402, and the decoder regenerates, at step s1403, the three-dimensional array from the encoded octree, as in the 2D quadtree decoding process described. Then, for any 24 bit colour value, the corresponding colour index can be determined by simply looking up the index value stored in the 3D array, as represented in step s1404. The vector post-quantisation process ends at step s1405. This technique can be used for mapping any non-stationary three-dimensional data onto a single dimension. This is normally a requirement when vector quantisation is used to select a codebook that will be used to represent an original multi-dimensional data set. It does not matter at what stage of the process the vector quantisation is performed. For example, we could directly quadtree encode 24-bit data followed by VQ or we could VQ the data first and then quadtree encode the result as we do here. The great advantage of this method is that, in heterogeneous environments, it permits 24-bit data to be sent to clients which, if capable of displaying the 24 bit data, may do so, but, if not, may receive the pre-quantisation data and apply this to achieve real-time, high quality quantisation of the 24-bit source data.

The scene/object control data component 14 of FIG. 18 permits each object to be associated with one visual data stream, one audio data stream and one of any other data streams. It also permits various rendering and presentation parameters for each object to be dynamically modified from time to time throughout the scene. These include the amount of object transparency, object scale, object volume, object position in 3D space, and object orientation (rotation) in 3D space.

The compressed video and audio data is now transmitted or stored for later transmission as a series of data packets. There is a plurality of different packet types. Each packet includes a common base header and a payload. The base header identifies the packet type, the total size of the packet including payload, what object it relates to, and a sequence identifier. The following types of packets are currently defined: SCENEDEFN, VIDEODEFN, AUDIODEFN, TEXTDEFN, GRAFDEFN, VIDEODAT, VIDEOKEY, AUDIODAT, TEXTDAT, GRAFDAT, OBJCTRL, LINKCTRL, USERCTRL, METADATA, DIRECTORY, VIDEOENH, AUDIOENH, VIDEOEXTN, VIDEOTRP, STREAMEND, MUSICDEFN, FONTLIB, OBJLIBCTRL. As described earlier, there are three main types of packets: definition, control and data packets. The control packets (CTRL) are used to define object rendering transformations, animations and actions to be executed by the object control engine, interactive object behaviours, dynamic media composition parameters and conditions for execution or application of any of the preceding, for either individual objects or for entire scenes being viewed. The data packets contain the compressed information that makes up each media object. The format definition packets (DEFN) convey the configuration parameters to each codec, and specify both the format of the media objects and how the relevant data packets are to be interpreted. The scene definition packet defines the scene format, specifies the number of objects, and defines other scene properties. The USERCTRL packets are used to convey user interaction and data back to a remote server using a backchannel, the METADATA packets contain metadata about the video, the DIRECTORY packets contain information to assist random access into the bit stream, and the STREAMEND packets demarcate stream boundaries.

Access Control and Identification

Another component of the object oriented video system is means for encrypting/decrypting the video stream for security of content. The key to perform the decryption is separately and securely delivered to the end user by encoding it using the RSA public key system.

An additional security measure is to include a universally unique brand/identifier in an encoded video stream. This takes at least four principal forms:

a. In a videoconferencing application, a single unique identifier is applied to all instances of the encoded video streams

b. In broadcast video-on-demand (VOD) with multiple video objects in each video data stream, each separate video object has a unique identifier for the particular video stream

c. A wireless, ultrathin client system has a unique identifier which identifies the encoder type as used for wireless ultrathin system server encoding, as well as identifying a unique instance of this software encoder.

d. A wireless ultrathin client system has a unique identifier that uniquely identifies the client decoder instance in order to match the Internet-based user profile to determine the associated client user.

The ability to uniquely identify a video object and data stream is particularly advantageous. In videoconference applications, there is no real need to monitor or log the teleconference video data streams, except where advertising content occurs (which is uniquely identified as per the VOD). The client side decoder software logs viewed decoded video streams (identifier, duration). Either in real-time or at subsequent synchronisation, this data is transferred to an Internet-based server. This information is used to generate marketing revenue streams as well as market research/statistics in conjunction with client personal profiles.

In VOD, the decoder can be restricted to decode broadcast streams or video only when enabled by a security key. Enabling can be performed, either in real-time if connected to the Internet, or at a previous synchronisation of the device, when accessing an Internet authentication/access/billing service provider which provides means for enabling the decoder through authorised payments. Alternatively, payments may be made for previously viewed video streams. Similarly to the advertising video streams in the video conferencing, the decoder logs VOD-related encoded video streams along with the duration of viewing. This information is transferred back to the Internet server for market research/feedback and payment purposes.

In the wireless ultrathin client (NetPC) application, real-time encoding, transmission and decoding of video streams from Internet or otherwise based computer servers is achieved by adding a unique identifier to the encoded video streams. The client-side decoder is enabled in order to decode the video stream. Enabling of the client-side decoder occurs along the lines of the authorised payments in the VOD application or through a secure encryption key process that enables various levels of access to wireless NetPC encoded video streams. The computer server encoding software facilitates multiple access levels. In the broadest form, wireless Internet connection includes mechanisms for monitoring client connections through decoder validation fed back from the client decoder software to the computer servers. These computer servers monitor client usage of server application processes and charge accordingly, and also monitor streamed advertising to end clients.

Interactive Audio Visual Markup Language (IAVML)

A powerful component of this system is the ability to control audio-visual scene composition through scripting. With scripts, the only constraints on the composition functions are imposed by the limitations of the scripting language. The scripting language used in this case is IAVML which is derived from the XML standard. IAVML is the textual form for specifying the object control information that is encoded into the compressed bit stream.

IAVML is similar in some respects to HTML, but is specifically designed to be used with object oriented multimedia spatio-temporal spaces such as audio/video. It may be used to define the logical and layout structure of these spaces, including hierarchies, it may also be used to define linking, addressing and also metadata. This is achieved by permitting five basic types of markup tags to provide descriptive and referential information, etc. These are system tags, structural definition tags, presentation formatting, and links and content.

Like HTML, IAVML is not case sensitive, and each tag comes in opening and closing forms which are used to enclose the parts of the text being annotated. For example:
<TAG> some text here </TAG>

Structural definition of audio-visual spaces uses structural tags and include the following:

| | |
|---|---|
| <SCENE> | Defines video scenes |
| <STREAMEND> | Demarcate streams within scene |
| <OBJECT> | Defines object instance |
| <VIDEODAT> | Defines video object data |
| <AUDIODAT> | Defines audio object data |
| <TEXTDAT> | Defines text object data |
| <GRAFDAT> | Defines vector object data |
| <VIDEODEFN> | Defines video data format |
| <AUDIODEFN> | Defines audio data format |
| <METADATA> | Defines metadata about given object |
| <DIRECTORY> | Defines directory object |
| <OBJCONTROL> | Defines object control data |
| <FRAME> | Defines video frame |

The structure defined by these tags in conjunction with the directory and meta data tags permit flexible access to and browsing of the object oriented video bitstreams.

Layout definition of audio-visual objects uses object control based layout tags (rendering parameters) to define the spatio-temporal placement of objects within any given scene and include the following:

| | |
|---|---|
| <SCALE> | Scale of visual object |
| <VOLUME> | Volume of audio data |
| <ROTATION | Orientation of object in 3D space |
| <POSITION> | Position of object in 3D space |
| <TRANSPARENT> | Transparency of visual objects |
| <DEPTH> | Change object Z order |
| <TIME> | Start time of object in scene |
| <PATH> | Animation path from start to end time |

Presentation definition of audio-visual objects uses presentation tags to define the presentation of objects (format definition) and include the following:

| | |
|---|---|
| <SCENESIZE> | Scene spatial size |
| <BACKCOLR> | Scene background colour |
| <FORECOLR> | Scene foreground colour |
| <VIDRATE> | Video Frame rate |
| <VIDSIZE> | Size of video frame |
| <AUDRATE> | Audio sample rate |
| <AUDBPS> | Audio sample size in bits |
| <TXTFONT> | Text Font type to use |
| <TXTSIZE> | Text font size to use |
| <TXTSTYLE> | Text style (bold, underline, italic) |

Object behaviours and action tags encapsulate the object controls and includes the following types:

| | |
|---|---|
| <JUMPTO> | Replaces current scene or object |
| <HYPERLINK> | Set hyperlink target |
| <OTHER> | Retarget control to another object |
| <PROTECT> | Limit user interaction |
| <LOOPCTRL> | Looping object control |
| <ENDLOOP> | Break loop control |
| <BUTTON> | Define button action |
| <CLEARWAITING> | Terminate waiting actions |
| <PAUSEPLAY> | Play or pause video |
| <SNDMUTE> | Mute sound on/off |
| <SETFLAG> | Set or reset system flag |
| <SETTIMER> | Set timer value and Start counting |
| <SENDFORM> | Send system flags back to server |
| <CHANNEL> | Change the viewed channel |

The hyperlink references within the file permits objects to be clicked on that invoke defined actions.

Simple video menus can be created using multiple media objects with the BUTTON, OTHER and JUMPTO tags defined with the OTHER parameter to indicate the current scene and the JUMPTO parameter indicating the new scene. A persistent menu can be created by defining the OTHER parameter to indicate the background video object and the JUMPTO parameter to indicate the replacement video object. A variety of conditions defined below can be used to customise these menus by disabling or enabling individual options.

Simple forms to register user selections can be created by using a scene that has a number of checkboxes created from 2 frame video objects. For each checkbox object, the JUMPTO and SETFLAG tags are defined. The JUMPTO tag is used to select which frame image is displayed for the object to indicate if the object is selected or not selected, and the indicated system flag registers the state of the selection. A media object defined with BUTTON and SENDFORM can be used to return the selections to the server for storage or processing.

In cases where there may be multiple channels being broadcast or multicast, the CHANNEL tag enables transitions between a unicast mode operation and a broadcast or multicast mode and back.

Conditions may be applied to behaviours and actions (object controls) before they are executed in the client. These are applied in IAVML by creating conditional expressions by using either <IF> or <SWITCH> tags. The client conditions include the following types:

| | |
|---|---|
| <PLAYING> | Is video currently playing |
| <PAUSED> | Is video currently paused |
| <STREAM> | Streaming from remote server |
| <STORED> | Playing from local storage |
| <BUFFERED> | Is object frame # buffered |
| <OVERLAP> | Need to be dragged onto what object |
| <EVENT> | What user event needs to happen |
| <WAIT> | Do we wait for conditions to be true |
| <USERFLAG> | Is the given user flag set? |
| <TIMEUP> | Has a timer expired? |
| <AND> | Used to generate expressions |
| <OR> | Used to generate expressions |

Conditions that may be applied at the remote server to control the dynamic media composition process include the following types:

| | |
|---|---|
| <FORMDATA> | User returned form data |
| <USERCTRL> | User interaction event has occurred |
| <TIMEODAY> | Is it a given time |
| <DAYOFWEEK> | What day of the week is it |
| <DAYOFYEAR> | Is it a special day |
| <LOCATION> | Where is the client geographically |
| <USERTYPE> | Class of user demographic? |
| <USERAGE> | What is age of user (range) |
| <USERSEX> | What is the sex of the user (M/F) |
| <LANGUAGE> | What is the preferred language |
| <PROFILE> | Other subclasses of user profile data |
| <WAITEND> | Wait for end of current stream |
| <AND> | Used to generate expressions |
| <OR> | Used to generate expressions |

An IAVML file will generally have one or more scenes and one script. Each scene is defined to have a determined spatial size, a default background colour and an optional background object in the following manner:

```
<SCENE = “sceneone”>
    < SCENESIZE SX = “320”, SY=”240”>
    < BACKCOLR =”#RRGGBB” >
    <VIDEODAT SRC = “URL”>
    <AUDIODAT SRC = “URL”>
    <TEXTDAT > this is some text string </a>
</ SCENE>
```

Alternatively, the background object may have been defined previously and then just declared in the scene:

```
<OBJECT = “backgrnd”>
    <VIDEODAT SRC = “URL”>
    <AUDIODAT SRC = “URL”>
    <TEXTDAT > this is some text string </a>
    <SCALE = “2’>
    <ROTATION = “90”>
    <POSITION= XPOS =“50” YPOS=”100”>
</OBJECT>
<SCENE>
    < SCENESIZE SX = “320”, SY=”240”>
    < BACKCOLR =”#RRGGBB” >
    <OBJECT = “backgrnd”>
</SCENE>
```

Scenes can contain any number of foreground objects:

```
<SCENE>
    < SCENESIZE SX = “320”, SY=”240”>
    < FORECOLR =”#RRGGBB” >
    < OBJECT = “foregnd_object1”, PATH =”somepath”>
    <OBJECT = “foregnd_object2”, PATH =”someotherpath”>
    <OBJECT = “foregnd_object3”, PATH =”anypath”>
</SCENE>
```

Paths are defined for each animated object in a scene:

```
<PATH = somepath>
    < TIME START=”0”, END=”100”>
    < POSITION TIME=START, XPOS=”0”, YPOS=”100”>
    < POSITION TIME=END, XPOS=”0”, YPOS=”100”>
    <INTERPOLATION= LINEAR>
</PATH>
```

Using IAVML, content creators can textually create animation scripts for object oriented video and conditionally define dynamic media composition and rendering parameters. After creation of an IAVML file, the remote server software processes the IAVML script delivered to the media player. The server also uses the IAVML script internally to know how to respond to dynamic media composition requests mediated by user interaction returned from the client via user control packets.

Streaming Error Correction Protocol

In the case of wireless streaming, suitable network protocols are used to ensure that video data is reliably transmitted across the wireless link to the remote monitor. These may be connection-oriented, such as TCP, or connectionless, such as UDP. The nature of the protocol will depend on the nature of the wireless network being used, the bandwidth, and the channel characteristics. The protocol performs the following functions: error control, flow control, packetisation, connection establishment, and link management.

There are many existing protocols for these purposes that have been designed for use with data networks. However, in the case of video, special attention may be required to handle errors, since retransmission of corrupted data is inappropriate due to the real-time constraints imposed by the nature of video on the reception and processing of transmitted data.

To handle this situation the following error control scheme is provided:
(1) Frames of video data are individually sent to the receiver, each with a check sum or cyclic redundancy check appended to enable the receiver to assess if the frame contains errors;
(2a) If there was no error, then the frame is processed normally;
(2b) If the frame is in error, then the frame is discarded and a status message is sent to the transmitter indicating the number of the video frame that was in error;
(3) Upon receiving such an error status message, the video transmitter stops sending all predicted frames, and instead immediately sends the next available key frame to the receiver;
(4) After sending the key frame, the transmitter resumes sending normal inter-frame coded video frames until another error status message is received.

A key frame is a video frame that has only been intra-frame coded but not inter-frame coded. Inter-frame coding is where the prediction processes are performed and makes these frames dependent on all the preceding video frames after and including the last key frame. Key frames are sent as the first frame and whenever an error occurs. The first frame needs to be a key frame because there is no previous frame to use for inter-frame coding.

Voice Command Process

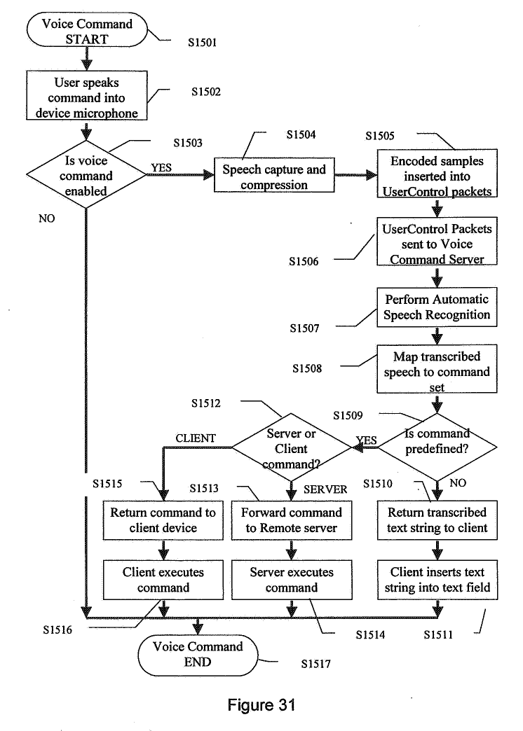

Since wireless devices are small, the ability to enter text commands manually for operating the device and data processing is difficult. Voice commands have been suggested as a possible avenue for achieving hands-free operation of the device. This presents a problem in that many wireless devices have very low processing power, well below that required for general automatic speech recognition (ASR). The solution in this case is to capture the user speech on the device, compress it, and send it to the server for ASR and execution as shown in FIG. 31, since in any case the server will be actioning all user commands. This frees the device from having to perform this complex processing, since it is likely to be devoting most of its processing resources to decoding and rendering any streaming audio/video content. This process is depicted by the flowchart of FIG. 31, beginning at step s1501. The process is initiated when the user speaks a command into the device microphone at step s1502. If, at step s1503, voice commands are disabled, the voice command is ignored and the process ends at step s1517. Otherwise, the voice command speech is captured and compressed at step s1504, the encoded samples are inserted into USERCTRL packets at step s1505, and sent to a voice command server at step s1506. The voice command server then performs automatic speech recognition at step s1507, and maps the transcribed speech to a command set at step s1508. If the transcribed command is not predefined at step s1509, the transcribed test string is sent to the client at step s1510, and the client inserts the text string into an appropriate text field. If (step s1509) the transcribed command is predefined, the command type (server or client) is checked at step s1512. If the command is a server command, it is forwarded to the server at step s1513, and the server executes the command at step s1514. If the command is a client command, the command is returned to the client device, step s1515, and the client executes the command, step s1516, concluding the voice command process at step s1517.

Applications

Ultrathin Client Process and Compute Servers

By using an ultra thin client as a means for controlling a remote computer of any kind from any other kind of personal mobile computing device, a virtual computing network is created. In this new application, the user's computing device performs no data processing, but serves as a user interface into the virtual computing network. All the data processing is performed by compute servers located in the network. At most, the terminal is limited to decoding all output and encoding all input data, including the actual user interface display. Architecturally, the incoming and outgoing data streams are totally independent within the user terminal. Control over the output or displayed data is performed at the compute server where the input is data is processed. Accordingly, the graphical user interface (GUI) decomposes into two separate data streams: the input and the output display component, which is a video. The input stream is a command sequence that may be a combination of ASCII characters and mouse or pen events. To a large extent, decoding and rendering the display data comprises the main function of such a terminal, and complex GUI displays can be rendered.

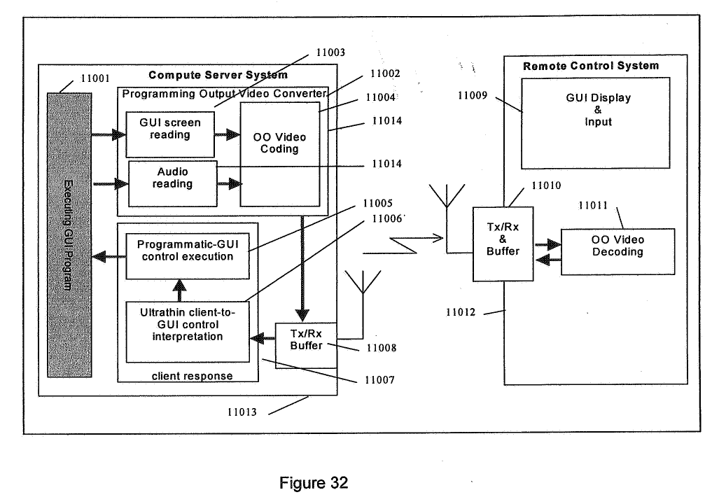

FIG. 32 shows an ultra thin client system operating in a wireless LAN environment. This system could equally operate within a wireless WAN environment such as across CDMA, GSM, PHS or other similar networks. In the wireless LAN environment system, a range from 300 meters indoors to up to 1 km outdoors is typical. The ultrathin client is a personal digital assistant or palmtop computer with a wireless network card and antenna to receive signals. The wireless network card interfaces to the personal digital assistant through through a PCMCIA slot, a compact flash port or other means. The compute server may be any computer running a GUI that is connected to the Internet or a local area network with wireless LAN capability. The compute server system can comprise of Executing GUI Programs (11001) which are controlled by client response (11007) with the program outputs, including audio and GUI display, being read and encoded with the Program output video converter (11002). Delivery of the GUI display to the Remote Control System (11012) can be achieved by first video encoding within 11002 which uses the GO Video Coding (11004) to convert the GUI display, captured through the GUI screen reading (11003), and any audio, captured through the Audio reading (11014), to compressed video using the process described previously for encoding and transmits it to the ultra thin client. The GUI display may be captured using a GUI screen reading (11003) which is a standard function in many operating systems such as CopyScreenToDIB( ) in Microsoft Windows NT. The ultra thin client receives the compressed video via the Tx/Rx Buffer (11008 and 11010) and renders it appropriately to the user display using the GUI Display and Input (11009) after decoding via the GO Video Decoding (11011). Any user control data is transmitted back to the compute server, where it is interpreted by the Ultrathin client-to-GUI control interpretation (11006) and used to control the executing GUI Program (11001) through the Programmatic-GUI control execution (11005). This includes the ability to execute new programs, terminate programs, perform operating system functions, and any other fanctions associated with the running program(s). This control may be effected through various, in the case of MS Windows NT, the Hooks/JournalPlaybackFunc( ) can be used.

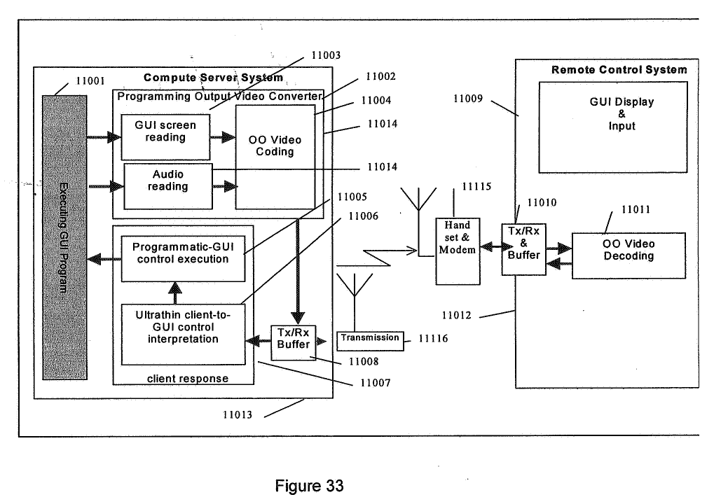

For longer range applications, the WAN system of FIG. 33 is preferred. In this case, the compute server is directly connected to a standard telephone interface, Transmission (11116), for transmitting the signals across a CDMA, PHS, GSM or similar cellular phone network. The ultra thin client in this case comprises a personal digital assistant with a modem connected to a phone, Handset and Modem (11115). All other aspects are similar in this WAN system configuration to those described in FIG. 32. In a variation of this system, the PDA and phone are integrated within a single device. In one instance of this ultra thin client system, the mobile device has full access to the compute server from any location whilst within the reach of standard mobile telephony networks such as CDMA, PHS or GSM. A cabled version of this system may also be used which dispenses with the mobile phone so that the ultra thin computing device is connected directly to the standard cabled telephone network through a modem.

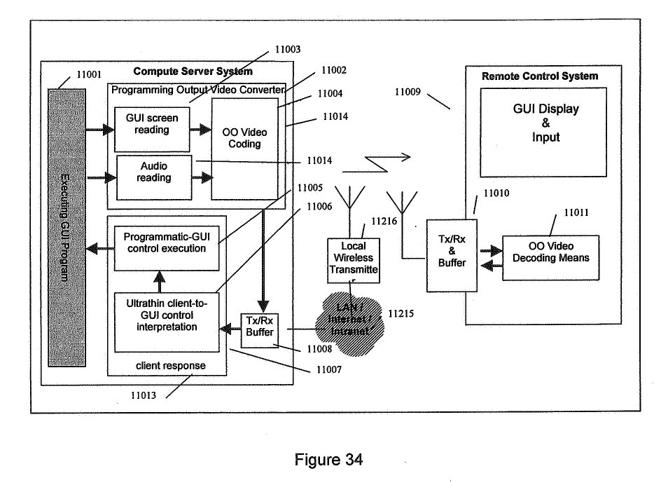

The compute server may also be remotely located and connected via an Intranet or the Internet (11215) to a local wireless transmitter/receiver (11216) as depicted in FIG. 34. This ultra thin client application is especially relevant in the context of emerging Internet-based virtual computing systems.

Rich Audio-Visual User Interfaces

In the ultra thin client system where no object control data is inserted into the bit stream, the client may perform no process other than rendering a single video object to the display and returns all user interaction to the server for processing. While that approach can be used to access the graphical user interface of remotely executing processes, it may not be suitable for creating user interfaces for locally executing processes.

Given the object-based capabilities of the DMC and interaction engine, this overall system and its client-server model is particularly suited for use as the core of a rich audio-visual user interface. Unlike typical graphical user interfaces, which are based on the concept of mostly static icons and rectangular windows, the current system is capable of creating rich user interfaces using multiple video and other media objects which can be interacted with to facilitate either local device or remote program execution.

Multipart Wireless VideoConferencing Process

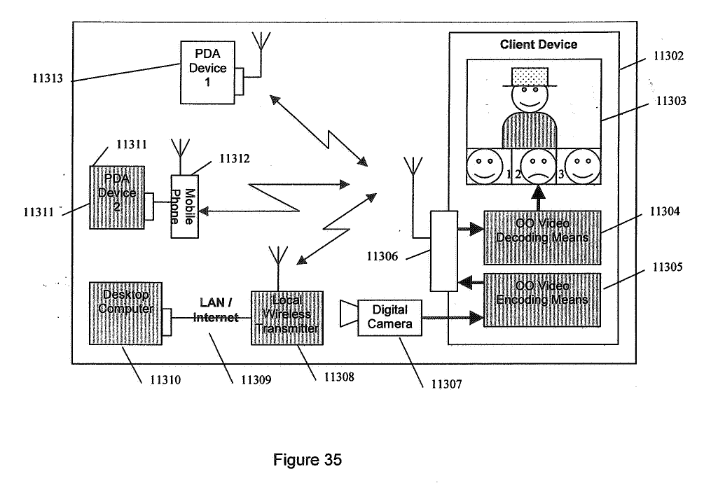

FIG. 35 shows a multiparty wireless videoconferencing system involving two or more wireless client telephony devices. In this application, two or more participants may set up a number of video communication links among themselves. There is no centralised control mechanism, and each participant may decide what links to activate in a multiparty conference. For example, in a three person conference consisting of persons A, B, C, links may be formed between persons AB, BC and AC (3 links), or alternatively AB and BC but not AC (2 links). In this system, each user may set up as many simultaneous links to different participants as they like, as no central network control is required and each link is separately managed. The incoming video data for each new videoconference link forms a new video object stream that is fed into the object oriented video decoder of each wireless device connected in a link relevant to the incoming video data. In this application, the object video decoder (object oriented Video Decoding 11011) is run in a presentation mode where each video object is rendered (11303) according to layout rules, based on the number of video objects being displayed. One of the video objects can be identified as currently active, and this one may be rendered in a larger size than the other objects. The selection of which object is currently active may be performed using either automatic means based on the video object with most acoustic energy (loudness/time) or manually by the user. Client telephony devices (11313, 11311, 11310, 11302) include personal digital assistants, handheld personal computers, personal computing devices (such as notebooks and desktop PCs) and wireless phone handsets. Client telephony devices can include wireless network cards (11306) and antennae (11308) to receive and transmit signals. A wireless network card interfaces to the client telephony device through a PCMCIA slot, a compact flash port or other connection interface. A wireless phone handset can be used for the PDA wireless connection (11312). A link can be established across a LAN/Intranet/Internet (11309). Each client telephony device (eg. 11302) may include a video camera (11307) for digital video capture and one or more microphones for audio capture. The client telephony device includes the video encoder (OO Video Encoding 11305) to compress the captured video and audio signals, using the process described previously, which are then transmitted to one or more other client telephony devices. The digital video camera may only capture digital video and pass it to the client telephony device for compression and transmission, or it may also compress the video itself using a VLSI hardware chip (an ASIC) and pass the coded video to the telephony device for transmission. The client telephony devices, which contain specific software, receive the compressed video and audio signals and render them appropriately to the user display and speaker outputs using the process previously described. This embodiment may also include direct video manipulation or advertising on a client telephony device, using the process of interactive object manipulation described previously, which can be reflected (replicated on the GUI display) through the same means as above to other client telephony devices participating in the same videoconference. This embodiment may include transmission of user control data between client telephony devices such as to provide for remote control of other client telephony devices. Any user control data is transmitted back to the appropriate client telephony device, where it is interpreted and then used to control local video image and other software and hardware functions. As in the case of the ultra thin client system application, there are various network interfaces which can be used.

Interactive Animation or Video On Demand with Targeted in-Picture User Advertising

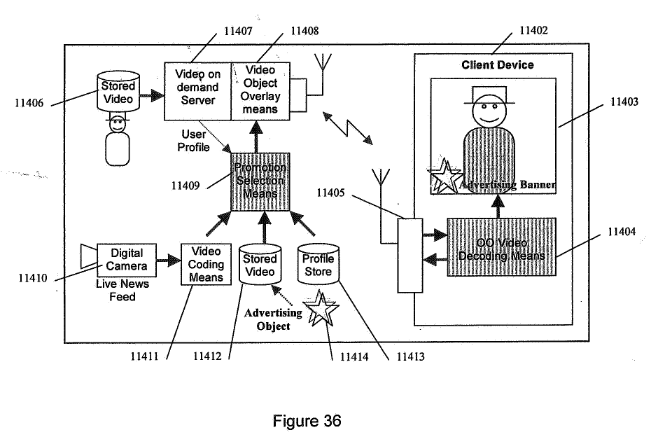

FIG. 36 is a block diagram of an interactive video on demand system with targeted user video advertising. In this system, a service provider (eg. live news, video-on-demand (VOD) provider, etc.) would unicast or multicast video data streams to individual subscribers. The video advertising can include multiple video objects which can be sourced separately. In one instance of the video decoder, a small video advertisement object (11414) is dynamically composited into the video stream being delivered to the decoder (11404) to be rendered into the scene being viewed at certain times. This video advertising object can be changed either from pre-downloaded advertising stored on the device in a library (11406), or streamed from remote storage (11412) via an online video server (eg. Video on demand server 11407) capable of dynamic media composition using Video Object Overlay (11408). This video advertising object can be targeted specifically to the client device (11402) based on the client owner's (subscriber's) profile information. A subscriber's profile information can have components stored in multiple locations such as in an online server library (11413) or locally on the client device. For targeted video based advertising, feedback and control mechanisms for video streams and viewing thereof are used. The service provider or another party can maintain and operate a video server that stores compressed video streams (11412). When a subscriber selects a program from the video server, the provider's transmission system automatically selects what promotion or advertising data is applicable from information obtained from a subscriber profile database (11413) which can include information such as subscriber age, gender geographical location, subscription history, personal preferences, purchasing history, etc. The advertising data, which can be stored as single video objects, can then be inserted into the transmission data stream together with the requested video data and sent to the user. As a separate video object(s), the user can then interact with the advertising video object(s) by adjusting its presentation/display properties). The user may also interact with the advertising video object(s) by clicking, or dragging, etc.) on the object to thereby send a message back to the video server indicating that the user wishes to activate some function associated with that advertising video object as determined by the service provider or Advertising object provider. This function may simply entail a request for further information from the advertiser, placing a video/phone call to the advertiser, initiate a sales coupon process, initiate a proximity based transaction or some other form of control. In addition to advertising, this function may be directly used by the service provider to promote additional video offerings such as other available channels, which may be advertised as small moving iconic images. In this case, the user action of clicking on such an icon may be used by the provider to change the primary video data being sent to the subscriber or send additional data. Multiple video object data streams may be combined by the video object overlay (11408) into the final composite video data stream that is transmitted to each client. Each of the separate video object streams that are combined may be retrieved over the Internet by the video promotion selection (11409) from different remote sources such as other video servers, web cameras (11410), or compute servers through either real-time or preprocessed encoding as previously described (Video Coding, 11411). Again, as in the other system applications of ultra thin clients and videoconferencing, various preferred network interfaces can be used.

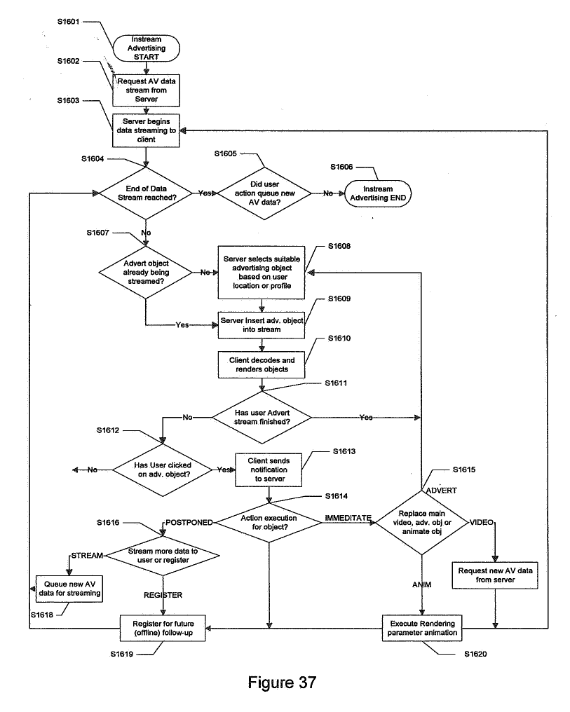

In one embodiment of in-picture advertising, the video advertisement object may be programmed to operate like a button as shown in FIG. 37 which, when selected by a user, may do one of the following:
Immediately change the video scene being viewed by jumping to a new scene that provides more information about the product being advertised or to an online e-commerce enabled store. For example, it may be used to change “video channels”.
Immediately change the video advertising object into; streaming text information like subtitles by replacing the object with another that provides more information about the product being advertised. This does not affect any other video objects in the displayed scene.
Removes the video advertising object and sets a system flag indicating that the user has selected the advertisement, the current video will then play through to the end normally and then jumpto the indicated advertisement target
Send a message back to the server registering interest in the product being offered for future asynchronous followup information, which may be via email or as additional streaming video objects, etc.
Where the video advertising object is being used for branding purposes only, clicking on the object may toggle its opacity and make it semitransparent, or enable it to perform a predefined animation such as rotating in 3D or moving in a circular path.

Another manner of using video advertising objects is to subsidise packet charges or call charges for users of mobile smart phones by:
Automatically displaying a sponsor's video advertising object for an unconditionally sponsored call during or at the end of the call.
Displaying an interactive video object prior to, during or after the call offering sponsorship if the user performs some interaction with the object.

FIG. 37 shows one embodiment of in-picture advertising the system is. When an in-picture advertising session is started (Instream Advertising Start s1601) a request for an audio-visual stream (Request AV data stream from Server s1602) is sent from the client device (Client) to a server process. The server process (Server) can be local on the client device or remote on an online server. In response to the request the server begins streaming the request data (s1603) to the client. The While streaming data is being received by the client it executes processes to render the data stream, and accepts and responds to user interaction. Hence the client checks to see if the received data indicates that the end of the current AV streaming has been reached (s1604). If this is true and unless there is another queued AV data stream (s1605) to be streamed pending completion of the current stream just ended then the in-picture advertising session can end (s1606). If queued AV data streams exist then the server commences streaming the new AV data stream (back to s1603). While in the process of streaming a data stream such that the end of the AV stream has not been reached (s1604—NO) and if a current advertising object is not being streamed then the Server can select (s1608) and insert new advertising object(s) in the AV stream (s1609) based on parameters including: location, user profile, etc. If the server is in the process of streaming an AV data stream and an advertising object has been selected and inserted into the AV stream the client decodes the bit stream as described previously and renders the objects (s1610). Whilst the AV data stream may continue, the in-picture advertising stream may end (s1611) due to various reasons including: client interaction, server intervention or end of advertising stream. If the in-picture advertising stream has ended (s1611—YES) then reselection of a new in-picture advertisement may occur through s1608. If the AV data stream and in-picture advertising stream continue (s1611—NO) then the client captures any interaction with the advertising object. If a user clicks on object the object (s1612—YES) the client sends notification to the Server (s1613). The server's dynamic media composition program script define what actions are to be taken in response. These include: no action, delayed (postponed) or immediate actions (s1614). In the case of no action (s1614—NONE) the server can register this fact for future (online or off-line) follow up actions (s1619), this could include updating user profile information which could be used in targeting similar advertisements or follow up advertisements. In the case of a delayed action (s1614—POSTPONED) then the action to be taken may include registration (s1619) for followup as per undertaken for s1619 or queuing a new AV data (s1618) for streaming pending the end of the current AV data stream. In a circumstance when the Server is on the client device this may be queued and downloaded when the device may next be connected to an online server. In the case with a remote online Server then when the current AV stream is completed, queued streams may then play (s1605—YES). In the case of an immediate action (s1614—IMMEDIATE) then a number of actions could be performed based on the control information attached to the advertising object including: change animation parameters for the current advertising object (s1615—ANIM), replace the current advertisement object(s) (s1615—ADVERT) and replace the current AV data stream (s1617). Animation request changes (s1615—ANIM) could result in rendering changes for the object (s1620) such as translation or rotation, and transparency etc. This would be registered for later followup as per (s1619) In the case of an advertising object change request (s1615—ADVERT) a new advertising object could be selected as before (s1608)

In another embodiment, the dynamic media composition capabilities of this video system may be used to enable viewers to customise their content. An example is where the user may be able to select from one of a number of characters to be the principal character in a storyline. In one such case with an animated cartoon, viewers may be able to select from male or female characters. This selection may be performed interactively from a shared character set such as for online multi-participant entertainment or may be based on a stored user profile. Selecting a male character would cause the male character's audiovisual media object to be composited into the bit stream to replace that of a female character. In another example, rather than just selecting the principal character for a fixed plot, the plot itself may be changed by making selections during viewing that change the storyline such as by selecting which scene to jumpto display next. A number of alternative scenes could be available at any given point. Selection Selections may be constrained by various mechanisms such as the previous selections, video objects selected and position within the storyline the video is at.

Service providers may provide user authentication and access control to video material, metering of content consumption and billing of usage. FIG. 41 shows one embodiment of the system where all users could register with the relevant authentication/access provider (11507) before they are provided access to services (eg. content services). The authentication/access service could create a ‘unique identifier’ and ‘access information’ for each user (11506). The unique identifier could be automatically transferred to the client device (11502) for local storage when the client is online (eg. first access to the service). All subsequent requests by users to stored video content (11510) via a video content provider (11511) could be controlled with the use of the client system's user identifier. In one example of usage a user could be billed a regular subscription fee which enables access to content for the user by authentication of their unique identifier.

Alternatively in a pay-per-view situation, billing information (11508) can be gathered through usage. Information about usage such as metering may be recorded by the content provider (11511) and supplied to one or more of Billing Service Provider (11509) and Access Broker/Metering Provider (11507). Different levels of access can be granted for different users and different content. Per previous system embodiments wireless access could be achieved in multiple ways, FIG. 41 shows one instance of access for the client device (11502) through the Tx/Rx Buffer (11505) to the Local Wireless Transmitter (11513) which provides access to the service providers via a LAN/Intranet or Internet connection (11513) not excluding wireless WAN access as well. The client device may liase with the Access Broker/Metering (11507) in real-time to gain access rights to the content. An encoded bit stream can be decoded by 11504 as previously described and rendered to screen with client interaction made possible as previously described (11503). The access control and or billing service provider can maintain a user usage profile which may then be sold or licensed to third parties for advertising/promotional purposes. In order to implement billing and usage control, a suitable encryption method can be deployed, as previously described. In addition to this, a process for uniquely branding/identifying an encoded video can be used as described previously.

Video Advertising Brochures

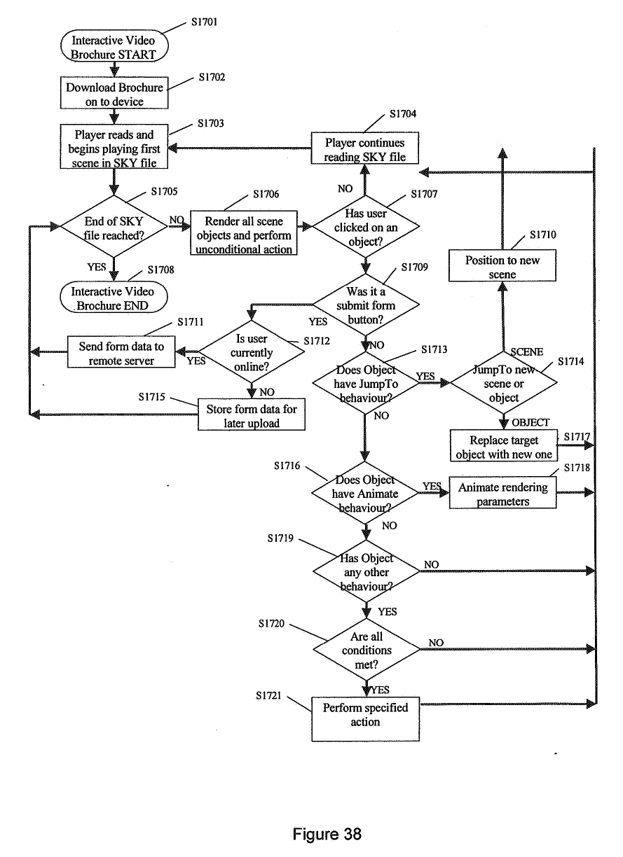

An interactive video file may be downloaded rather than streamed to a device so that it can be viewed offline or online at any time as shown in FIG. 38. A downloaded video file still preserves all of the interaction and dynamic media composition capabilities that are provided by the online streaming process previously described. Video brochures may include menus, advertising objects, and even forms that register user selections and feedback. The only difference is that, since video brochures may be viewed offline, hyperlinks attached to the video objects may not designate new targets that are not located on the device. In this situation, the client device could store all user selections not able to be serviced from data on the device and forward these to the appropriate remote server the next time the device is online or synchronised with a PC. Forwarded user selections in this manner may cause various actions to be performed such as providing further information, downloading requested scenes or linking to requested URLs. Interactive Video Brochures can be used for many content types such as Interactive Advertising Brochures, Corporate Training Content Interactive Entertainment and for interactive online and offline purchasing of goods and services.

FIG. 38 shows one possible embodiment of Interactive Video Brochures (IVB) In this example the IVB (SKY file) data file can be downloaded to the client device (s1702) upon request (pull from server) or as scheduled (push from server) (s1701). The download could occur either wirelessly, via synchronisation with a desktop PC or distributed on media storage technology such as compact flash, or memory stick. The client's player would decode the bitstream (as previously described) and render the first scene from the IVB (s1703). If the player reaches the end of the IVB (s1705—YES) then the IVB will end (s1708). When the player has not reached the end of the IVB it renders the scene(s) and executes all unconditional object control actions (s1706). The user may interact with objects as defined by the object controls. If the user does not interact with an object (s1707—NO) then the player continues to read from the data file (s1704). If the user interacts with an object within the scene (s1707—YES) and the object control action was to perform a submit a form operation (s1709—YES) then if the user is online (s1712—YES) then the form data could be sent to the online server (s1711), otherwise if offline (s1712—NO) then the form data could be stored for later upload (s1715) when the device is back online. If the object's control action was a JumpTo behaviour (s1713—YES) and the control specified a jump to a new scene then the player could seek to the location of the new scene in the data file (s1710) and continue reading data from there. If the control specified a jump to another object (s1714—OBJECT) then this could cause the target object to be replaced and rendered, by accessing the correct data stream in the scene as stored in the data file (s1717). If the object's control action was to change the object's animation parameters (s1716—YES) then the object's animation parameters would be could be updated or actioned depending on the parameters specified by the object control (s1718). If the object's control action was to perform some other operation on the object (s1719—YES) and all the conditions specified by the control are met (s1720—YES) then the control operation is performed (s1721). If the object selected did not have a control operation (s1719—NO or s1720—NO) then the player can continue reading and rendering the video scene. In any of these cases, the action request can be logged and notification can be stored for later upload to the server if offline or transferred directly to the server if online.

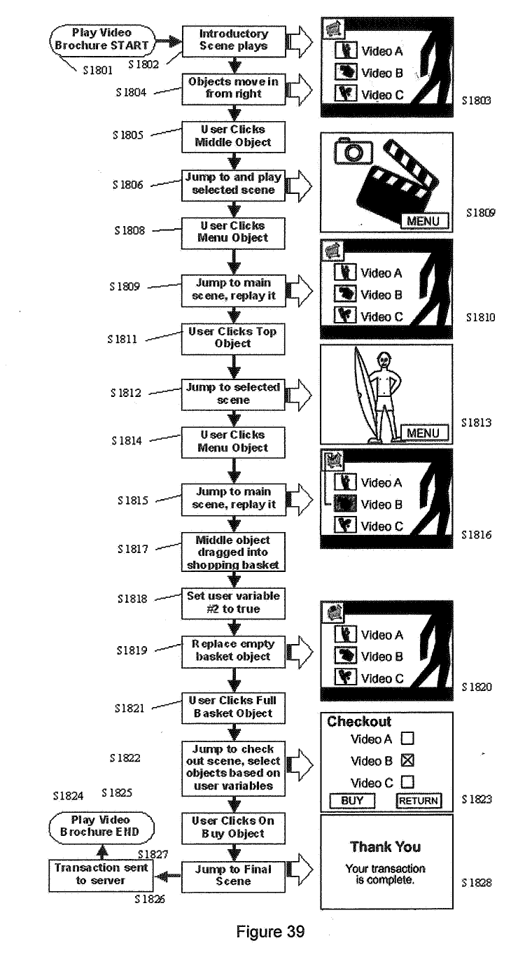

FIG. 39 shows one embodiment of Interactive Video Brochure for advertising and purchasing applications. The example shown contains forms for online purchasing and content viewing selection. The IVB is selected and playing commenced (s1801). The introductory scene could play (s1802) which could consist of multiple objects as shown (s1803, video object A, video object B, video object C). All video objects could have various rendering parameter animations defined by their attached control data, for example A, B and C could move in from the right hand side after the main viewing object has begun rendered (s1804). The user could interact with any object and initiate an object control action, for example the user could click on B (s1805) which could have a “JumpTo” hyper link, control action to stop playing the current scene and start playing the new scene as indicated by the control parameters (s1806, s1807). This could contain multiple objects, for example it could obtain a Menu object for navigation control which the user could select (s1808) to return to the main scene (s1809, s1810). The user could interact with another object, for example A (s1811), which could have a behaviour to jump to a another specific scene (s1812, s1813). In the example shown the user could select the Menu option again (s1814) to return to the main scene (s1815, s1816). Another user interaction could be to drag object B into the shopping basket shown (s1817) which can cause the execution of another object control that was conditional on overlapping objects B and the shopping basket to register a purchase request by setting the state of appropriate user flag variables (s1818) and also cause object animation or change (s1819, s1820) based on the dynamic media composition where in the example the shopping basket is shown full. The user could interact with the shopping basket object (s1821) which may have a jumpto behaviour to a check out transaction and information scene (s1822, s1823) which could show purchases requested. The objects displayed in this scene would be determined by the dynamic media composition based on the value of the user flag variables. The user may interact with the objects such as to change their purchase request state on/off by modifying the user flags as defined by the object control parameters which would cause the dynamic media composition process to show selected or unselected objects in the scene. The user may alternatively choose to interact with the buy or return objects which may have jumpto new scene control behaviour with the appropriate scenes as targets, such as the main scene or a scene to commit the transaction (s1825). A committed transaction could be stored on the client device if offline for later upload to a server or could be uploaded to the server in real-time for purchase/credit authorization if client device online. Selecting the buy object could jump to a confirmation scene (s1827, s1828) whilst the transaction could be sent through to a server (s1826) with any remaining video played after transaction completed (s1824).

Distribution Models and DMC Operation

There are numerous distribution mechanism for delivery of a bitstream to a client device including: download to desktop PC with synchronisation to the client device, wireless online connection to device and compact media storage devices. Content delivery can be initiated either by the client device or by the network. The combinations of distribution mechanism and delivery initiation provide a number of delivery models. One such model client initiated delivery is on-demand streaming in which one embodiment referred to as on demand streaming which provides a channel with low bandwidth and low latency (eg. wireless WAN connection) and the content is streamed in real-time to the client device where it is viewed as it is streamed. A second model of content delivery is a client initiated delivery over an online wireless connection where content can be quickly downloaded in entirety before playing such as using a file transfer protocol, one embodiment provides a high bandwidth, high latency channel in which the content is delivered immediately and subsequently viewed. A third delivery model is a network initiated delivery in which one embodiment provides low bandwidth and high latency, the device is said to be “always on”—since the client device can be always online. In this model, the video content can be trickled down to the device overnight or other off-peak period and buffered in memory for viewing at a later time. In this model, the operation of the system differs second model above (client initiated on-demand download) in that users would register a request for delivery of specific content with a content service provider. This request would then be used to automatically schedule network initiated delivery by the server to the client device. When the appropriate time for the delivery of the content occurs such as an off-peak period of network utilisation the server would set up a connection with the client device and negotiate the transmission parameters and manage the data transfer with the client. Alternatively the server could send the data in small amounts from time-to-time using any available residual bandwidth left over in the network from that allocated (for example in constant rate connections). Users could be made aware that the requested data has been fully delivered by signalling to users via a visual or audible indication so that they can then view the requested data when they are ready.

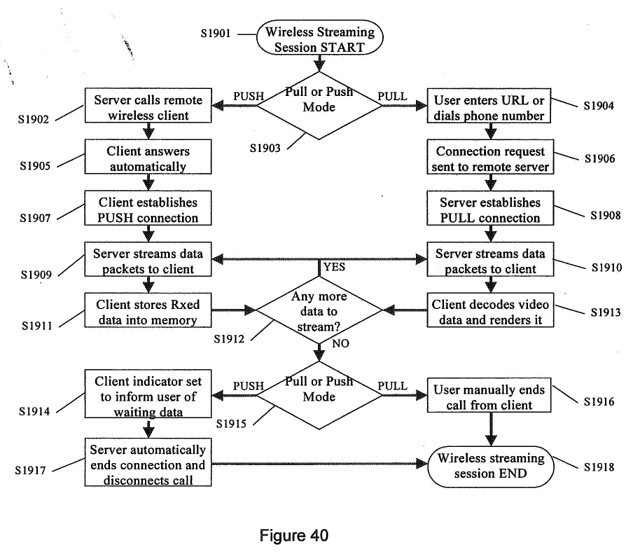

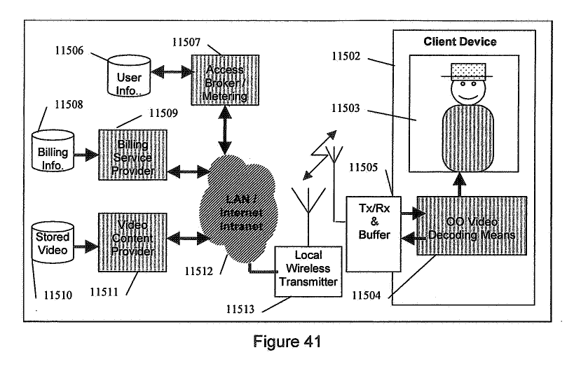

The player is capable of handling both the push or pull delivery models. One embodiment of the system operation is shown in FIG. 40. A wireless streaming session can be commenced (s1901) by either the client device (s1903—PULL) or by the network (s1903—PUSH). In a client initiated streaming session the client can initiate the stream through various ways (s1904) such as: entering a URL, hyperlinking from an interactive object or dialling the phone number of a wireless service provider. A connection request can be sent to the remote server (s1906) from the client. The server can establish and start a PULL connection (s1908) which can stream data to the client device (s1910). During streaming the client decodes and renders the bitstream as well as takes user input as previously described. As more data is streamed (s1912—YES) the server continues to stream new data to the client for decoding and rendering, this process can include interactivity and DMC functionality as described previously. Normally when there is no more data in the stream (s1912—NO) the user can terminate the call from the client device (s1915—PULL) but the user may terminate the call at any time. Termination of the call will close the wireless streaming session otherwise if the user does not terminate the call after the data has finished streaming the client device may enter an idle state but remain online. In an example of a network initiated wireless streaming session (s1903—PUSH) the server could call the client device (s1902). The client device could automatically answer the call (s1905) with the client establishing a PUSH connection (s1907). The establishment process may include negotiation between the server and the client regarding capabilities of the client device, or configuration or user specific data. The server could then stream data to the client (s1909) with the client storing the received data for later viewing (s1911). Whilst more data may need to be streamed (s1912—YES) this process could continue either over a very long period of time (low bandwidth trickle stream) or over a shorter period of time (higher bandwidth download). When the entire data stream or a certain scripted position is reached within the stream (s1912—NO) then the client device in this PUSH connection (s1915—PUSH) could signal the user that content was ready for playing (s1914). After streaming all required content the server could terminate the call or connection to the client device (s1917) to end the wireless streaming session (s1918). In another embodiment hybrid operation between PUSH and PULL connections could occur with a network initiated message to a wireless client device which when received can be interacted with by the subscriber to commence a PULL connection as described above. In this way a PULL connection can be prompted by scheduled delivery by the network of data containing a suitable hyperlink.

These three distribution models are suitable for unicast mode of operation. In the first on demand model described above, the remote streaming server can perform unrestricted dynamic media composition and handle user interaction and execute object control actions etc, in real-time, whereas in the other two models, the local client can handle the user interaction and perform DMC as the user may view the content offline. Any user interaction data and form data to be sent to the server can be delivered immediately if the client is online or at an indeterminate time if offline with subsequent processing undertaken on the transferred data at an indeterminate time.

FIG. 42 is a flowchart depicting one embodiment of the main steps a wireless streaming player/client performs in playing on demand streaming wireless video, according to the present invention. The client application begins at step s2001, waiting for a user to enter a URL or phone number of a remote server, at step s2002. When the user enters the remote server URL or phone number the software initiates at step s2003 a network connection with the wireless network (if not already connected). After connection is established the client software requests data to be streamed from the server at step s2004. The client then continues processing the on demand streaming video until the user requests a disconnection, when at step s2005, the software proceeds to step s2007 to initiate a call disconnect with the wireless network and remote server. Finally the software frees any resources it may have allocated at step s2009 and the client application ends at step s2011. Until the user requests the call to be ended step s2005 proceeds to step s2006 checking for network data received. If no data is received the software returns to step s2005. However if data is received from the network, the incoming data is buffered at step s2008 until an entire packet is received. When a complete packet is received step s2010 checks the data packet for errors, sequence information and synchronisation information. If, at step s2012 the data packet contains errors, or is out of sequence a status message is sent to the remote server indicating this at step s2013; subsequently returning to step s2005 to check for a user call disconnect request. If however the packet was received without error step s2012 proceeds to step s2014 and the data packet is passed to the software decoder at step s2014, and is decoded. The decoded frames are buffered in memory at step s2015 for rendering at step s2016. Finally the application returns to step s2005 to check for a user call disconnect and the wireless streaming player application continues.

Apart from unicast, other operating modes include multicast and broadcast. In the case of a multicast or broadcast, the system/user interaction and DMC capabilities can be constrained and may operate in a different manner to unicast models. In a wireless environment, it is likely that multicast and broadcast data will be transmitted in separate channels. These are not purely logical channels as with packet networks, instead these may be circuit switched channels. A single transmission is sent from one server to multiple clients. Hence user interaction data may be returned to the server using separate individual unicast ‘back channel’ connections for each user. The distinction between multicast and broadcast is that multicast data may be broadcast only within certain geographical boundaries such as the range of a radio cell. In one embodiment of a broadcast model of data delivery to client devices, data can be sent to all radio cells within a network, which broadcast the data over particular wireless channels for client devices to receive.

An example of how a broadcast channel may be used is to transmit a cycle of scenes containing service directories. Scenes could be categorised to contain a set of hyper-linked video objects corresponding to other selected broadcast channels, so that users selecting an object will change to the relevant channel. Another scene may contain a set of hyper-linked video objects pertaining to video-on-demand services, where the user, by selecting a video object, would create a new unicast channel and switch from the broadcast to that. Similarly, hyper-linked objects in a unicast on demand channel would be able to change the bit stream being received by the client to that from a specified broadcast channel

Since a multi or broadcast channel transmits the same data from the server to all the clients, the DMC is restricted in its ability to customise the scene for each user. The control of the DMC for the channel in a broadcast model may not be subject to individual users, in which case it would not possible for individual user interaction to modify the content of the bit stream being broadcast. Since broadcast relies on real-time streaming, it is unlikely that the same approach can be for local client DMC as with offline viewing, where each scene can have multiple object streams and jump to controls can be executed. In broadcast models the user, however, is not completely inhibited from interacting with the scenes, they are still free to modify rendering parameters such as activating animations, etc, registering object selection with the server, and they are free to select a new unicast or broadcast channel to jump to by activating any hyperlinks associated with video objects.

One way in which DMC can be used to customise the user experience in broadcast is to monitor the distribution of different users currently watching the channel and construct the outgoing bit stream defining the scene to be rendered based on the average user profile, For example, the selection of in-picture advertising object may be based on whether viewers were predominantly male or female. Another manner that the DMC can be used to customise the user experience in a broadcast situation is to send a composite bit stream with multiple media objects, without regard for the current viewer distribution. The client in this case selects from among the objects based on a user profile local to the client to create the final scene. For example, multiple subtitles in a number of languages may be inserted into the bit stream defining a scene for broadcasting. The client is then able to select which language subtitle to render based on special conditions in the object control data broadcast in the bit stream.

Video Monitoring System

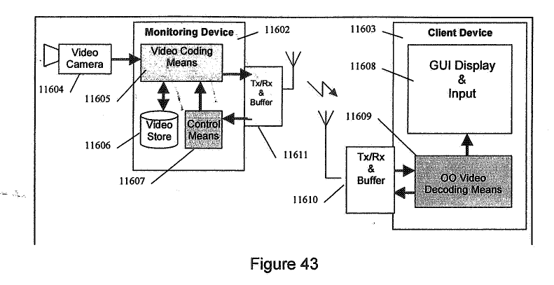

FIG. 43 shows one embodiment of a video monitoring system which could be used to monitor in real-time many different environments such as: home property and family, commercial property and staff, traffic, childcare, weather and special interest locations. In this example a video camera device (11604) could be used for video capture. The captured video could be encoded as previously described within 11602 with the ability to combine additional video objects from either store (11606) or streamed in remotely from a server using controls (11607) as previously described. The monitoring device (11602) could be: part of the camera (as in an ASIC implementation), part of a client device (eg. PDA with camera and ASIC), separate from the camera (eg. separate monitoring encoding device) or remote from the video capture (eg. a server encoding process with live video feed). The encoded bitstream can be streamed or downloaded at scheduled times to the client device (11603) where the bitstream can be decoded (11609) and rendered (11608) as previously described. In addition to transmitting remote video to wireless handheld devices over short ranges using wireless LAN interfaces, monitoring devices (11602) are also able to transmit remote video over long distances using standard wireless network infrastructures such as: telephone interface over using TDMA, FDMA, or CDMA transmission using PHS, GSM or other such wireless networks. Other access network architectures can also be used. The monitoring system can have intelligent functions such as motion detection alarms, automatic notification and dial out on alarm, recording and retrieval of video segments, select and switch between multiple camera inputs, and provide for user activation of multiple digital or analogue outputs at the remote location. Applications of this include domestic security, child monitoring and traffic monitoring. In this last case live traffic video is streamed to users and can be performed in a number of alternative ways:
a. The user dials a special phone number and then selects the traffic camera location to view within the region handled by the operator/exchange.
b. The user dials a special phone number and the users geographic location (derived from GPS or GSM cell triangulation for example) is used to automatically provide a selection of traffic camera locations to view with possible accompanying traffic information. In this method the user may be able to optionally specify his or her destination, which if provided may be used to help provide the selection of traffic camera.
c. The user can register for a special service where the service provider will call the user and automatically stream video showing the motorists route that may have a potential traffic jam. Upon registering the user may elect to nominate on or more scheduled routes for this purpose, which may be stored by the system to assist with predicting the users route possibly in combination with positioning information from GPS systems or cell triangulation. The system would track the users speed and location to determine direction of travel and route being followed; it would then search its list of monitored traffic cameras along potential routes to determine if any sites are congested. If so then the system would notify the motorist of any congested routes and present the traffic view most relevant to the user. Stationary users or those travelling at walking speeds would not be called. Alternatively given a traffic camera indicating congestion the system may search through the list of registered users that are travelling on that route and alert them.
   Electronic Greeting Card Service

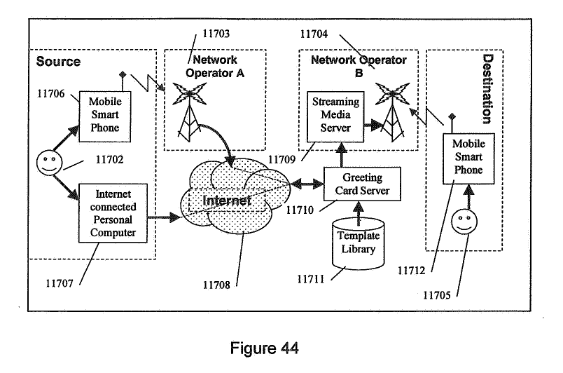

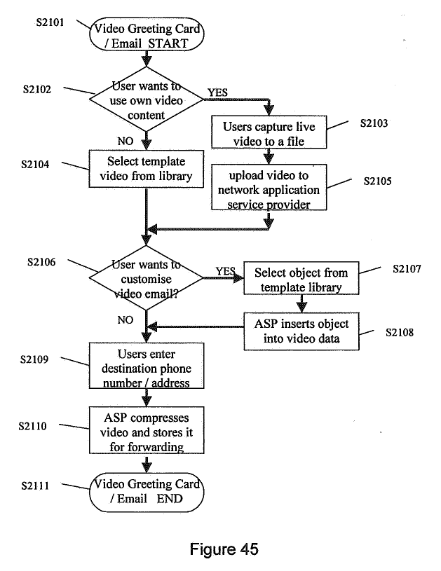

FIG. 44 is a block diagram of one embodiment of an electronic greeting card service for smart mobile phones 11702 and 11712 and wirelessly connected PDAs. In this system, an initiating user 11702 can access a greeting card server 11710 either from the Internet 11708 using a Internet connected personal computer 11707 or the mobile phone network 11703 using a mobile smart phone 11706 or wirelessly connected PDA. The Greeting Card server 11710 provides a software interface that permits users to customise a greeting card template selected from a template library 11711 stored on the server. The templates are short videos or animations covering a number of themes, such as birthday wishes, postcards, good luck wishes, etc. The customisation may include the insertion of text and or audio content to the video and animation templates. After customisation, the user may pay for the transaction and forward the electronic greeting card to a person's mobile phone number. The electronic greeting is then passed to the streaming server 11712 to be stored. Finally the greeting card is forwarded from the streaming media server 11709, via the wireless phone network 11704 during off peak periods, to the desired user's 11705 mobile device 11712. In the case of post cards, specialised template videos can be created for mobile phone networks in each geographic locations that can only be sent by people physically within that locality. In another embodiment, users are able to upload a short video to a remote application service provider which then compresses the video and stores it for later forwarding to the destination phone number. FIG. 45 is a flowchart showing one embodiment of the major steps a user would perform to generate and send an electronic greeting card according to the present invention. The process as shown begins in step s2101, where the user is connected via either the Internet or a wireless phone network to the application service provider ASP. If, at step s2102, the user wants to use their own video content, the user may capture live video or obtain video content from any of a number of sources. This video content is stored in a file at step s2103, and is uploaded, at step s2105, by the user to application service provider and is stored by the greeting card server. If the user does not want to use their own video content, step s2102 proceeds to step s2104, where the user selects a greeting card/email template from the template library which is maintained by the ASP. At step s2106 the user may opt to customize the video greeting card/email, whereby at step s2107 the user selects one or more video objects from the template library, and the application service provider inserts, at step 2108, the selected objects into the already selected video data. When the user has completed customising the electronic greeting card/email, the user enters at step s2109 the destination phone number/address. Subsequently the ASP compresses the data stream at step s2110 and stores it for forwarding to a streaming media server. The process is now complete as indicated at step s2111.

Wireless Local Loop Streaming Video and Animation System

Another application is for wireless access to corporate audio-visual training materials stored on a local server, or for wireless access to audio-visual entertainment such as music videos in domestic environments. One problem encountered in wireless streaming is the low bandwidth capacity of wide area wireless networks and associated high costs. Streaming high quality video uses high link bandwidth, so can be a challenge over wireless networks. An alternate solution to streaming in these circumstances can be to spool the video to be viewed over a typical wide area network connection to a local wireless server or and, once this has been fully or partially received, commence wirelessly streaming the data to the client device over a high capacity local loop or private wireless network.

One embodiment for this application for this is local wireless streaming of music videos. A user downloads a music video from the Internet onto a local computer attached to a wireless domestic network. These music videos can then be streamed to a client device (eg. PDA or wearable computing device) that also has wireless connectivity. A software management system running on the local computer server manages the library of videos, and responds to client user commands from the client device/PDA to control the streaming process.

There are four main components to the server side software management system: a browsing structure creation component; a user interface component; a streaming control component; and a network protocol component. The browsing structure creation component creates the data structures that are used to create a user interface for browsing locally stored videos. In one embodiment, the user may create a number of playlists using the server software; these playlists are then formatted by the user interface component for transmission to the client player. Alternatively, the user may store the video data in a hierarchical file directory structure and the browsing structure component creates the browsing data structure by automatically navigating the directory structure. The user interface component formats browsing data for transmission to the client and receives commands from the client that are relayed to the streaming control component. The user play back controls may include ‘standard’ functions such as play start, pause stop, loop etc. In one embodiment, the user interface component formats the browsing data into HTML, but the user playback controls into a custom format. In this embodiment, the client user interface includes two separate components: a HTML browser handles the browsing functions, while the playback control functions are handled by the video decoder/player. In another embodiment, there is no separation of function in the client software, and the video decoder/player handles all of the user interface functionality itself. In this case, the user interface component formats the browsing data into a custom format understood directly by the video decoder/player.

This application is most suitable for implementation in domestic or corporate applications, for training or entertainment purposes. For example, a technician may use the configuration to obtain audio-visual training materials on how to repair or adjust a faulty device without having to move away from the work area to a computer console in a separate room. Another application is for domestic users to view high quality audio-visual entertainment while lounging outside in their patio. The back channel allows user to select what audio video content they wish to view from a library. The primary advantage is that the video monitor is portable and therefore the user can move freely around the office or home. The video data stream can as previously described contain multiple video objects which can have interactive capabilities. It will be appreciated that this is a significant improvement over known prior art of electronic books and streaming over wireless cellular networks.

Object Oriented Data Format

The object oriented multimedia file format is designed to meet the following goals:
Speed—the files are designed to be rendered at high speed
Simplicity—the format is simple so that parsing is fast and porting is easy. In addition, compositing can be performed by simply appending files together.
Extensibility—The format is a tagged format, so that new packet types can be defined as the players evolve, while maintaining backwards compatibility with older players.
Flexibility—There is a separation of data from its rendering definitions, permitting total flexibility such as changing data rates, and codecs midstream on the fly.

The files are stored in big-endian byte order. The following data types are used:

| Type | Definition |
|---|---|
| BYTE | 8 bits, unsigned char |
| WORD | 16 bits, unsigned short |
| DWORD | 32 bits, unsigned long |
| BYTE[] | String, byte[0] specifies length up to 254, (255 |
| | reserved) |
| IPOINT | 12 bits unsigned, 12 bits unsigned, (x, y) |
| DPOINT | 8 bits unsigned char, 8 bits unsigned char, |
| | (dx, dy) |

The file stream is divided into packets or blocks of data. Each packet is encapsulated within a container similar to the concept of atoms in Quicktime, but is not hierarchical. A container consists of a BaseHeader record that specifies the payload type and some auxiliary packet control information and the size of the data payload. The payload type defines the various kinds of packet in the stream. The one exception to this rule is the SystemControl packet used to perform end-to-end network link management. These packets consist of a BaseHeader with no payload. In this case, the payload size field is reinterpreted. In the case of streaming over circuit switched networks, a preliminary, additional network container is used to achieve error resilience by providing for synchronisation and checksums

There are four main types of packets within the bit stream: data packets, definition packets, control packets and metadata packets of various kinds. Definition packets are used to convey media format and codec information that is used to interpret the data packets. Data packets convey the compressed data to be decoded by the selected application. Hence an appropriate Definition packet precedes any data packets of each given data type. Control packets that define rendering and animation parameters occur after Definition but before Data Packets.

Conceptually, the object oriented data can be considered to consist of 3 main interleaved streams of data. The definition, data, control streams. The metadata is an optional fourth stream. These 3 main streams interact to generate the final audio-visual experience that is presented to a viewer.

All files start with a SceneDefinition block which defines the AV scene space into which any audio or video streams or objects will be rendered. Metadata and directory packets contain additional information about the data contained by the data and definition packets to assist browsing of the data packets. If any metadata blocks exist, they occur immediately after a SceneDefinition packet. A directory packet immediately follows a Metadata packet or a SceneDefinition packet if there is no Metadata packet.

The file format permits integration of diverse media types to support object oriented interaction, both when streaming the data from a remote server or accessing locally stored content. To this end, multiple scenes can be defined and each may contain up to 200 separate media objects simultaneously. These objects may be of a single media type such as video, audio, text or vector graphics, or composites created from combinations of these media types.

As shown in FIG. 4, the file structure defines a hierarchy of entities: a file can contain one of more scenes, each scene may contain one of more objects, and each object can contain one or more frames. In essence, each scene consists of a number of separate interleaved data streams, one for each object each consisting of a number of frames. Each stream is consists of one of more definition packets, followed by data and control packets all bearing the same object_id number.

Stream Syntax

Valid Packet Types

The BaseHeader allows for a total of up to 255 different packet types according to payload. This section defines the packet formats for the valid packet types as listed in the following table.

| Value | DataType | Payload | Comment |
|---|---|---|---|
| 0 | SCENEDEFN | SceneDefinition | Defines scene space properties |
| 1 | VIDEODEFN | VideoDefinition | Defines video format/codec properties |
| 2 | AUDIODEFN | AudioDefinition | Defines audio format/codec properties |
| 3 | TEXTDEFN | TextDefinition | Defines text format/codec properties |
| 4 | GRAFDEFN | GrafDefinition | Defines vector graphics format/codec |
| | | | properties |
| 5 | VIDEOKEY | VideoKey | Video Key Frame data |
| 6 | VIDEODAT | VideoData | Compressed Video data |
| 7 | AUDIODAT | AudioData | Compressed audio data |
| 8 | TEXTDAT | TextData | Text data |
| 9 | GRAFDAT | GrafData | Vector Graphics data |
| 10 | MUSICDAT | Music Data | Music Score Data |
| 11 | OBJCTRL | ObjectControl | Defines object animation/rendering |
| | | | properties |
| 12 | LINKCTRL | — | Used for streaming end to end link |
| | | | management |
| 13 | USERCTRL | UserControl | Back channel for user system interaction |
| 14 | METADATA | MetaData | Contains meta data about AV scene |
| 15 | DIRECTORY | Directory | Directory of data or system objects, |
| 16 | VIDEOENH | — | RESERVED - video enhancement data |
| 17 | AUDIOENH | — | RESERVED - audio enhancement data |
| 18 | VIDEOEXTN | — | Redundant I frames for error correction |
| 19 | VIDEOTERP | Video Data | Discardable Interpolated video files |
| 20 | STREAMEND | — | Indicates end of stream and the start of a |
| | | | new stream |
| 21 | MUSICDEFN | Music Defin | Defines music format |
| 22 | FONTLIB | FontLibDefn | font library data |
| 23 | OBJLIBCTRL | ObjectLibCntrol | object/font library control |
| 255 | — | — | RESERVED |

BaseHeader

Short BaseHeader is for packets that are shorter than 65536 bytes

| Description | Type | Comment |
|---|---|---|
| Type | BYTE | Payload packet type [0], can be definition, data |
| | | or control packet |
| Obj_id | BYTE | Object stream ID - what object does |
| | | this belong to |
| Seq_no | WORD | Frame sequence number, individual |
| | | sequence for each object |
| Length | WORD | Size of frame to follow in bytes {0 means |
| | | end of stream} |

Long BaseHeader will support packets from 64K up to 0xFFFFFFF bytes

| Description | Type | Comment |
|---|---|---|
| Type | BYTE | Payload packet type [0], can be definition, data |
| | | or control packet |
| Obj_id | BYTE | Object stream ID - what object does this |
| | | belong to |
| Seq_no | WORD | Frame sequence number, individual sequence |
| | | for each object |
| Flag | WORD | 0xFFFF |
| Length | DWORD | Size of frame to follow in bytes |

System BaseHeader is for end-to-end network link management

| Description | Type | Comment |
|---|---|---|
| Type | BYTE | DataType = SYSCTRL |
| Obj_id | BYTE | Object stream ID - what object does this |
| | | belong to |
| Seq_no | WORD | Frame sequence number, individual sequence |
| | | for each object |
| Status | WORD | StatusType {ACK, NAK, CONNECT, |
| | | DISCONNECT, IDLE} +object type |

Total size is 6 or 10 bytes

SceneDefinition

| Description | Type | Comment |
|---|---|---|
| Magic | BYTE[4] | ASKY = 0x41534B59 (used for format |
| | | validation) |
| Version | BYTE | Version 0x00 - current |
| Compatible | BYTE | Version 0x00 - current - minimum format |
| | | playable |
| Width | WORD | SceneSpace width (0 = unspecified) |
| Height | WORD | SceneSpace height (0 = unspecified) |
| BackFill | WORD | RESERVED - Scene Fill Style/colour |
| NumObjs | BYTE | How many objects in this scene |
| Mode | BYTE | Frame playout mode bitfield |

Total size is 14 bytes

MetaData

| Description | Type | Comment |
|---|---|---|
| NumItem | WORD | Number of scenes/frames in |
| | | file/scene (0 = unspecified) |
| SceneSize | DWORD | Size in bytes of file/scene/object |
| | | including (0 = unspecified) |
| SceneTime | WORD | Playing time of file/scene/object |
| | | in seconds (0 = unspecified/static) |
| BitRate | WORD | Bit rate of this file/scene/object |
| | | in kbits/sec |
| MetaMask | DWORD | Bit field specifying what optional |
| | | 32 meta data tags follow. |
| Title | BYTE[] | Title of video file/scene - whatever |
| | | you like, byte[0] = length |
| Creator | BYTE[] | Who created this, byte[0] = length |
| Date | BYTE[8] | Creation date in ASCII => DDMMYYYY |
| Copyright | BYTE[] | |
| Rating | BYTE | X, XX, XXX etc |
| EncoderID | BYTE[] | — |
| — | BYTE | — |

Directory

This is an array of type WORD or DWORD. The size is given by the Length field in the BaseHeader packet.

VideoDefinition

| Description | Type | Comment |
|---|---|---|
| Codec | BYTE | Video Codec Type { RAW, QTREE }; |
| Frate | BYTE | Frame rate {0 = stop/pause video play} in |
| | | ⅕ sec |
| Width | WORD | Width Of video frame |
| Height | WORD | Height Of video frame |
| Time | DWORD | Time stamp in 50 ms resolution from start of |
| | | scene (0 = unspecified) |

Total size is 10 bytes

AudioDefinition

| Description | Type | Comment |
|---|---|---|
| Codec | BYTE | Audio Codec Type { RAW, |
| | | G723,, ADPCM } |
| Format | BYTE | Audio Format in bits 7-4, Sample Rate |
| | | in bits 3-0 |
| Fsize | WORD | Samples per frame |
| Time | DWORD | Time stamp in 50 ms resolution from start of |
| | | scene (0 = unspecified) |

Total size is 8 bytes

TextDefinition

| Description | Type | Comment |
|---|---|---|
| Type | BYTE | Type in low nibble {TEXT, HTML, |
| | | etc} compression in |
| | | high nibble |
| Fontinfo | BYTE | Font size in low nibble, Front Style in high |
| | | nibble |
| Colour | WORD | Font colour |
| BackFill | WORD | Background colour |
| Bounds | WORD | Text boundary Box (frame) X in high byte, |
| | | Y in low byte |
| Xpos | WORD | Xpos relative to object origin if defined |
| | | relative to 0, 0 otherwise |
| Ypos | WORD | Xpos relative to object origin if defined |
| | | relative to 0, 0 otherwise |
| Time | DWORD | Time stamp in 50 ms resolution from |
| | | start of scene (0 = unspecified) |

Total size is 16 bytes

GrafDefinition

| Description | Type | Comment |
|---|---|---|
| Xpos | WORD | XPos relative to object origin if defined |
| | | relative to 0, 0 otherwise |
| Ypos | WORD | XPos relative to object origin if defined |
| | | relative to 0, 0 otherwise |
| FrameRate | WORD | Frame delay in 8.8 fps |
| FrameSize | WORD | RESERVED Frame size in twips |
| | | ( 1/20 pel) - used for |
| | | scaling to fit scene space |
| Time | DWORD | Time stamp in 50 ms resolution from start of |
| | | scene |

Total size is 12 bytes

VideoKey, VideoData, AudioData, TextData, GrafData and MusicData

| Description | Type | Comment |
|---|---|---|
| Payload | — | Compressed data |

StreamEnd

| Description | Type | Comment |
|---|---|---|
| StreamObjs | BYTE | How many objects interleaved in the next |
| | | stream |
| StreamMode | BYTE | RESERVED |
| StreamSize | DWORD | Length of next stream in bytes |

Total size is 6 bytes

UserControl

| Description | Type | Comment |
|---|---|---|
| Event | BYTE | User data Type eg. PENDOWN, KEYEVENT, |
| | | PLAYCTRL, |
| Key | BYTE | Parameter 1 = Keycode value/Start/Stop/Pause |
| HiWord | WORD | Parameter 2 = X position |
| LoWord | WORD | Parameter 3 = Y position |
| Time | WORD | Timestamp = sequence number of activated |
| | | object |
| Data | BYTE[ ]* | Optional field for form field data |

Total siz e is 8+ bytes

ObjectControl

| Description | Type | Comment |
|---|---|---|
| ControlMask | BYTE | Bit field defining common object |
| | | controls |
| ControlObject | BYTE | (optional) ID of affected object |
| Timer | WORD | (optional) Top nibble=timer number, |
| | | bottom 12 bits = 100 ms steps |
| ActionMask | WORD\|BYTE | Bit field actions defined in remaining |
| | | payload |
| Params | ... | Parameters for actions defined by |
| | | Action bit field |

ObjLibCtrl

| Description | Type | Comment |
|---|---|---|
| Action | BYTE | What to do with this object |
| | | 1. INSERT - does not overwrite LibID location |
| | | 2. UPDATE - overwrites into LibID location |
| | | 3. PURGE - removes |
| | | 4. QUERY - returns LibID/Version for Unique_ID object |
| LibID | BYTE | Object's index/number in the library |
| Version | BYTE | this object's version number |
| Persist/Expire | BYTE | Does this get garbage collected or does it stick around, 0 = remove |
| | | after session, 1-254 = days before expiry, 255 = persist |
| Access | BYTE | Access control function |
| | | Top 4 bits: Who can overwrite or remove this object, |
| | | 1. any session at will (by LibID) |
| | | 2. system purge/reset |
| | | 3. by knowning the unique ID/libID for object |
| | | 4. never/RESERVED |
| | | Bit 3: Can the user transfer this object to another, |
| | | beaming (1=YES) |
| | | Bit 2: Can the user directly play this from the library |
| | | (Yes = 1/No) |
| | | Bit 1: RESERVED |
| | | Bit 0: RESERVED |
| UniqueID | BYTE[ ] | Unqiue ID/label for this object |
| State | DWORD?? | Where did you get it from/how, many hops, feeding time |
| | ?? | else it dies |
| | | 1. Hop count |
| | | 2. Source (SkyMail, SkyFile, SkyServer) |
| | | 3. time since activation |
| | | 4. # Activations |

Semantics
BaseHeader

This is the container for all information packets in the stream.

Type—BYTE

Description—Specifies the type of payload in packet as defined above
Valid Values: enumerated 0-255, see Payload type table below
   Obj_id—BYTE
Description—Object ID—defines scope—what object does this packet belong to. Also defines the Z-order in steps of 255, that increases towards the viewer. Up to four different media types can share the same obj_id.
Valid Values: 0—NumObjs (max 200) NumObjs defined in SceneDefinition
   201-253: Reserved for system use
   250: Object Library
   251: RESERVED
   252: Directory of Streams
   253: Directory of Scenes
   254: This Scene
   255: This File
      Seq_no—WORD
Description—Frame sequence number, individual sequence for each media type within an object. Sequence number are restarted after each new SceneDefinition packet.
Valid Values: 0-0xFFFF
   Flag (optional)—WORD
Description—Used to indicate long baseheader packet.
Valid Values: 0xFFFF
   Length—WORD/DWORD
Used to indicate payload length in bytes, (if flag set packet size=length+0xFFFF).
Valid Values: 0x0001-0xFFF, If flag is set 0x00000001-0xFFFFFFFF ( )
   0—RESERVED for Endof File/Stream 0xFFFF
      Status—WORD
Used with SysControl DataType flag, for end to end link management.

Valid Values: enumerated 0-65535

| Value | Type | Comment |
|---|---|---|
| 0 | ACK | Acknowledge packet with given obj_id and |
| | | seq_no |
| 1 | NAK | Flag error on packet with given obj_id and |
| | | seq_no |
| 2 | CONNECT | Establish client/server connection |
| 3 | DISCONNECT | Break client/server connection |
| 4 | IDLE | Link is idle |
| 5-65535 | — | RESERVED |

SceneDefinition

This defines the properties of the AV scene space into which the video and audio objects will be played.

Magic—BYTE[4]

Description—used for format validation,
Valid Value: ASKY=0x41534B59
   Version—BYTE
Description—used for stream format validation
Valid Range: 0-255 (current=0)
   Compatible—BYTE
Description—what is the minimum player that can read this format
Valid Range: 0—Version
   Width—WORD
Description—SceneSpace width in pixels
Valid Range: 0x0000-0xFFFF
   Height—WORD
Description—SceneSpace height in pixels
Valid Range: 0x0000-0xFFFF
   BackFill—(RESERVED) WORD
Description—background scene fill (bitmap, solid colour, gradient)
Valid Range: 0x1000-0xFFFF solid colour in 15 bit format else the low order BYTE defines the object id for a vector object and the high order BYTE (0-15) is an index to gradient fill style table. This vector object definition occurs prior to any data control packets
   NumObjs—BYTE
Description—how many data objects are in this scene
Valid Range: 0-200 (201-255 reserved for system objects)
   Mode—BYTE

Description—Frame playout mode bitfield

Bit: [7] play status - paused = 1, play = 0 // continuous play or step through

| | |
|---|---|
| Bit: [6] RESERVED Zooming - prefer = 1, normal = 0 | // play zoomed |
| Bit: [5] RESERVED - data storage - live = 1, stored = 0 | // being streamed ? |
| Bit: [4] RESERVED streaming - reliable = 1, best try = 0 | // is streaming reliable |
| Bit: [3] RESERVED data source - video = 1, thinclient = 0 | // originating source |
| Bit: [2] RESERVED Interaction - allow = 1, disallow = 0 | |
| Bit: [1] RESERVED | |

Bit: [0] Library Scene - is this a library scene 1 = yes, 0 = no

MetaData

This specifies metadata associated with either an entire file, scene or an individual AV object. Since files can be concatenated, there is no guarantee that a metadata block with file scope is valid past the last scene it specifies. Simply comparing the file size with the SCENESIZE field in this Metadata packet however can validate this.

The OBJ_ID field in baseHeader defines the scope of a metadata packet. This scope can be the entire file (255), a single scene (254), or an individual video object (0-200). Hence if MetaData packets are present in a file they occur in flocks (packs?) immediately following SceneDefinition packets.

NumItem—WORD

Description—Number of scenes/frames in file/scene,
For scene scope NumItem contains the number of frames for video object with obj_id=0
Valid Range: 0-65535 (0=unspecified)
   SceneSize—DWORD
Description—Self inclusive size in bytes of file/scene/object including,
Valid Range: 0x0000-0xFFFFFFFF (0=unspecified)
   SceneTime—WORD
Description—Playing time of file/scene/object in seconds,
Valid Range: 0x0000-0xFFFF (0=unspecified)
   BitRate—WORD
Description—bit rate of this file/scene/object in kbits/sec,
Valid Range: 0x0000-0xFFFF (0=unspecified)
   MetaMask—(RESERVED) DWORD
Description—Bit field specifying what optional 32 meta data fields follow in order,
Bit Value [31]: Title
Bit Value [30]: Creator
Bit Value [29]: Creation Date
Bit Value [28]: Copyright
Bit Value [27]: Rating
Bit Value [26]: EncoderID
Bit Value [26-27]: RESERVED
   Title—(Optional) BYTE[ ]
Description—String of up to 254 chars
   Creator—(Optional) BYTE[ ]
Description—String of up to 254 chars
   Date—(Optional) BYTE[8]
Description—Creation date in ASCII=>DDMMYYYY
   Copyright—(Optional) BYTE[ ]
Description—String of up to 254 chars
   Rating—(Optional) BYTE
Description—BYTE specifying 0-255
   Directory

This specifies directory information for an entire file or for a scene. Since the files can be concatenated, there is no guarantee that a metadata block with file scope is valid past the last scene it specifies. Simply comparing the file size with the SCENESIZE field in a Metadata packet however can validate this.

The OBJ_ID field in baseHeader defines the scope of a directory packet. If the value of the OBJ_ID field is less than 200 then the directory is a listing of sequence numbers (WORD) for keyframes in a video data object. Else, the directory is a location table of system objects. In this case the table entries are relative offset in bytes (DWORD) from the start of the file (for directories of scenes and directories) or scene for other system objects). The number of entries in the table and the table size can be calculated from the LENGTH field in the BaseHeader packet.

Similar to MetaData packets if Directory packets are present in a file they occur in flocks (packs?) immediately following SceneDefinition, or Metadata packets.

VideoDefinition

Codec—BYTE

Description—Compression Type

Valid Values: enumerated 0-255

| Value | Codec | Comment |
|---|---|---|
| 0 | RAW | Uncompressed, the first byte defines colour depth |
| 1 | QTREE | Default Video codec |
| 2-255 | — | RESERVED |

Frate—BYTE
Description—frame playout rate in ⅕ sec (ie max=51 fps, min=0.2 fps)
Valid Values: 1-255, play/start playing if stopped
   0—stop playing
      Width—WORD
Description—how wide in pixels in video frame
Valid Values: 0-65535
   Height—WORD
Description—how high in pixels in video frame
Valid Values: 0-65535
   Times—WORD
Description—Time stamp in 50 ms resolution from start of scene (0=unspecified)
Valid Values: 1-0xFFFFFFFF (0=unspecified)
   AudioDefinition
   Codec—BYTE
Description—Compression Type

Valid Values: enumerated 1 (0=unspecified)

| Value | Codec | Comment |
|---|---|---|
| 0 | WAV | Uncompressed |
| 1 | G723 | Default Video codec |
| 2 | IMA | Interactive Multimedia Association ADPCM |
| 3-255 | — | RESERVED |

Format—Byte
Description—This BYTE is split into 2 separate fields that are independently defined. The top 4 bits define the audio format (Format>>4) while the bottom 4 bits separate define the sample rate (Format & 0x0F).

Low 4 Bits, Value: enumerated 0-15, Sampling Rate

| Value | Samp.Rate | Comment |
|---|---|---|
| 0 | 0 | 0 - stop playing |
| 1 | 5.5 kHz | 5.5 kHz Very low rate sampling, start playing if |
| | | stopped |
| 2 | 8 kHz | Standard 8000 Hz Sampling, start playing if stopped |
| 3 | 11 kHz | Standard 11025 Hz Sampling, start playing if stopped |
| 4 | 16 kHz | 2x 8000 Hz Sampling, start playing if stopped |
| 5 | 22 kHz | Standard 22050 Hz Sampling, start playing if stopped |
| 6 | 32 kHz | 4x 8000 Hz Sampling, start playing if stopped |
| 7 | 44 kHz | Standard 44100 Hz Sampling, start playing if stopped |
| 8-15 | | RESERVED |

Bits 4-5, Value enumerated 0-3, Format

| Value | Format | Comment |
|---|---|---|
| 0 | MONO8 | Monophonic, 8 bits per sample |
| 1 | MONO16 | Monophonic, 16 bits per sample |
| 2 | STEREO8 | Stereophonic, 8 bits per sample |
| 3 | STEREO16 | Stereophonic, 16 bits per sample |

High 2 Bits (6-7), Value: enumerated 0-3, Special

| Codec | Comment |
|---|---|
| WAV | RESERVED (unused) |
| G.723 | RESERVED (unused) |
| IMA | Bits Per Sample (Value +2) |

Fsize—WORD
Description—samples per frame
Valid Values: 0-65535
   Times—WORD
Description—Time stamp in 50 ms resolution from start of scene (0=unspecified)
Valid Values: 1-0xFFFFFFFF (0=unspecified)
   TextDefinition

We need to include writing direction, it can be LRTB, or RLTB or TBRL or TBLR. This can be done by using a special letter code in the body of the text to indicate the direction, for example we could use DC1-DC4 (ASCII device control codes 17-20) for this task. We also need to have a font table downloaded at the start with bitmap fonts. Depending on the platform the player is running on the renderer may either ignore the bitmap fonts or attempt to use the bitmap fonts for rendering the text. If there is no bit map font table or if it being ignored by the player then the rendering system will automatically attempt to use the Operating System text output functions to render the text.

Type—BYTE

Description—Defines how text data is interpreted in low nibble (Type & 0x0F) and compression method in high nibble (Type>>4)

Low 4 Bits, Value: enumerated 0-15, Type—interpretation

| Value | Type | Comment |
|---|---|---|
| 0 | PLAIN | Plain text - no interpretation |
| 1 | TABLE | RESERVED - table data |
| 2 | FORM | Form/Text Field for user input |
| 3 | WML | RESERVED WAP - WML |
| 4 | HTML | RESERVED HTML |
| 5-15 | — | RESERVED |

High 4 Bit, Value: enumerated 0-15, compression method

| Value | Codec | Comment |
|---|---|---|
| 0 | NONE | Uncompressed 8 bit ASCII codes |
| 1 | TEXT7 | RESERVED - 7 Bit Character codes |
| 2 | HUFF4 | RESERVED - 4 bit Huffman coded ASCII |
| 3 | HUFF8 | RESERVED - 8 bit Huffman coded ASCII |
| 4 | LZW | RESERVED - Lepel-Zev-Welsh coded ASCII |
| 5 | ARITH | RESERVED - Arithmetic coded ASCII |
| 6-15 | — | RESERVED |

FontInfo—BYTE
Description—Size in low nibble (FontInfo & 0x0F) Style in high nibble (FontInfo>>4). This field is ignored if the Type is WML or HTML.
Low 4 Bits Value: 0-15 FontSize
High 4 Bit Values: enumerated 0-15, FontSyle
   Colour—WORD
Description—Textface colour
Valid Values: 0x0000-0xEFFF, colour in 15 bit RGB (R5,G5,B5)
   0x8000-0x80FF, colour as index into VideoData LUT (0x80FF transparent)
   0x8100-0xFFFF RESERVED
      BackFill—WORD
Description—Background colour
Valid Values: 0x0000-0xEFFF, colour in 15 bit RGB (R5,G5,B5)
   0x8000-0x80FF, colour as index into VideoData LUT (0x80FF=transparent)
   0x8100-0xFFFF RESERVED
      Bounds—WORD
Description—Text boundary box (frame) in character units, Width in the LoByte (Bounds & 0x0F) and height in the HiByte (Bounds>>4). The text will be wrapped using the width and clipped for the height.
Valid Values: width=1-255, height=1-255,
   width=0—no wrapping performed,
   height=0—no clipping performed
      Xpos—WORD
Description—pos relative to object origin if defined else relative to 0,0 otherwise
   Valid Values: 0x0000-0xFFFF
   Ypos—WORD
Description—pos relative to object origin if defined else relative to 0,0 otherwise
Valid Values: 0x0000-0xFFFF

NOTE: Colours in the range of 0x80F0-0x80FF are not valid colour indexes into VideoData LUTs since they only support up to 240 colours. Hence they are interpreted as per the following table. These colours should be mapped into the specific device/OS system colours as best possible according to the table. In the standard Palm OS UI only 8 colours are used and some of these colours are similar to the other platforms but not identical, this is indicated with an asterix. The missing 8 colours will have to be set by the application.

GrafDefinition

This packet contains the basic animation parameters. The actual graphic object definitions are contained in the GrafData packets, and the animation control in the objControl packets.

Xpos—WORD

Description—XPos relative to object origin if defined relative to 0,0 otherwise
Valid Values:
   Ypos—WORD
Description—XPos relative to object origin if defined relative to 0,0 otherwise
Valid Values:
   FrameRate—WORD
Description—Frame delay in 8.8 fps
Valid Values:
   FrameSize—WORD
Description—Frame size in twips ( 1/20 pel)—used for scaling to fit scene space
Valid Values:
   FrameCount—WORD
Description—How many frames in this animation
Valid Values:
   Time—DWORD
Description—Time stamp in 50 ms resolution from start of scene
Valid Values:
   VideoKey, VideoData, VideoTrp and AudioData

These packets contain codec specific compressed data. These packets contain codec specific compressed data.

Buffer sizes should be determined from the information conveyed in the VideoDefn and AudioDefn packets. Beyond the TypeTag VideoKey packets are similar to VideoData packets, differing only in their ability to encode transparency regions—VideoKey frames have no transparency regions. The distinction in type definition makes keyframes visible at the file parsing level to facilitate browsing. VideoKey packets are an integral component of a sequence of VideoData packets; they are typically interspersed among them as part of the same packet sequence. VideoTrp packets represent frames that are non-essential to the video stream, thus they may be discarded by the Sky decoding engine.

TextData

Textdata packets contain the ASCII character codes for text to be rendered. Whatever Serif system font are available one the client device should be used to render these fonts. Serif fonts are to be used since proportional fonts require additional processing to render. In the case where the specified Serif system font style is not available, then the closest matching available font should be used.

Plain text is rendered directly without any interpretation. White space characters other than LF (new line) characters and spaces and other special codes for tables and forms as specified below are totally ignored and skipped over. All text is clipped at scene boundaries.

The bounds box defines how text wrapping functions. The text will be wrapped using the width and clipped if it exceeds the height. If the bounds width is 0 then no wrapping occurs. If the height is 0 then no clipping occurs.

Table data is treated similarly as Plain text with the exception of LF that is used to denote end of rows and the CR character that is used to denote columns breaks.

WML and HTML is interpreted according to their respective standards, and the font style specified in this format is ignored. Images are not supported in WML and HTML.

To obtain streaming text data new TextData packets are sent to update the relevant object. Also in normal text animation the rendering of TextData can be defined using ObjectControl packets.

GrafData

This packet contains all of the graphic shape and style definitions used for the graphics animation. This is a very simple animation data type. Each shape is defined by a path, some attributes and a drawing style. One graphic object may be composed of an array of paths in any one GraphData packet. Animation of this graphic object can occur by clearing or replacing individual shape records array entires in the next frame, adding new records to the array can also be performed using the CLEAR and SKIP path types.

GraphData Packet

| Description | Type | Comment |
|---|---|---|
| NumShapes | BYTE | Number of shape records to follow |
| Primitives | SHAPERecord[ ] | Array of Shape Definitions |

ShapeRecord

| Description | Type | Comment |
|---|---|---|
| Path | BYTE | Sets the path of the shape + DELETE |
| | | operation |
| Style | BYTE | Defines how path is interpreted and rendered |
| Offset | IPOINT | |
| Vertices | DPOINT[ ] | Length of array given in Path low nibble |
| FillColour | WORD[ ] | Number of entries depend on fill style |
| | | and # vertices |
| LineColour | WORD | Optional field determined by style field |

Path—BYTE
Description—Sets the path of the shape in the high nibble and the # vertices in low nibble
Low-4 Bits Value: 0-15: number of vertices in poly paths

High 4 Bits Value: ENUMERATED: 0-15 defines the path shape

| Value | Path | Comment |
|---|---|---|
| 0 | CLEAR | Deletes SHAPERECORD definition from array |
| 1 | SKIP | Skips this SHAPERECORD in the array |
| 2 | RECT | Description - topleft corner, bottom right corner |
| | | Valid Values: (0 . . . 4096, 0 . . . 4096), [0 . . . 255, |
| | | 0 . . . 255] . . . |
| 3 | POLY | Description - # points, initial xy value, |
| | | array of relative pt coords |
| | | Valid Values: 0 . . . 255, (0 . . . 4096, 0 . . . 4096), |
| | | [0 . . . 255, 0 . . . 255] . . . |
| 4 | ELLIPSE | Description - centre coord, major axis radius, minor |
| | | axis radius |
| | | Valid Values: (0 . . . 4096, 0 . . . 4096), 0 . . . 255, |
| | | 0 . . . 255 |
| 5-15 | | RESERVED |

Style—BYTE
Description—Defines how path is interpreted
Low 4 Bits Value: 0-15 line thickness
High 4 Bits: BITFIELD: path rendering parameters. The default is not draw the shape at all so that it operates as an invisible hot region.
Bit [4]: CLOSED—If bit set then path is closed
Bit [5]: FILLFLAT—Default is no fill—if both fills then do nothing
Bit [6]: FILLSHADE—Default is no fill—if both fills then do nothing
Bit [7]: LINECOLOR—Default is no outline
   UserControl

These are used to control the user-system and user-object interaction events. They are used as a back channel to return user interaction back to a server to effect server side control. However if the file is not being streamed these user interactions are handled locally by the client. A number of actions can be defined for user-object control in each packet. The following actions are defined in this version. The user-object interactions need not be specified except to notify the server that one has occurred since the server knows what actions are valid.

| User-system interactions | User-Object interactions |
|---|---|
| Pen events (up, down, | Set 2D position, visibility (self, other) |
| move, dblclick) | |
| Keyboard events | Play/Pause system control |
| Play control (play, pause, | Hyperlink - Goto # (Scene, frame, label, |
| frame advance, stop) | URL) |
| Return Form Data | Hyperlink - Goto next/prev, (scene, frame) |
| | Hyperlink - Replace object (self, other) |
| | Hyperlink - Server Defined |

The user-object interaction depends on what actions are defined for each object when they are clicked on by the user. The player may know these actions through the medium of ObjectControl messages. If it does not, then they are forwarded to an online server for processing. With user-object interaction the identification of the relevant object is indicated in the BaseHeader obj-id field. This applies to OBJCTRL and FORMDATA event types. For user-system interaction the value of the obj-id field is 255. The Event type in UserControl packets specifies the interpretation of the key, HiWord and LoWord data fields.

Event—BYTE

Description—User Event Type

Valid Values: enumerated 0-255

| Value | Event Type | Comment |
|---|---|---|
| 0 | PENDOWN | User has put pen down on touch screen |
| 1 | PENUP | User has lifted pen up from touch screen |
| 2 | PENMOVE | User is dragging pen across touch screen |
| 3 | PENDBLCLK | User has double clicked touch screen with pen |
| 4 | KEYDOWN | User has pressed a key |
| 5 | KEYUP | User has pressed a key |
| 6 | PLAYCTRL | User has activated a play/pause/stop control |
| | | button |
| 7 | OBJCTRL | User has clicked/activated an AV object |
| 8 | FORMDATA | User is returning form data |
| 9-255 | — | RESERVED |

Key, HiWord and LoWord—BYTE, WORD, WORD
Description—parameter data for different event types

Valid Values: The interpretation of these fields is as follows

| Event | Key | HiWord | LoWord |
|---|---|---|---|
| PENDOWN | Key code if key held down | X position | Y position |
| PENUP | Key code if key held down | X position | Y position |
| PENMOVE | Key code if key held down | X position | Y position |
| PENDBLCLK | Key code if key held down | X position | Y position |
| KEYDOWN | Key code | Unicode Key code | 2^{nd} key held down |
| KEYUP | Key code | Unicode Key code | 2^{nd} key held down |
| PLAYCTRL | Stop = 0, Start = 1, pause = 2 | RESERVED | RESERVED |
| OBJCTRL | Pen Event ID | Keycode if key | RESERVED |
| | | held down | |
| FORMDATA | RESERVED | Length of data field | RESERVED |

Time—WORD
Description—Time of user event=sequence number of activated object
Valid Values: 0-0xFFFF
   Data—(RESERVED—OPTIONAL)
Description—Text strings from form object
Valid Values: 0. . . 65535 bytes in length

Note: In the case of the PLAYCTRL events that pausing repeatedly when play is already paused should invoke a frame advance response from the server. Stopping should reset play to the start of the file/stream.

ObjectControl

ObjectControl packets are used to define the object-scene and system-scene interaction. They also specifically define how objects are rendered and how scenes are played out. A new OBJCTRL packet is used for each frame to coordinate individual object layout. A number of actions can be defined for an object in each packet. The following actions are defined in this version

| Object-system actions | System-scene actions |
|---|---|
| Set 2D/3D position | Goto # (Scene, frame, label, URL) |
| Set 3D Rotation | Goto next, previous, (scene, frame) |
| Set scale/size factor | Play/Pause |
| Set visibility | Mute audio |
| Set label/title (for use as in | IF (scene, frame, object) THEN DO |
| tool tips) | (action) |
| Set background colour | |
| (nil = transparent) | |
| Set tweening value | |
| (for animations) | |
| Begin/end/duration/repeat (loop) | |
| implicit | |

ControlMask—BYTE
   Description—Bit field—The control mask defines controls common to Object level and System level operations. Following the ControlMask is an optional parameter indicating the object id of the affected object. If there is no affected object ID specified then the affected object id is the object id of the base header. The type of ActionMask (object or system scope) following the ControlMask is determined by the affected object id.
      Bit: [7] CONDITION—What is needed to perform these actions
      Bit: [6] BACKCOLR—Set colour of object background
      Bit: [5] PROTECT—limit user modification of scene objects
      Bit: [4] JUMPTO—replace the source stream for an object with another
      Bit: [3] HYPERLINK—sets hyperlink target
      Bit: [2] OTHER—object id of the affected object will follow (255=system)
      Bit: [1] SETTIMER—Set a timer and start counting down
      Bit: [0] EXTEND—RESERVED for future expansion
ControlObject—BYTE (Optional)
   Description: Object ID of affected object. Is included if bit 2 of ControlMask is set.
   Valid values: 0-255
Timer—WORD (Optional)
   Description: Top nibble=timer number, bottom 12 bits=time setting
   Top nibble, valid values: 0-15 timer number for this object.
   Bottom 12 bits valid range: 0-4096 time setting in 100 ms steps
ActionMask [OBJECT scope]—WORD
   Description—Bit field—This defines what actions are specified in this record and the parameters to follow. There are two versions of this one for object the other for system scope. This field defines actions that apply to media objects.
   Valid Values: For objects each one of the 16 bits in the ActionMask identifies an action to be taken. If a bit is set, then additional associated parameter values follow this field.
      Bit: [15] BEHAVIOR—indicates that this action and conditions remain with the object even after the actions have been executed
      Bit: [14] ANIMATE—multiple control points defining path will follow
      Bit: [13] MOVETO—set screen position
      Bit: [12] ZORDER—set depth
      Bit: [11] ROTATE—3D Orientation
      Bit: [10] ALPHA—Transparency
      Bit: [9] SCALE—Scale/size
      Bit: [8] VOLUME—set loundness
      Bit: [7] FORECOLR—set/change foreground colour
      Bit: [6] CTRLLOOP—repeat the next # actions (if set else ENDLOOP)
      Bit: [5] ENDLOOP—if looping control/animation then break it
      Bit: [4] BUTTON—define penDown image for button
      Bit: [3] COPYFRAME—copies the frame from object into this object (checkbox)
      Bit: [2] CLEAR_WAITING_ACTIONS—clears waiting actions
Bit: [1] OBJECT_MAPPING—specifies the object mapping between streams
Bit: [0] ACTIONEXTEND—Extended Action Mask follows
ActionExtend [OBJECT scope]—WORD
   Description—Bit field—RESERVED
ActionMask [SYSTEM scope]—BYTE
   Description—Bit field—This defines what actions are specified in this record and the parameters to follow. There are two versions of this one for object the other for system scope. This field defines actions that have scene wide scope.
   Valid Values: For systems each one of the 16 bits in the ActionMask identifies an action to be taken. If a bit is set then additional associated parameter values follow this field
      Bit: [7] PAUSEPLAY—if playing pause indefinitively
      Bit: [6] SNDMUTE—if sounding then mute if muted then sound
      Bit: [5] SETFLAG—Sets user assignable system flag value
      Bit: [4] MAKECALL—change/open the physical channel
      Bits: [3] SENDDTMF—Send DTMF tones on voice call
      Bits: [2-0]—RESERVED
Params—BYTE array
   Description—Byte array. Most of the actions defined in the above bit fields use additional parameters. The parameters used as indicated by the bit field value being set are specified here in the same order as the bit field from top (15) to bottom (0) and order of masks, ActionMask then [Object/System] Mask (except for the affected object id which has already been specified between the two). These parameters may include optional fields, these are shown as yellow rows in the tables below.

CONDITION bit—Consists of one or more state records chained together, each record can also have an optional frame number field after it. The conditions within each record are logically ANDed together. For greater flexibility additional records can be chained through bit 0 to create logical OR conditions. In addition to this, multiple, distinct definition records may exist for any one object creating multiple conditional control paths for each object.

| Param | Type | Comment |
|---|---|---|
| State | WORD | What is needed to perform these actions, bit-field (logically ANDed) |

| | |
|---|---|
| Bit: [15] playing | // continuous playing |
| Bit: [14] paused | // playing is paused |
| Bit: [13] stream | // streaming from remote server |
| Bit: [12] stored | // playing from local storage |
| Bit: [11] buffered | // is object frame # buffered? (true |
| if stored) | |
| Bit: [10] overlap | // what object do we need to be |
| dropped on? | |
| Bit: [9] event | // what user event needs to be |
| happening | |
| Bit: [8] wait | // do we wait for conditions to |
| become true | |
| Bit: [7] userflags | // tests user flags which follow |
| Bit: [6] TimeUp | // Timer has expired |
| Bit: [5-1] | RESERVED |
| Bit: [0] OrState | // OrState condition record follow |

| | | |
|---|---|---|
| Frame | WORD | (optional) frame number for bit 11 condition |
| Object | BYTE | (optional) object ID for bit 10 condition, invisible objects can be used |
| Event | WORD | High BYTE: the event field from the UserControl Packet |
| | | Low BYTE: the key field from the UserControl Packet, |
| | | 0xFF ignore keys, 0x00 no key being pressed |
| User | DWORD | High WORD: mask indicating which flags to check |
| flags | | Low WORD: mask indicating the values of user flags |
| | | (set or not set) |
| TimeUp | BYTE | High nibble: RESERVED |
| | | Low nibble: timer id number (0-15) |
| State | WORD | Same bit field as the previous state field, but is logically |
| | | ORed with it |
| . . . | WORD | . . . |

ANIMATE bit set—If the animate bit is set the animation parameters follow specifying the times and interpolation of the animation. The animate bit also affects the number of MOVETO, ZORDER, ROTATE, ALPHA, SCALE, and VOLUME parameters that exist in this control. Multiple values will occur for each parameter, one value for each control point.

| Param | Type | Comment |
|---|---|---|
| AnimCtrl | BYTE | High nibble: Number of control points − 1 |
| | | Low nibble: path control |
| | | Bit [3]: Looping Animation |
| | | Bit [2]: RESERVED |
| | | Bits [1 . . . 0]: enum, Path type - {0: linear, 1: |
| | | Quadratic, 2: Cubic} |
| Start time | WORD | Start time of animation, from scene start or |
| | | condition in 50 ms steps |
| Durations | WORD[ ] | Array of durations in 50 ms increments, |
| | | length = control points − 1 |

MOVETO bit set

| Param | Type | Comment |
|---|---|---|
| Xpos | WORD | X position to move to, relative to current pos |
| Ypos | WORD | Y position to move to, relative to current pos |

ZORDER bit set

| Param | Type | Comment |
|---|---|---|
| Depth | WORD | Depth increases away from viewer, values |
| | | of 0, 256, 512, 768 etc reserved |

ROTATE bit set

| Param | Type | Comment |
|---|---|---|
| Xrot | BYTE | X axis rotation, absolute in degrees * 255/360, |
| Yrot | BYTE | Y axis rotation, absolute in degrees * 255/360 |
| Zrot | BYTE | Z axis rotation, absolute in degrees * 255/360 |

ALPHA bit set

| Param | Type | Comment |
|---|---|---|
| alpha | BYTE | Transparency 0 = transparent, 255 = fully opaque |

SCALE bit set

| Param | Type | Comment |
|---|---|---|
| scale | WORD | Size/Scale in 8.8 fixed int format |

VOLUME bit set

| Param | Type | Comment |
|---|---|---|
| vol | BYTE | Sound volume 0 = softest, 255 = loudest |

BACKCOLR bit set

| Param | Type | Comment |
|---|---|---|
| fillcolr | WORD | Same format as SceneDefinition Backcolor (nil = |
| | | transparent) |

PROTECT bit set

| Param | Type | Comment | |
|---|---|---|---|
| Protect | BYTE | limit user modification of scene objects bit field, | |
| | | bit set = disabled | |
| | | Bit: [7] move | // prohibit moving objects |
| | | Bit: [6] alpha | // prohibit changing alpha value |
| | | Bit: [5] depth | // prohibit changing depth value |
| | | Bit: [4] clicks | // disable click through behaviour |
| | | Bit: [3] drag | // disable dragging of objects |
| | | Bit: [2..0] | // RESERVED |

CTRLLOOP bit set

| Param | Type | Comment |
|---|---|---|
| Repeat | BYTE | Repeat the next # actions for this object - clicking |
| | | on object to break loop |

SETFLAG bit set

| Param | Type | Comment |
|---|---|---|
| Flag | BYTE | Top nibble = flag number, bottom nibble if true |
| | | set flag else reset flag, |

HYPERLINK bit set

| Param | Type | Comment |
|---|---|---|
| hLink | BYTE[ ] | Sets hyperlink target URL for click |
| | | through |

JUMPTO bit set

| Param | Type | Comment |
|---|---|---|
| scene | BYTE | Goto scene # if value = 0xFF goto |
| | | hyperlink (250 = library) |
| stream | BYTE | [optional] Stream # if value = 0 then |
| | | read optional object id |
| object | BYTE | [optional] object id # |

BUTTON bit set

| Param | Type | Comment |
|---|---|---|
| scene | BYTE | scene # (250 = library) |
| stream | BYTE | Stream # if value = 0 then read optional object id |
| object | BYTE | [optional] object id # |

COPYFRAME bit set

| Param | Type | Comment |
|---|---|---|
| object | BYTE | Frame will be copied from the object with this id |

OBJECTMAPPING bit set—when an object jumps to another stream the stream may use different object ids to the current scene. Hence an object mapping is specified in the same packet containing a JUMPTO command.

| Param | Type | Comment |
|---|---|---|
| Objects | BYTE | Number of objects to be mapped |
| Mapping | WORD[ ] | Array of words, length = objects |
| | | High BYTE: object id being used in the stream |
| | | we are jumping to |
| | | Low BYTE: object id of the current scene which |
| | | the new object ids will be mapped to. |

MAKECALL bit set

| Param | Type | Comment |
|---|---|---|
| channel | DWORD | Phone number of new channel |

SENDDTMF bit set

| Param | Type | Comment |
|---|---|---|
| DTMF | BYTE[ ] | DTMF string to be sent on channel |

Notes:
There are no parameters for the PAUSEPLAY and SNDMUTE actions as these are binary flags.
Button states can be created by having an extra image object that is set to be initially transparent. When the user clicks down on the button object, this is then replaced with the invisible object that is set to visible using the button behaviour field and reverts to the original state when the pen is lifted.
   ObjLibControl

ObjLibCtrl packets are used to control the persistent local object library that the player maintains. In one sense the local object library may be considered to store resources. A total of 200 user objects and 55 system objects can be stored in each library. During playback the object library can be directly addressed by using object_id=250 for the scene. The object library is very powerful and unlike the font library supports both persistence and automatic garbarge collection.

The Objects are inserted into the object library through a combination of ObjLibCtrl packets and SceneDefn packets which have the ObjLibrary bit set in the Mode bit field [bit 0]. Setting this bit in the SceneDefli packet tells the player that the data to follow is not to be played out directly but is to be used to populate the object library. The actual object data for the library is not packaged in any special manner it still consists of definition packets and data packets. The difference is that there is now an associated ObjLibCtrl packet for each object that instructs the player what to do with the object data in the scene. Each ObjLibCtrl packet contains management information for the object with the same obj_id in the base header. A special case of ObjLibCtrl packets are those that have object_id in the base header set to 250. These are used to convey library system management commands to the player.

The present invention described herein may be conveniently implemented using a conventional general purpose digital computer or microprocessor programmed according to the teachings of the present specification, as will be apparent to those skilled in the computer art. Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art. It is to be noted that this invention not only includes the encoding processes and systems disclosed herein, but also includes corresponding decoding systems and processes which may be implemented to operate to decode the encoded bit streams or files generated by the encoders in basically the opposite order of encoding, eluding certain encoding specific steps.

The present invention includes a computer program product or article of manufacture which is a storage medium including instructions which can be used to program a computer or computerized device to perform a process of the invention. The storage medium can include, but is not limited to, any type of disk including floppy disks, optical discs, CD-ROMs, and magneto-optical disks, ROMs, RAMs, EPROMs, EEPROMs, magnetic or optical cards, or any type of media suitable for storing electronic instructions. The invention also includes the data or signal generated by the encoding process of the invention. This data or signal may be in the form of an electromagnetic wave or stored in a suitable storage medium.

Many modifications will be apparent to those skilled in the art without departing from the spirit and scope of the present invention as herein described

1. A method of generating an object oriented interactive multimedia file, including:
encoding data comprising at least one of video, text, audio, music and/or graphics elements as a video packet stream, text packet stream, audio packet stream, music packet stream and/or graphics packet stream respectively;
combining said packet streams into a single self-contained object, said object containing its own control information;
placing a plurality of said objects in a data stream; and
grouping one or more of said data streams in a single contiguous self-contained scene, said scene including format definition as the initial packet in a sequence of packets.

2. A method of generating an interactive multimedia file according to claim 1, including combining one or more of said scenes.

3. A method of generating an interactive multimedia file according to claim 1 wherein a single scene contains an object library.

4. A method of generating an interactive multimedia file according to claim 1 wherein data for configuring customisable decompression transforms is included within said objects.

5. A method of generating an interactive object oriented multimedia file according to claim 1 wherein object control data is attached to objects which are interleaved into a video bit stream, and said object control data controls interaction behaviour, rendering parameters, composition, and interpretation of compressed data.

6. A method of generating an interactive object oriented multimedia file according to claim 1 comprising a hierarchical directory structure wherein first level directory data comprising scene information is included with the first said scene, second level directory data comprising stream information is included with one or more of said scenes, and wherein third level directory data comprising information identifying the location of intra-frames is included in said data stream.

7. A method of generating an object oriented interactive multimedia file, including:
encoding data comprising at least one of video and audio elements as a video packet stream and audio packet stream respectively;
combining said packet streams into a single self-contained object;
placing said object in a data stream;
placing said stream in a single contiguous self-contained scene, said scene including format definition; and
combining a plurality of said scenes.

8. A method of generating an interactive object oriented multimedia file according to claim 1, wherein said object control data takes the form of messages encapsulated within object control packets and represents parameters for rendering video and graphics objects, for defining the interactive behaviour of said objects, for creating hyperlinks to and from said objects, for defining animation paths for said objects, for defining dynamic media composition parameters, for assigning values to user variables, for redirecting or retargeting the consequences of interactions with objects and other controls from one object to another, for attaching executable behaviours to objects, including voice calls and starting and stop timers, and for defining conditions for the execution of control actions.

9. A method of generating an interactive object oriented multimedia file according to claim 7, wherein said rendering parameters represent object transparency, scale, volume, position, z-order, background colour and rotation, where said animation paths affect any of said rendering parameters, said hyperlinks support non-linear video and links to other video files, individual scenes within a file, and other object streams within a scene as targets, said interactive behaviour data includes the pausing of play and looping play, returning user information back to the server, activating or deactivating object animations, defining menus, and simple forms that can register user selections.

10. A method of generating an interactive object oriented multimedia file according to claim 7, wherein conditional execution of rendering actions or object behaviours is provided and conditions take the form of timer events, user events, system events, interaction events, relationships between objects, user variables, and system status such as playing, pausing, streaming or stand-alone play.

11. An interactive multimedia file format comprising single objects containing video, text, audio, music, and/or graphical data wherein at least one of said objects comprises a data stream, and at least one of said data streams comprises a scene, at least one of said scenes comprises a file, and wherein directory data and metadata provide file information.

12. A system for dynamically changing the actual content of a displayed video in an object-oriented interactive video system comprising:
a dynamic media composition process including an interactive multimedia file format including objects containing video, text, audio, music, and/or graphical data wherein at least one of said objects comprises a data stream, at least one of said data streams comprises a scene, at least one of said scenes comprises a file;
a directory data structure for providing file information;
selecting mechanism for allowing the correct combination of objects to be composited together;
a data stream manager for using directory information and knowing the location of said objects based on said directory information; and
control mechanism for inserting, deleting, or replacing in real time while being viewed by a user, said objects in said scene and said scenes in said video.

13. A system according to claim 12 including remote server non-sequential access capability, selection mechanism for selecting appropriate data components from each object stream, interleaving mechanism for placing said data components into a final composite data stream, and wireless transmission mechanism for sending said final composite stream to a client.

14. A system according to claim 12 including remote server non-sequential access capability, including a mechanism for executing library management instructions delivered to said system from said remote server, said server capable of querying said library and receiving information about specific objects contained therein, and inserting, updating, or deleting the contents of said library; and said dynamic media composition engine capable of sourcing object data stream simultaneously both from said library and remote server if required.

15. A system according to claim 12 including a local server providing offline play mode;
a storage mechanism for storing appropriate data components in local files;
selection mechanism for selecting appropriate data components from separate sources;
a local data file including multiple streams for each scene stored contiguously within said file;
access mechanism for said local server to randomly access each stream within a said scene;
selection mechanism for selecting said objects for rendering;
a persistent object library for use in dynamic media composition capable of being managed from said remote server, said objects capable of being stored in said library with full digital rights management information;
software available to a client for executing library management instructions delivered to it from said remote server, said server capable of querying said library and receiving information about specific objects contained therein, and inserting, updating, or deleting the contents of said library; and
said dynamic media composition engine capable of sourcing object data stream simultaneously both from said library and remote server.

16. A system according to claim 12, wherein each said stream includes an end of stream packet for demarcating stream boundaries, said first stream in a said scene containing descriptions of said objects within said scene;
object control packets within said scene provide information for interactivity, changing the source data for a particular object to a different stream;
reading mechanism in said server for reading more than one stream simultaneously from within a said file when performing local playback; and
mechanism for managing an array or linked list of streams, data stream manager capable of reading one packet from each stream in a cyclical manner; storage mechanism for storing the current position in said file; and storage mechanism for storing a list of referencing objects.

17. A system according to claim 12, wherein data is streamed to a media player client, said client capable of decoding packets received from the remote server and sending back user operations to said server, said server responding to user operations such as clicking, and modifying said data sent to said client, each said scene containing a single multiplexed stream composed of one or more objects, said server capable of composing scenes in real-time by multiplexing multiple object data streams based on client requests to construct a single multiplexed stream for any given scene, and wireless streaming to said client for playback.

18. A system according to claim 12 including playing mechanism for playing a plurality of video objects simultaneously, each of said video objects capable of originating from a different source, said server capable of opening each of said sources, interleaving the bit streams, adding appropriate control information and forwarding the new composite stream to said client.

19. A system according to claim 12 including a data source manager capable of randomly accessing said source file, reading the correct data and control packets from said streams which are needed to compose the display scene, and including a server multiplexer capable of receiving input from multiple source manager instances with single inputs and from said dynamic media composition engine, said multiplexer capable of multiplexing together object data packets from said sources and inserting additional control packets into said data stream for controlling the rendering of component objects in the composite scene.

20. A system according to claims 12 including an XML parser to enable programmable control of said dynamic media composition through IAVML scripting.

21. A system according to claims 12, wherein said remote server is capable of accepting a number of inputs from the server operator to further control and customize said dynamic media composition process, said inputs including user profile, demographics, geographic location, or the time of day.

22. A system according to claims 12, wherein said remote server is capable of accepting a number of inputs from the server operator to further control and customize said dynamic media composition process, said inputs including a log of user interaction such as knowledge of what advertisements have success with a user.

23. An object oriented interactive multimedia file, comprising:
a combination of one or more of contiguous self-contained scenes,
each said scene comprising scene format definition as the first packet, and a group of one or more data streams following said first packet;
each said data stream apart from first data stream containing objects which may be optionally decoded and displayed according to a dynamic media composition process as specified by object control information in said first data stream; and
each said data stream including one or more single self-contained objects and demarcated by an end stream marker; said objects each containing it's own control information and formed by combining packet streams; said packet streams formed by encoding raw interactive multimedia data including at least one or a combination of video, text, audio, music, or graphics elements as a video packet stream, text packet stream, audio packet stream, music packet stream and graphics packet stream respectively.

24. An object-oriented interactive video system including an interactive multimedia file format according to claim 23 including:
server software for performing said dynamic media composition process, said process allowing the actual content of a displayed video scene to be changed dynamically in real-time while a user views said video scene, and for inserting, replacing, or adding any of said scene's arbitrary shaped visual/audio video objects; and
a control mechanism to replace in-picture objects by other objects to add or delete in-picture objects to or from a current scene to perform said process in a fixed, adaptive, or user-mediated mode.

25. An object oriented interactive multimedia file according to claim 23 including data for configuring customisable decompression transforms within said scenes.

26. An object-oriented interactive video system including an interactive multimedia file format according to claim 23 including:
a control mechanism to provide a local object library to support said process, said library including a storage means for storing objects for use in said process, control mechanism to enable management of said library from a streaming server, control mechanism for providing versioning control for said library objects, and for enabling automatic expiration of non persistent library objects; and
control mechanism for updating objects automatically from said server, for providing multilevel access control for said library objects, and for supporting a unique identity, history and status for each of said library objects.

27. An object-oriented interactive video system including an interactive multimedia file format according to claim 23 including:
a control mechanism for responding to a user click on a said object in a session by immediately performing said dynamic media composition process; and
control mechanism for registering a user for offline follow-up actions, and for moving to a new hyperlink destination at the end of said session.

28. A method of real-time streaming of file data in the object oriented file format according to claim 23, over a wireless network whereby a scene includes only one stream, and said dynamic media composition engine interleaves objects from other streams at an appropriate rate into the said first stream.

29. A method of real-time streaming of file data in the object oriented file format according to claim 23, over a wireless network whereby a scene includes only one stream, and said dynamic media composition engine interleaves objects from other streams at an appropriate rate into the said first stream.

30. A method according to claim 28 of streaming live video content to a user where said other streams include streams which are encoded in real time.

31. A method according to claim 29 of streaming live video content to a user comprising the following steps:
said user connecting to a remote server; and
said user selecting a camera location to view within a region handled by the operator/exchange;

32. A method according to claim 29 of streaming live video content to a user comprising the following steps:
said user connects to a remote server; and
said user's geographic location, derived from a global positioning system or cell triangulation, is used to automatically provide a selection of camera locations to view for assistance with said user's selection of a destination.

33. A method according to claim 29 of streaming live traffic video content to a user comprising the following steps:
said user registers for a special service where a service provider calls said user and automatically streams video showing a motorist's route that may have a potential problem area;
upon registering said user may elect to nominate a route for this purpose, and may assist with determining said route; and
said system tracks said user's speed and location to determine the direction of travel and route being followed, said system could then search its list of monitored traffic cameras along potential routes to determine if any sites are problem areas, and if any problems exist, said system notifies said user and plays a video to present the traffic information and situation.

34. A method of advertising according to claim 24, wherein said dynamic media composition process selects objects based on a subscriber's own profile information, stored in a subscriber profile database.

35. A method of providing a voice command operation of a low power device capable of operating in a streaming video system, comprising the following steps:
capturing a user's speech on said device;
compressing said speech;
inserting encoded samples of said compressed speech into user control packets;
sending said compressed speech to a server capable of processing voice commands;
said server performs automatic speech recognition;
said server maps the transcribed speech to a command set;
said system checks whether said command is generated by said user or said server;
if said transcribed command is from said server, said server executes said command;
if said transcribed command is from said user said system forwards said command to said user device; and
said user executes said command.

36. A method of providing a voice command operation of a low power device capable of operating in a streaming video system, according to claim 35 wherein:
said system determines whether transcribed command is pre-defined;
if said transcribed command is not pre-defined, said system sends said transcribed text string to said user; and
said user inserts said text string into an appropriate text field.

37. A method of processing objects, comprising the steps of:
parsing information in a script language;
reading a plurality of data sources containing a plurality of objects in the form of at least one of video, graphics, animation, and audio;
attaching control information to the plurality of objects based on the information in the script language; and
interleaving the plurality of objects into at least one of a data stream and a file.

38. A method according to claim 37, further comprising the step of inputting information from a user, wherein the step of attaching is performed based on the information in the script language and the information from the user.

39. A method according to claim 37, further comprising the step of inputting control information selected from at least one of profile information, demographic information, geographic information, and temporal information, wherein the step of attaching is performed based on the information in the script language and the control information.

40. A method according to claim 39, further comprising the step of inputting information from a user, wherein the step of attaching is performed based on the information in the script language, the control information, and the information from the user.

41. A method according to claim 40, wherein the step of inputting information from the user comprises graphically pointing and selecting an object on a display.

42. A method according to claim 37, further comprising the steps of inserting an object into the at least one of the data stream and file.

43. A method according to claim 42, wherein said inserting step comprises inserting an advertisement into the at least one of the data stream and file.

44. A method according to claim 43, further comprising the step of replacing the advertisement with a different object.

45. A method according to claim 42, wherein said inserting step comprises inserting a graphical character into the at least one of the data stream and file.

46. A method according to claim 45, wherein said step of inserting a graphical character comprises inserting the graphical character based on a geographical location of a user.

47. A method according to claim 37, further comprising the step of replacing one of the plurality of objects with another object.

48. A method according to claim 47, wherein said step of replacing one of the plurality of objects comprises replacing the one of the plurality of objects which is a viewed scene with a new scene.

49. A method according to claim 37, wherein said step of reading a plurality of data sources comprises reading a least one of the plurality of data sources which is training video.

50. A method according to claim 37, wherein said step of reading a plurality of data sources comprises reading a least one of the plurality of data sources which is an educational video.

51. A method according to claim 37, wherein said step of reading a plurality of data sources comprises reading a least one of the plurality of data sources which is a promotional video.

52. A method according to claim 37, wherein said step of reading a plurality of data sources comprises reading a least one of the plurality of data sources which is an entertainment video.

53. A method according to claim 37, wherein said step of reading a plurality of data sources comprises obtaining video from a surveillance camera.

54. A method according to claim 42, wherein said inserting step comprises inserting a video from a camera for viewing automobile traffic into the at least one of the data stream and file.

55. A method according to claim 42, wherein said inserting step comprises inserting information of a greeting card into the at least one of the data stream and file.

56. A method according to claim 42, wherein said inserting step comprises inserting a computer generated image of a monitor of a remote computing device.

57. A method according to claim 37, further comprising the step of providing the at least one of a data stream and a file to a user, wherein the at least one of a data stream and a file include an interactive video brochure.

58. A method according to claim 37, further comprising the step of providing the at least one of a data stream and a file which includes an interactive form to a user;
electronically filling out the form by the user; and
electronically storing information entered by the user when filling out the form.

59. A method according to claim 58, further comprising the step of transmitting the information which has been electronically stored.

60. A method according to claim 57, wherein the step of attaching control information comprises attaching control information which indicates interaction behaviour.

61. A method according to claim 37, wherein the step of attaching control information comprises attaching control information which includes rendering parameters.

62. A method according to claim 37, wherein the step of attaching control information comprises attaching control information which includes composition information.

63. A method according to claim 37, wherein the step of attaching control information comprises attaching control information which indicates how to process compressed data.

64. A method according to claim 37, wherein the step of attaching control information comprises attaching an executable behaviour.

65. A method according to claim 64, wherein the step of attaching an executable behaviour comprises attaching rendering parameters used for animation.

66. A method according to claim 64, wherein the step of attaching an executable behaviour comprises attaching a hyperlink.

67. A method according to claim 64, wherein the step of attaching an executable behaviour comprises attaching a timer.

68. A method according to claim 64, wherein the step of attaching an executable behaviour comprises attaching a behaviour which allows making a voice call.

69. A method according to claim 64, wherein the step of attaching an executable behaviour comprises attaching systems states including at least one of pause and play.

70. A method according to claim 64, wherein the step of attaching an executable behaviour comprises attaching information which allows changing of user variables.

71. A system for processing objects, comprising:
means for parsing information in a script language;
means for reading a plurality of data sources containing a plurality of objects in the form of at least one of video, graphics, animation, and audio;
means for attaching control information to the plurality of objects based on the information in the script language; and
means for interleaving the plurality of objects into at least one of a data stream and a file.

72. A system according to claim 71, further comprising means for inputting information from a user, wherein the means for attaching operates based on the information in the script language and the information from the user.

73. A system according to claim 71, further comprising means for inputting control information selected from at least one of profile information, demographic information, geographic information, and temporal information, wherein the means for attaching operates based on the information in the script language and the control information.

74. A system according to claim 73, further comprising means for inputting information from a user, wherein the means for attaching operates based on the information in the script language, the control information, and the information from the user.

75. A system according to claim 74, wherein the means for inputting information from the user comprises means for graphically pointing and selecting an object on a display.

76. A system according to claim 71, further comprising means for inserting an object into the at least one of the data stream and file.

77. A system according to claim 76, wherein said means for inserting comprises means for inserting an advertisement into the at least one of the data stream and file.

78. A system according to claim 77, further comprising means for replacing the advertisement with a different object.

79. A system according to claim 76, wherein said means for inserting comprises means for inserting a graphical character into the at least one of the data stream and file.

80. A system according to claim 79, wherein said means for inserting a graphical character comprises means for inserting the graphical character based on a geographical location of a user.

81. A system according to claim 71, further comprising means for replacing one of the plurality of objects with another object.

82. A system according to claim 71, wherein said means for replacing one of the plurality of objects comprises means for replacing the one of the plurality of objects which is a viewed scene with a new scene.

83. A system according to claim 71, wherein said means for reading a plurality of data sources comprises means for reading a least one of the plurality of data sources which is a training video.

84. A system according to claim 71, wherein said means for reading a plurality of data sources comprises means for reading a least one of the plurality of data sources which is a promotional video.

85. A system according to claim 71, wherein said means for reading a plurality of data sources comprises means for reading a least one of the plurality of data sources which is an entertainment video.

86. A system according to claim 71, wherein means for reading a plurality of data sources comprises means for reading a least one of the plurality of data sources which is an educational video.

87. A system according to claim 71, wherein said means for reading a plurality of data sources comprises means for obtaining video from a surveillance camera.

88. A system according to claim 75, wherein said means for inserting comprises means for inserting a video from a camera for viewing automobile traffic into the at least one of the data stream and file.

89. A system according to claim 75, wherein said means for inserting comprises means for inserting information of a greeting card into the at least one of the data stream and file.

90. A system according to claim 75, wherein said means for inserting comprises inserting a computer generated image of a monitor of a remote computing device.

91. A system according to claim 71, further comprising means for providing the at least one of a data stream and a file to a user, wherein the at least one of a data stream and a file includes an interactive video brochure.

92. A system according to claim 71, further comprising means for providing the at least one of a data stream and a file which includes an interactive form to a user;
means for electronically filling out the form by the user; and
means for electronically storing information entered by the user when filling out the form.

93. A system according to claim 92, further comprising means for transmitting the information which has been electronically stored.

94. A system according to claim 71, wherein the means for attaching control information comprises means for attaching control information which indicates interaction behaviour.

95. A system according to claim 71, wherein the means for attaching control information comprises means for attaching control information which includes rendering parameters.

96. A system according to claim 71, wherein the means for attaching control information comprises means for attaching control information which includes composition information.

97. A system according to claim 71, wherein the means for attaching control information comprises means for attaching control information which indicates how to process compressed data.

98. A system according to claim 71, wherein the means for attaching control information comprises means for attaching an executable behaviour.

99. A system according to claim 98, wherein the means for attaching an executable behaviour comprises means for attaching rendering parameters used for animation.

100. A system according to claim 98, wherein the means for attaching an executable behaviour comprises means for attaching a hyperlink.

101. A system according to claim 98, wherein the means for attaching an executable behaviour comprises means for attaching a timer.

102. A system according to claim 98, wherein the means for attaching an executable behaviour comprises means for attaching a behaviour which allows making a voice call.

103. A system according to claim 98, wherein the means for attaching an executable behaviour comprises means for attaching systems states including at least one of pause and play.

104. A system according to claim 98, wherein the means for attaching an executable behaviour comprises means for attaching information which allows changing of user variables.

105. A method of transmitting an electronic greeting card, comprising the steps of:
inputting information indicating features of a greeting card;
generating image information corresponding to the greeting card;
encoding the image information as an object having control information;
transmitting the object having the control information over a wireless connection;
receiving the object having the control information by a wireless hand-held computing device;
decoding the object having the control information into a greeting card image by the wireless hand-held computing device; and
displaying the greeting card image which has been decoded on the hand-held computing device.

106. A method according to claim 105, wherein the step of generating image information comprises capturing at least one of an image and as series of images as custom image information, wherein the encoding step further comprises encoding said custom image as an object having control information, wherein said step of decoding comprises decoding the object encoded using the image information and decoding the object encoded using the custom image information, wherein said displaying step comprises displaying image information and the custom image information as the greeting card.

107. A system transmitting an electronic greeting card, comprising:
means for inputting information indicating features of a greeting card;
means for generating image information corresponding to the greeting card;
means for encoding the image information as an object having control information;
means for transmitting the object having the control information over a wireless connection;
means for receiving the object having the control information by a wireless hand-held computing device;
means for decoding the object having the control information into a greeting card image by the wireless hand-held computing device; and
means for displaying the greeting card image which has been decoded on the hand-held computing device.

108. A system according to claim 107, wherein the means for generating image information comprises means for capturing at least one of an image and as series of images as custom image information, wherein the means for encoding further comprises means for encoding said custom image as an object having control information, wherein said means for decoding comprises means for decoding the object encoded using the image information and decoding the object encoded using the custom image information, wherein said means for displaying comprises means for displaying image information and the custom image information as the greeting card.

109. An object oriented multimedia video system capable of supporting multiple arbitrary shaped video objects without the need for extra data overhead or processing overhead to provide video object shape information.

110. A system according to claim 109, wherein said video objects have their own attached control information.

111. A system according to claim 109, wherein said video objects are streamed from a remote server to a client.

112. A system according to claim 109, wherein said video object shape is intrinsically encoded in the representation of the images.

113. A method according to claim 37, wherein the step of attaching control information comprises attaching conditions for execution of controls.

114. A method according to claim 39 further comprising the steps of obtaining information from user flags or variables, wherein the step of attaching is performed based on the information in the script language, the control information, and the information from said user flags.

115. A method according to claim 37, wherein said step of reading a plurality of data sources comprises reading a least one of the plurality of data sources which take the form of marketing, promotional, product information, entertainment videos videos.

116. A system according to claim 12 including a persistent object library on a portable client device for use in dynamic media composition said library being capable of being managed from said remote server, software available to a client for executing library management instructions delivered to it from said remote server, said server capable of querying said library and receiving information about specific objects contained therein, and inserting, updating, or deleting the contents of said library; and said dynamic media composition engine capable of sourcing object data stream simultaneously both from said library and remote server, if required, said persistent object library storing object information including expiry dates, access permissions, unique identifiers, metadata and state information, said system performing automatic garbage collection on expired objects, access control, library searching, and various other library management tasks.

117. A video encoding method, including:
encoding video data with object control data as a video object; and
generating a data stream including a plurality of video objects with respective video data and object control data.

118. A video encoding method as claimed in claim 117, including:
generating a scene packet representative of a scene and including a plurality of said data stream with respective video objects.

119. A video encoding method as claimed in claim 118, including generating a video data file including a plurality of said scene packet with respective data streams and user control data.

120. A video encoding method as claimed in claim 117, wherein said video data represents video frames, audio frames, text and/or graphics.

121. A video encoding method as claimed in claim 117, wherein said video object comprises a packet with data packets of said encoded video data and at least one object control packet with said object control data for said video object.

122. A video encoding method as claimed in claim 118, wherein said video data file, said scene packets and said data streams include respective directory data.

123. A video encoding method as claimed in claim 117, wherein said object control data represents parameters defining said video object to allow interactive control of said object within a scene by a user.

124. A video encoding method as claimed in claim 117, wherein said encoding includes encoding luminance and colour information of said video data with shape data representing the shape of said video object.

125. A video encoding method as claimed in claim 117, wherein said object control data defines shape, rendering, animation and interaction parameters for said video objects.

126. A video encoding method, including:
quantising colour data in a video stream based on a reduced representation of colours;
generating encoded video frame data representing said quantised colours and transparent regions; and
generating encoded audio data and object control data for transmission with said encoded video data as a video object.

127. A video encoding method as claimed in claim 126, including:
generating motion vectors representing colour changes in a video frame of said stream; said encoded video frame data representing said motion vectors.

128. A video encoding method as claimed in claim 127, including:
generating encoded text object and vector graphic object and music object data for transmission with said encoded video data; and
generating encoded data for configuring customisable decompression transformations.

129. A video encoding method as claimed in claim 118, including dynamically generating said scene packets for a user in real-time based on user interaction with said video objects.

130. A video encoding method as claimed in claim 117, wherein said object control data represents parameters for (i) rendering video objects, for (ii) defining the interactive behaviour of said objects, for (iii) creating hyperlinks to and from said objects, for (iv) defining animation paths for said objects, for (v) defining dynamic media composition parameters, for (vi) assigning of values to user variables and/or for (vii) defining conditions for execution of control actions.

131. A video encoding method as claimed in claim 126, wherein said object control data represents parameters for rendering objects of a video frame.

132. A video encoding method as claimed in claim 126, wherein said parameters represents transparency, scale, volume, position, and rotation.

133. A video encoding method as claimed in claim 126, wherein said encoded video, audio and control data are transmitted as respective packets for respective decoding.

134. A video encoding method, including:
(i) selecting a reduced set of colours for each video frame of video data;
(ii) reconciling colours from frame to frame;
(iii) executing motion compensation;
(iv) determining update areas of a frame based on a perceptual colour difference measure;
(v) encoding video data for said frames into video objects based on steps (i) to (iv); and
(vi) including in each video object animation, rendering and dynamic composition controls.

135. A video decoding method for decoding video data encoded according to a method as claimed in claim 1.

136. A video decoding method as claimed in claim 135, including parsing said encoded data to distribute object control packets to an object management process and encoded video packets to a video decoder.

137. A video encoding method as claimed in claim 130, wherein said rendering parameters represent object transparency, scale, volume, position and rotation.

138. A video encoding method as claimed in claim 130, wherein said animation paths adjust said rendering parameters.

139. A video encoding method as claimed in claim 130, wherein said hyperlinks represent links to respective video files, scene packets and objects.

140. A video encoding method as claimed in claim 130, wherein said interactive behaviour data provides controls for play of said objects, and return of user data.

141. A video decoding method as claimed in claim 136 including generating video object controls for a user based on said object control packets for received and rendered video objects.

142. A video decoder having components for executing the steps of the video decoding method as claimed in claim 135.

143. A computer device having a video decoder as claimed in claim 142.

144. A computer device as claimed in claim 143, wherein said device is portable and handheld, such as a mobile phone or PDA.

145. A dynamic colour space encoding method including executing the video encoding method as claimed in claim 117 and adding additional colour quantisation information for transmission to a user to enable said user to select a real-time colour reduction.

146. A video encoding method as claimed in claim 117, including adding targeted user and/or local video advertising with said video object.

147. A computer device having an ultrathin client for executing the video decoding method as claimed in claim 135 and adapted to access a remote server including said video objects.

148. A method of multivideo conferencing including executing the video encoding method as claimed in claim 117.

149. A video encoding method as claimed in claim 117, including generating video menus and forms for user selections for inclusion in said video objects.

150. A method of generating electronic cards for transmission to mobile phones including executing said video encoding method as claimed in claim 117.

151. A video encoder having components for executing the steps of the video encoding method as claimed in claim 117.

152. A video on demand system including a video encoder as claimed in claim 151.

153. A video security system including a video encoder as claimed in claim 151.

154. An interactive mobile video system including a video decoder as claimed in claim 142.

155. A video decoding method as claimed in 135 including processing voice commands from a user to control a video display generated on the basis of said video objects.

156. A computer program stored on a computer readable storage medium including code for executing a video decoding method as claimed in claim 135 and generating a video display including controls for said video objects, and adjusting said display in response to application of said controls.

157. A computer program as claimed in claim 156 including IAVML instructions.

158. A wireless streaming video and animation system, including:
(i) a portable monitor device and first wireless communication means;
(ii) a server for storing compressed digital video and computer animations and enabling a user to browse and select digital video to view from a library of available videos; and
(iii) at least one interface module incorporating a second wireless communication means for transmission of transmittable data from the server to the portable monitor device, the portable monitor device including means for receiving said transmittable data, converting the transmittable data to video images displaying the video images, and permitting the user to communicate with the server to interactively browse and select a video to view.

159. A wireless streaming video and animation system as claimed in claim 158, wherein said portable wireless device is a hand held processing device.

160. A method of providing wireless streaming of video and animation including at least one of the steps of:
(a) downloading and storing compressed video and animation data from a remote server over a wide area network for later transmission from a local server;
(b) permitting a user to browse and select digital video data to view from a library of video data stored on the local server;
(c) transmitting the data to a portable monitor device; and
(d) processing the data to display the image on the portable monitor device.

161. A method of providing an interactive video brochure including at least one of steps of:
(a) creating a video brochure by specifying (i) the various scenes in the brochure and the various video objects that may occur within each scene, (ii) specifying the preset and user selectable scene navigational controls and the individual composition rules for each scene, (iii) specifying rendering parameters on media objects, (iv) specifying controls on media objects to create forms to collect user feedback, (v) integrating the compressed media streams and object control information into a composite data stream.

162. A method as claimed in claim 161, including:
(a) processing the composite data stream and interpreting the object control information to display each scene;
(b) processing user input to execute any relevant object controls, such as navigation through the brochure, activating animations etc, registering and user selections and other user input;
(c) storing the user selections and user input for later uploading to the provider of the video brochures network server when a network connection becomes available; and
(d) at a remote network server, receiving uploads of user selections from interactive video brochures and processing the information to integrate it into a customer/client database.

163. A video encoding method as claimed in claim 117, wherein said object control data includes shape parameters that allow a user to render arbitrary shape video corresponding to said video object.

164. A video encoding method as claimed in claim 117, wherein said object control data includes condition data determining when to invoke corresponding controls for said video object.

165. A video encoding method as claimed in claim 117, wherein said object control data represents controls for affecting another video object.

166. A video encoding method as claimed in claim 117, including controlling dynamic media composition of said video objects on the basis of at least one state set in response to events or user interactions

167. A video encoding method as claimed in claim 117, including broadcasting and/or multicasting said data stream.
